(19) United States
(12) Patent Application Publication
(10) Pub. No.: US 2025/0289103 A1
(43) Pub. Date: Sep. 18, 2025

(54) IMPACT TOOL

(71) Applicant: MAKITA CORPORATION, ANJO-SHI (JP)

(72) Inventors: Kazunori KINOSHITA, Anjo-shi (JP); Tomoya HATTORI, Anjo-shi (JP)

(21) Appl. No.: 19/056,876

(22) Filed: Feb. 19, 2025

(30) Foreign Application Priority Data
Mar. 12, 2024 (JP) 2024-038438

(51) Int. Cl. B25B 23/147; B25F 5/02

(52) U.S. Cl. CPC B25B 23/1475; B25F 5/02

(57) ABSTRACT

An impact tool includes a housing, a motor housed in the housing, a hammer rotated by the motor, an anvil impacted in the direction of rotation by the hammer, a hammer case housing the hammer, a first sensor that detects rotation of the anvil, a second sensor that detects movement of the hammer, and a controller that controls tightening torque based on detection data output by the first and second sensors. The anvil has a bit hole into which a tool accessory is insertable.

### CROSS-REFERENCE TO RELATED APPLICATION

This application claims priority to Japanese patent application no. 2024-038438 filed on Mar. 12, 2024, the contents of both of which are fully incorporated herein by reference.

### TECHNICAL FIELD

The techniques disclosed in the present specification relate to impact tools.

### BACKGROUND ART

Bolts that are used for fastening of structures, etc. may be tightened to a specified torque range, as disclosed, for example, in US 2023/0302611.

### SUMMARY OF THE INVENTION

However, in the previously existing technology, with regard to T-handle type impact wrenches, they were tightened with a specified range of torques. There are various types of impact tools, and no consideration has been given with respect to the impact tool other than T-handle type impact wrenches to tightening to a specific range of torques.

The techniques disclosed in the present specification are intended such that fasteners, such as bolts, nuts and screws, can be tightened in a specified range of torques in various types of impact tools.

In one aspect of the present teachings, an impact tool may include a housing, a motor housed in the housing, a hammer that is rotated by the motor, an anvil that is impacted in the rotational direction by the hammer, a hammer case housing the hammer, a first sensor that detects rotation of the anvil, a second sensor that detects movement of the hammer, and a controller that controls tightening torque based on the detection data of the first sensor and the second sensor. The anvil has a bit hole into which a tool accessory is inserted.

According to the above configuration, in various types of impact tools, fasteners, such as bolts, nuts and screws, can be tightened with a specified range of torques.

### BRIEF DESCRIPTION OF THE DRAWINGS

FIG. 1 is a side view that shows an impact tool according to a first embodiment of the present teachings.

FIG. 2 is a cross-sectional view that shows the impact tool according to the first embodiment.

FIG. 3 is a longitudinal cross-sectional view of the upper portion of the impact tool according to the first embodiment.

FIG. 4 is a perspective cross-sectional view that shows the upper portion of the impact tool according to the first embodiment.

FIG. 5 is a longitudinal cross-sectional view that shows the tool holding mechanism according to the first embodiment.

FIG. 6 is a block view that shows the controller according to the first embodiment.

FIG. 7 is a cross-sectional view that shows the upper portion of the impact tool according to the first embodiment.

FIG. 8 is a cross-sectional view that shows the upper portion of the impact tool according to the first embodiment.

FIG. 9 is a cross-sectional view that shows the upper portion of the impact tool according to the first embodiment.

FIG. 10 is a perspective view that shows the anvil and a first sensor board according to the first embodiment from the rear.

FIG. 11 is a perspective view that shows the anvil and the first sensor board according to the first embodiment from the front.

FIG. 12 is a perspective view that shows the first sensor board according to the first embodiment from the rear.

FIG. 13 is a perspective view that shows the operation of the anvil according to the first embodiment from the rear.

FIG. 14 is a perspective view that shows the operation of the anvil according to the first embodiment from the rear.

FIG. 15 is a perspective view that shows the hammer and a second sensor board from the rear.

FIG. 16 is a perspective view that shows the hammer and the second sensor board from the front.

FIG. 17 is a perspective view that shows the second sensor board according to the first embodiment from the front.

FIG. 18 is a perspective view that shows the hammer according to the first embodiment from the rear in a first axial position relative to the second sensor board.

FIG. 19 is another perspective view that shows the hammer according to the first embodiment from the rear in a second axial position relative to the second sensor board.

FIG. 20 is a perspective view that shows a hammer case according to the first embodiment from below.

FIG. 21 is a side view that shows an impact tool according to a second embodiment of the present teachings.

FIG. 22 is a cross-sectional view that shows the impact tool according to the second embodiment.

FIG. 23 is a longitudinal cross-sectional view that shows the upper portion of the impact tool according to the second embodiment.

FIG. 24 is a perspective cross-sectional view that shows the upper portion of the impact tool according to the second embodiment.

FIG. 25 is a perspective view that shows the anvil and a first sensor board according to the second embodiment from the rear.

FIG. 26 is a perspective view that shows the anvil and the first sensor board according to the second embodiment from the front.

FIG. 27 is a perspective view that shows the first sensor board according to the second embodiment from the rear.

FIG. 28 is a perspective view that shows the hammer and a second sensor board from the rear.

FIG. 29 is a perspective view that shows the hammer and the second sensor board according to the second embodiment from the front.

FIG. 30 is a perspective view that shows the second sensor board according to the second embodiment from the front.

FIG. 31 is a perspective view that shows the hammer case according to the second embodiment from below.

FIG. 32 is a side view that shows an impact tool according to a third embodiment of the present teachings.

FIG. 33 is a cross-sectional view that shows the impact tool according to the third embodiment.

FIG. 34 is a longitudinal cross-sectional view that shows the upper portion of the impact tool according to the third embodiment.

FIG. 35 is a perspective cross-sectional view that shows the upper portion of the impact tool according to the third embodiment.

FIG. 36 is a perspective view that shows the anvil and a first sensor board according to the third embodiment from the rear.

FIG. 37 is a perspective view that shows the anvil and the first sensor board according to the third embodiment from the front.

FIG. 38 is a perspective view that shows the first sensor board according to the third embodiment from the rear.

FIG. 39 is a perspective view that shows the hammer and a second sensor board according to the third embodiment from the rear.

FIG. 40 is a perspective view that shows the hammer and the second sensor board according to the third embodiment from the front.

FIG. 41 is a perspective view that shows the second sensor board according to the third embodiment from the front.

FIG. 42 is a perspective view that shows the hammer case according to the third embodiment from below.

FIG. 43 is a side view that shows an impact tool according to a fourth embodiment of the present teachings.

FIG. 44 is a cross-sectional view that shows the impact tool according to the fourth embodiment.

FIG. 45 is a longitudinal cross-sectional view that shows the front portion of the impact tool according to the fourth embodiment.

FIG. 46 is a perspective cross-sectional view that shows the front portion of the impact tool according to the fourth embodiment.

FIG. 47 is a perspective view that shows the anvil and a first sensor board according to the fourth embodiment from the rear.

FIG. 48 is a perspective view that shows the anvil and the first sensor board according to the fourth embodiment from the front.

FIG. 49 is a perspective view that shows the first sensor board according to the fourth embodiment from the rear.

FIG. 50 is a perspective view that shows the hammer and a second sensor board according to the fourth embodiment from the rear.

FIG. 51 is a perspective view that shows the hammer and the second sensor board according to the fourth embodiment from the front.

FIG. 52 is a perspective view that shows the second sensor board according to the fourth embodiment from the front.

FIG. 53 is a perspective view that shows a hammer case according to the fourth embodiment from below.

FIG. 54 is a side view that shows an impact tool according to a fifth embodiment of the present teachings.

FIG. 55 is a cross-sectional view that shows the impact tool according to the fifth embodiment.

FIG. 56 is a longitudinal cross-sectional view that shows the front portion of the impact tool according to the fifth embodiment.

FIG. 57 is a perspective cross-sectional view that shows the front portion of the impact tool according to the fifth embodiment.

FIG. 58 is a perspective view that shows the anvil and a first sensor board according to the fifth embodiment from the rear.

FIG. 59 is a perspective view that shows the anvil and the first sensor board according to the fifth embodiment from the front.

FIG. 60 is a perspective view that shows the first sensor board according to the fifth embodiment from the rear.

FIG. 61 is a perspective view that shows the hammer and a second sensor board according to the fifth embodiment from the rear.

FIG. 62 is a perspective view that shows the hammer and the second sensor board according to the fifth embodiment from the front.

FIG. 63 is a perspective view that shows the second sensor board according to the fifth embodiment from the front.

FIG. 64 is a perspective view that shows the hammer case according to the fifth embodiment from below.

FIG. 65 is a cross-sectional view that shows an impact tool according to a sixth embodiment of the present teachings.

FIG. 66 is a cross-sectional view that shows an impact tool according to a seventh embodiment of the present teachings.

FIG. 67 is a cross-sectional view that shows an impact tool according to an eighth embodiment of the present teachings.

FIG. 68 is a cross-sectional view that shows an impact tool according to a ninth embodiment of the present teachings.

FIG. 69 is a cross-sectional view that shows an impact tool according to a tenth embodiment of the present teachings.

FIG. 70 is a cross-sectional view that shows an impact tool according to an eleventh embodiment of the present teachings.

FIG. 71 is a perspective view that shows a first sensor board according to a twelfth embodiment of the present teachings.

### DETAILED DESCRIPTION OF THE INVENTION

Embodiments of the present teachings are described below with reference to the drawings. In the embodiments, the terms left, right, front, rear, upper portion, and lower portion are used to describe the positional relationship of each part. These terms indicate the relative position or direction with respect to the center of the impact tool.

### First Embodiment

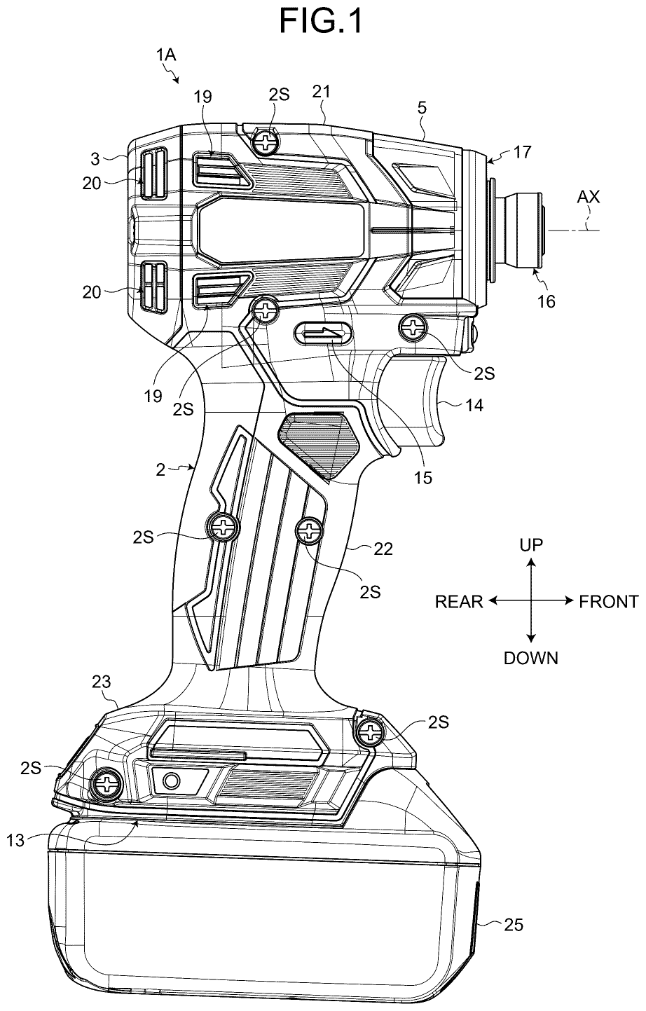

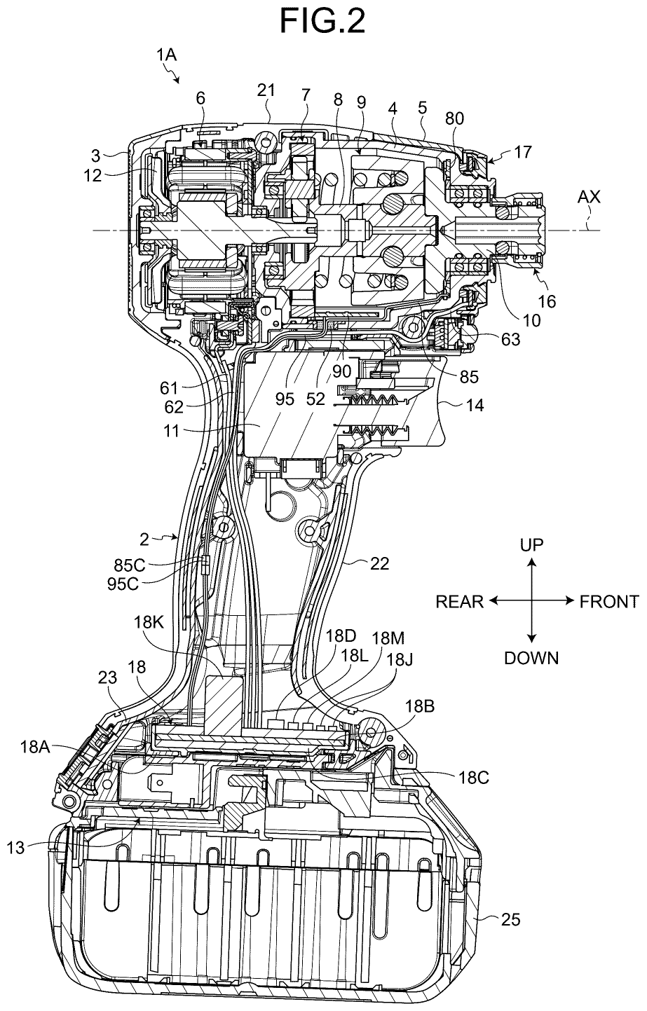

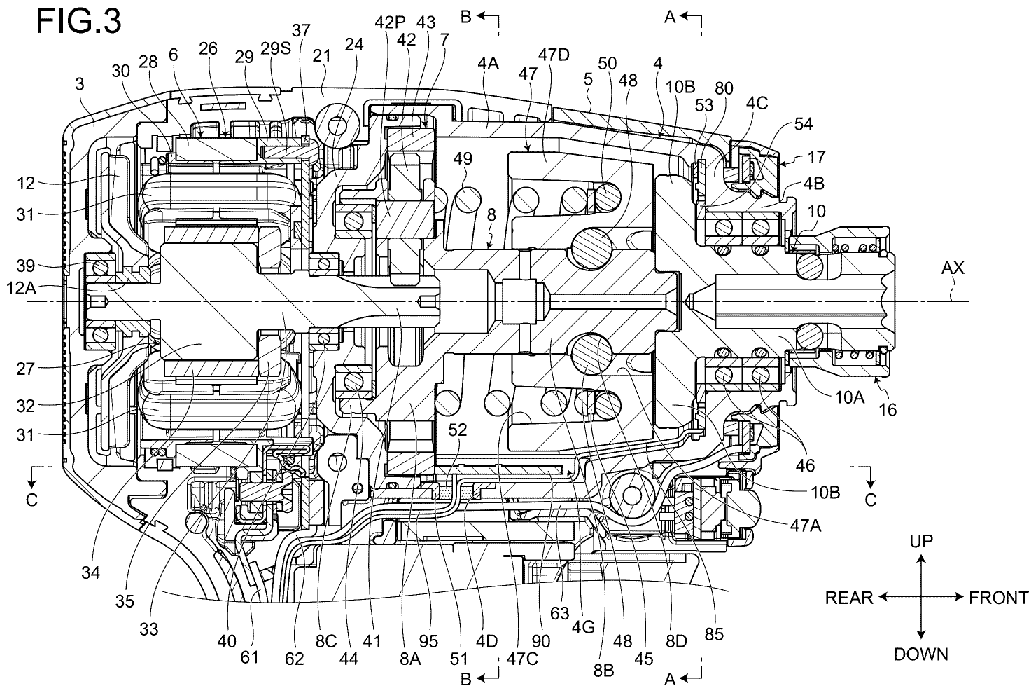

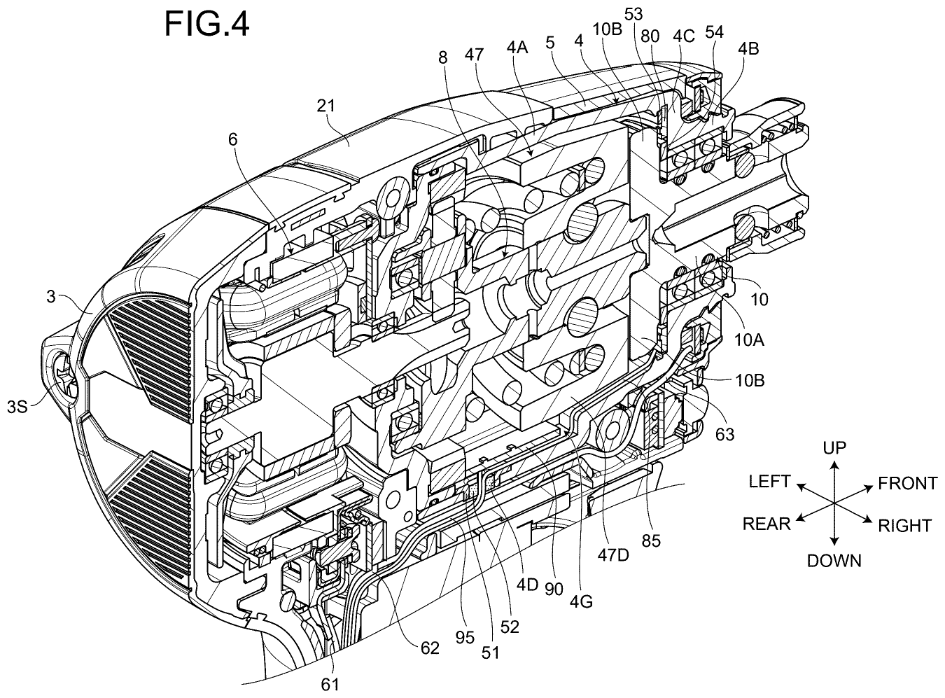

FIG. 1 is a side view that shows an impact tool according to a first embodiment of the present teachings. FIG. 2 is a cross-sectional view that shows the impact tool according to the first embodiment. FIG. 3 is a longitudinal cross-sectional view of the upper portion of the impact tool according to the first embodiment. FIG. 4 is a perspective cross-sectional view that shows the upper portion of the impact tool according to the first embodiment.

In the first embodiment, the impact tool 1A is an electric tool having an electric motor 6 as the motive power source. In all of the embodiments described hereinbelow, the direction parallel to rotational axis AX of the motor 6 is referred to as the axial direction as appropriate, the direction going around rotational axis AX is referred to as the circumferential or rotational direction as appropriate, and the radial direction of rotational axis AX is referred to as the radial direction as appropriate. In addition, in the radial direction, the direction closer to or approaching rotational axis AX is referred to as the radially inner side or inner circumferential side as appropriate, and the direction farther from or going away from rotational axis AX is referred to as the radially outer side or outer circumferential side as appropriate, as appropriate. In all of the embodiments described hereinbelow, rotational axis AX extends in the front-rear direction. One side in the axial direction is the front side (forward) and the other side in the axial direction is the rear side (rearward).

In the first embodiment, the impact tool 1A is an impact driver. The maximum tightening torque of the impact driver is approximately between 150 Nm and 250 Nm. The impact tool 1A comprises a housing 2, a rear cover 3, a hammer case 4, a cover 5, a motor 6, a reduction mechanism (also known as a speed reduction mechanism) 7, a spindle 8, an impact mechanism 9, an anvil 10, a fan 12, a battery mounting part 13, a trigger lever 14, a forward/reverse (rotation) switching lever 15, a tool holding mechanism (bit sleeve) 16, a light unit 17, a first sensor board 80, a second sensor board 90, and a controller 18.

The housing 2 is made of a synthetic resin. In all of the embodiments described herein, the housing 2 may be made of nylon. The housing 2 is constituted by a pair of half-split housings on either side. The pair of half-split housings are fixed by a plurality of screws 2S.

The housing 2 has a motor housing part 21, a grip part 22, and a battery holding part 23.

The motor housing part 21 is tubular shaped. The motor housing part 21 houses the motor 6. The motor housing part 21 houses the motor 6, a portion of bearing box 24, and the rear portion of hammer case 4.

The grip part 22 extends downward from the motor housing part 21. The trigger lever 14 is provided at the upper portion of the grip part 22. The grip part 22 is configured to be gripped by the operator.

The battery holding part 23 is connected to the lower end of the grip part 22. In each of the front-rear and left-right directions, the dimensions of the outer shape of the battery holding part 23 are larger than the dimensions of the outer shape of the grip part 22.

The rear cover 3 is made of a synthetic resin, e.g., nylon. The rear cover 3 is located rearward of the motor housing part 21. The rear cover 3 houses at least a portion of the fan 12. The fan 12 is located on the inner circumference side of the rear cover 3. The rear cover 3 is arranged to cover the opening at the rear end of the motor housing part 21. The rear cover 3 is fixed to the rear end of the motor housing part 21 by screws 3S.

The motor housing part 21 has intake ports 19. The rear cover 3 has exhaust ports 20. Air from outside of the housing 2 flows into the internal space of housing 2 via the intake ports 19. Air in the interior space of the housing 2 flows out to outside of the housing 2 via the exhaust ports 20.

The hammer case 4 functions as a gear case that houses the reduction mechanism 7. Thus, the hammer case 4 houses the reduction mechanism 7. The hammer case 4 also houses a front portion of the spindle 8. The hammer case 4 also houses the impact mechanism 9. The hammer case 4 also houses a rear portion of anvil 10. The hammer case 4 is made of metal. In the present embodiment, hammer case 4 is made of aluminum. The hammer case 4 is tubular shaped.

The hammer case 4 includes a rear side tubular part 4A, a front side tubular part 4B, and a ring-shaped part 4C. The front side tubular part 4B is located more forward than the rear side tubular part 4A. The outer diameter of the rear side tubular part 4A is larger than that of the front side tubular portion 4B. The inner diameter of the rear side tubular part 4A is larger than the inner diameter of the front side tubular part 4B. The ring-shaped part 4C is arranged to connect the front end of the rear side tubular part 4A with the rear end of the front side tubular portion 4B.

The hammer case 4 is connected to the front portion of the motor housing part 21. The motor housing part 21 is fixed to the rear portion of the hammer case 4.

A bearing box 24 is fixed to the rear portion of the rear side tubular part 4A. At least a portion of the reduction mechanism 7 is disposed in the interior of the bearing box 24. A portion of the bearing box 24 and the rear portion of the rear side tubular part 4A are housed in the motor housing part 21. The bearing box 24 is fixed to each of the motor housing part 21 and the hammer case 4.

The cover 5 is disposed to cover the outer surface of the rear side tubular part 4A of the hammer case 4.

Motor 6 is the motive power source of the impact tool 1A. The motor 6 generates a rotational force. The motor 6 is an electric motor. The motor 6 is preferably an inner rotor-type brushless motor, although other types of electric motors may be used with the present teachings. The motor 6 is housed in the motor housing part 21 of the housing 2.

The motor 6 has a stator 26 and a rotor 27. The stator 26 is (fixedly, non-rotatably) supported in the motor housing 21. At least a portion of the rotor 27 is disposed in the interior of the stator 26. The rotor 27 is rotatable relative to the stator 26. The rotor 27 rotates about rotational axis AX that extends in the front-rear direction.

The stator 26 has a stator core 28, a front insulator 29, a rear insulator 30, and coils 31.

The stator core 28 is disposed radially outward of (i.e. surrounding) the rotor 27. The stator core 28 is formed from a plurality of stacked, laminated steel plates. The steel plates are made of an iron-based metal. The stator core 28 is tubular shaped. The stator core 28 has radially-inward-extending teeth that respectively support the coils 31.

The front insulator 29 is provided on the front portion (side) of the stator core 28. The rear insulator 30 is provided on the rear portion (side) of the stator core 28. Each of the front insulator 29 and the rear insulator 30 is made of an electrical insulating member made of a synthetic resin. The front insulator 29 is arranged to cover a portion of the surface of the teeth. The rear insulator 30 is arranged to cover a portion of the surface of the teeth on the opposite side of the front insulator 29.

The coils 31 are mounted (wound) on stator core 28 via (around) the front insulator 29 and the rear insulator 30. That is, the coils 31 are respectively disposed around the teeth of stator core 28 via (around) the front insulator 29 and the rear insulator 30. The coils 31 and the stator core 28 are electrically insulated from each other by the front insulator 29 and the rear insulator 30.

The rotor 27 rotates around rotational axis AX. The rotor 27 has a rotor core part 32, a rotor shaft part 33, a rotor magnet 34, and a sensor magnet 35.

Each of the rotor core part 32 and rotor shaft part 33 is made of steel. In the present embodiment, the rotor core part 32 and the rotor shaft part 33 are one piece (integral without a seam therebetween). The front portion of the rotor shaft part 33 protrudes forward from the front end surface of the rotor core part 32. The rear portion of the rotor shaft part 33 protrudes rearwardly from the rear end surface of the rotor core part 32.

The rotor magnet 34 is fixed to the rotor core part 32. The rotor magnet 34 is cylindrical shaped. Thus, the rotor magnet 34 is arranged around the rotor core part 32.

The sensor magnet 35 is fixed to the rotor core part 32. The sensor magnet 35 is circular. The sensor magnet 35 is located on the front end surface of the rotor core part 32 and the front end surface of the rotor magnet 34.

A sensor board 37 is attached to the front insulator 29. The sensor board 37 is fixed to the front insulator 29 by screws 29S. The sensor board 37 includes a circular circuit board and magnetic sensors (e.g., Hall ICs) supported by the circuit board. At least a portion of the sensor board 37 faces the sensor magnet 35. The magnetic sensors detect the position of the sensor magnet 35, thereby detecting the position of the rotor 27 in the direction of rotation.

The rear portion of the rotor shaft part 33 is rotatably supported by a first rotor bearing 39. The front portion of rotor bearing 39 is rotatably supported by a second rotor bearing 40. The first rotor bearing 39 is held in the rear cover 3. The second rotor bearing 40 is retained in the bearing box 24. The front end of the rotor shaft part 33 is disposed in the interior space of the hammer case 4 and extends through an opening in the bearing box 24.

A pinion gear 41 is formed (provided) at the front end of the rotor shaft part 33. The pinion gear 41 is operably connected (coupled) to at least a part of the reduction mechanism 7, e.g., one of the gears thereof as will be further explained below. Thus, the rotor shaft part 33 is operably connected to the reduction mechanism 7 via the pinion gear 41.

The reduction mechanism 7 transmits the rotational force of the motor 6 to the spindle 8 and the anvil 10. The reduction mechanism 7 is housed in the rear side tubular part 4A of the hammer case 4. The reduction mechanism 7 has a plurality of gears. The reduction mechanism 7 is disposed forward of the motor 6. The reduction mechanism 7 operably connects the rotor shaft part 33 to the spindle 8. The gears of the reduction mechanism 7 are driven by the rotor 27, because the pinion gear 41 meshes with at least some of the gears of the reduction mechanism 7. The reduction mechanism 7 transmits the rotation of the rotor 27 to the spindle 8. More specifically, the reduction mechanism 7 rotates the spindle 8 at a lower rotational speed than the rotational speed of the rotor shaft part 33, but at a higher torque. The reduction mechanism 7 preferably includes a planetary gear mechanism.

More specifically, the reduction mechanism 7 preferably includes a plurality of planetary gears 42, which are disposed around the pinion gear 41, and an internal gear 43, which is disposed around the plurality of planetary gears 42. Each of the pinion gear 41, the planetary gears 42, and the internal gear 43 is housed in the hammer case 4 and the bearing box 24. In the present embodiment, which is a so-called one-stage planetary gear mechanism, all of the plurality of planetary gears 42 mesh with the pinion gear 41. The planetary gears 42 are rotatably supported by the spindle 8 via respective pins 42P. The spindle 8 is rotated by the planetary gears 42. The internal gear 43 has internal teeth that mesh with the planetary gears 42. The internal gear 43 is fixed to the bearing box 24. The internal gear 43 is always non-rotatable relative to bearing box 24.

When the rotor shaft part 33 rotates in response to driving (energization) of the motor 6, the pinion gear 41 rotates, which causes the planetary gears 42 to rotate while also orbiting (revolving) around the pinion gear 41. The planetary gears 42 orbit while meshing with the internal teeth of internal gear 43. Therefore, the orbital revolution of the planetary gears 42 causes the spindle 8, which is connected to the planetary gears 42 via the pins 42P, to rotate at a lower rotational speed than that of rotor shaft part 33.

Thus, the spindle 8 is rotated by the rotational force of motor 6. The spindle 8 is disposed forward of at least a portion of motor 6. The spindle 8 is disposed forward of the stator 26. At least a portion of spindle 8 is disposed forward of the rotor 27. At least a portion of spindle 8 is disposed forward of the reduction mechanism 7. The spindle 8 is rotated by the rotor 27 as was explained above. Thus, as was explained above, the spindle 8 is rotated by the rotational force of the rotor 27 that is transmitted by the reduction mechanism 7.

The spindle 8 has a flange portion 8A and a spindle shaft portion 8B protruding forward from the flange portion 8A. The planetary gears 42 are rotatably supported by (on) the flange portion 8A via the respective pins 42P. The rotational axis of the spindle 8 coincides with rotational axis AX of the motor 6. The spindle 8 rotates around rotational axis AX.

The spindle 8 is rotatably supported by a spindle bearing 44. The spindle bearing 44 is held in the bearing box 24. The spindle 8 has a ring-shaped part 8C that protrudes rearward from the rear portion of the flange portion 8A. The spindle bearing 44 is disposed in the interior of the ring-shaped part 8C. In the present embodiment, the outer ring of the spindle bearing 44 is connected to the ring-shaped part 8C and the inner ring of the spindle bearing 44 is supported by the bearing box 24.

The impact mechanism 9 is driven by the motor 6. More specifically, the rotational force (energy) output by the motor 6 is transmitted to the impact mechanism 9 via the reduction mechanism 7 and the spindle 8. In some aspects of the operation of the impact tool 1A (as will further described below), The impact mechanism 9 impacts (strikes) the anvil 10 in the rotational direction in accordance with the rotational force of the spindle 8, which is rotated by the motor 6. The impact mechanism 9 includes a hammer 47, balls 48, and a coil spring 49. The impact mechanism 9, which includes the hammer 47, is housed in the hammer case 4.

The hammer 47 is disposed forward of the reduction mechanism 7. The hammer 47 is housed in the rear side tubular part 4A. The hammer 47 is disposed around the spindle shaft portion 8B. The hammer 47 is held by the spindle shaft portion 8B. The balls 48 are located between the spindle shaft portion 8B and the hammer 47. The coil spring 49 is supported by (on) each of the flange part 8A and the hammer 47.

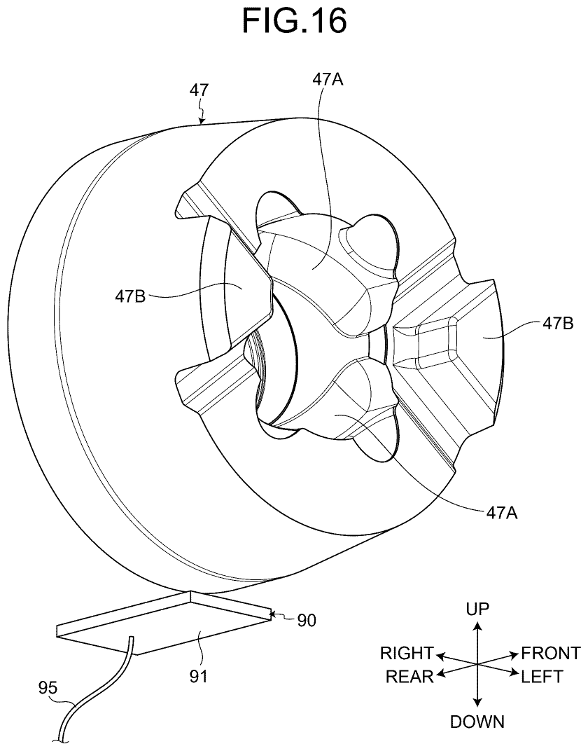

The hammer 47 has a body portion 47D, hammer grooves 47A and hammer projections 47B (see, e.g., FIG. 16). The body portion 47D is disposed around the spindle shaft portion 8B. The body portion 47D is ring-shaped. A recessed part 47C is provided in the rear portion of the body portion 47D. The recessed part 47C is provided so as to be recessed forward from the rear end of the body portion 47D. The recessed part 47C is ring-shaped. The hammer projections 47B project forward from the body portion 47D. Two hammer projections 47B are provided.

The hammer 47 is rotated by motor 6. More specifically, the rotational force (energy) of the motor 6 is transmitted to the hammer 47 via the reduction mechanism 7 and the spindle 8. The hammer 47 is rotatable with the spindle 8 based on the rotational force of the spindle 8, which is rotated by the motor 6. The rotational axis of the hammer 47 coincides with the rotational axis of the spindle 8 and rotational axis AX of the motor 6. The hammer 47 rotates around rotational axis AX.

The balls 48 are made of metal, such as steel. The balls 48 are disposed between the spindle shaft portion 8B and the hammer 47. The spindle 8 has a spindle groove 8D in which at least portions of the balls 48 are disposed. The spindle groove 8D is provided on a portion of the outer circumference of the spindle shaft portion 8B. The hammer 47 has the hammer grooves 47A, in which at least portions of the balls 48 are respectively disposed. The hammer grooves 47A are provided on portions of the inner surface of the body portion 47D. The balls 48 are disposed between the spindle groove 8D and the hammer grooves 47A. The ball 48 can roll inside the spindle groove 8D and inside the hammer grooves 47A, respectively. The hammer 47 can move with the balls 48. The spindle 8 and the hammer 47 can move relative to each other in the axial and rotational directions, respectively, in the range of motion defined by the spindle groove 8D and the hammer grooves 47A.

The coil spring 49 generates an elastic force that urges the hammer 47 to move forward. The coil spring 49 is disposed between the flange 8A and the hammer 47. A ring-shaped recessed part 47C is provided on the rear surface of the hammer 47. The recessed part 47C recesses forward from the rear surface of the hammer 47. A washer 45 is provided inside the recessed part 47C. The washer 45 is supported by the body portion 47D via balls 50. The rear end of the coil spring 49 is supported by (on) the flange portion 8A. The front end of the coil spring 49 is disposed in the interior of the recessed part 47C and is supported by (on) the washer 45.

The anvil 10 is the output part of the impact tool 1A. The anvil 10 is rotated by the rotational force of the motor 6, as will be further explained below. At least a portion of the anvil 10 is disposed (extends) forward of the hammer 47.

The anvil 10 has a rod-shaped anvil shaft portion 10A and anvil projections 10B. The anvil 10 has a bit hole 10C into which a tool accessory (driver bit) is insertable. The bit hole 10C extends rearward from the front end of the anvil shaft portion 10A. The tool accessory is held in the tool holding mechanism 16 while being inserted into the bit hole 10C. A recessed part is provided in the rear end portion of anvil 10. A convex portion is provided at the front end of the spindle shaft portion 8B. The convex portion at the front end of the spindle shaft portion 8B is inserted into the recessed part in the rear end of the anvil 10. The anvil projections 10B are provided on the rear end portion of the anvil 10. The anvil projections 10B protrude radially outward from the rear end of the anvil shaft portion 10A.

The anvil 10 is rotatably supported by anvil bearings 46. The rotational axis of the anvil 10, the rotational axis of the hammer 47, the rotational axis of the spindle 8, and rotational axis AX of the motor 6 coincide. The anvil 10 rotates around rotational axis AX. The anvil bearings 46 are disposed in the interior of the front side tubular part 4B. More specifically, the anvil bearings 46 are held in the front side tubular part 4B of the hammer case 4. The front side tubular part 4B is disposed around the anvil shaft portion 10A. The anvil bearings 46 rotatably support the anvil shaft portion 10A. In the embodiment, the anvil bearings 46 are arranged in a pair in the front-rear direction.

The hammer projections 47B are configured to contact the anvil projections 10B. In the state in which the hammer projections 47B are in continuous contact with the anvil projections 10B, the anvil 10 rotates with the hammer 47 and the spindle 8 when the motor 6 is driven.

In addition, the anvil 10 is also configured to be impacted (struck) in the direction of rotation by the hammer 47. For example, when the load acting on the anvil 10 becomes high, e.g., while tightening a fastener (e.g., a screw), eventually the anvil 10 cannot be rotated by the power generated by the motor 6 alone. When the power generated by the motor 6 alone cannot rotate the anvil 10, the rotation of the anvil 10 and hammer 47 temporarily stops, although the spindle 8 continues to be rotated by the motor 6 and the reduction mechanism 7. The spindle 8 and the hammer 47 are movable relative to each other in the axial and circumferential directions via the balls 48. Thus, even though the rotation of hammer 47 has temporarily stopped, rotation of spindle 8 is continued owing to the power generated by motor 6. When the spindle 8 rotates while the rotation of the hammer 47 is stopped, the balls 48 move rearward while being guided by each of the spindle groove 8D and the hammer grooves 47A. The hammer 47 receives a force from the balls 48 and moves rearward with the balls 48. In other words, in the state in which rotation of the anvil 10 has been stopped, the hammer 47 moves rearward owing to the spindle 8 rotating. Contact between the hammer projections 47B and the anvil projections 10B is released when the hammer 47 moves rearward.

The coil spring 49 generates an elastic force that urges the hammer 47 to move forward. After the hammer 47 has moved rearward, it then moves forward due to the elastic force of the coil spring 49. When the hammer 47 moves forward, it receives a force in the direction of rotation from the balls 48. In other words, the hammer 47 moves forward while rotating. When the hammer 47 moves forward while rotating, the hammer projections 47B contact (strike, impact) the anvil projections 10B while rotating. As a result, the anvil projections 10B are impacted in the rotational direction by the hammer projections 47B. Both the power of the motor 6 and the inertia force of the hammer 47 act on the anvil 10. Therefore, the anvil 10 can rotate around rotational axis AX with a higher torque.

The fan 12 is also rotated by the rotational force of the motor 6. The fan 12 is disposed rearward of the stator 26 of the motor 6. The fan 12 generates an airflow to cool the motor 6. The fan 12 is fixed to at least a portion of the rotor 27. More specifically, the fan 12 is fixed to the rear portion of the rotor shaft part 33 via a bushing 12A. The fan 12 is disposed between the rotor bearing 39 and the stator 26. The fan 12 rotates together with rotation of the rotor 27. That is, when the rotor shaft part 33 rotates, the fan 12 rotates with the rotor shaft part 33. When the fan 12 rotates, air from outside of the housing 2 flows into the internal space of the housing 2 through the intake ports 19. The air that flows into the interior space of the housing 2 cools the motor 6 by flowing through the interior space of the housing 2. The air that has flowed through the interior space of housing 2 flows out to the exterior of the housing 2 via the exhaust ports 20 as the fan 12 rotates.

The battery mounting part 13 is disposed at the lower portion of the battery holding part 23. A battery pack 25 is mounted on the battery mounting part 13. The battery pack 25 is detachable from the battery mounting part 13. The battery pack 25 serves as the electric power source for the impact tool 1A. The battery pack 25 includes one or more secondary batteries. In the embodiments described herein, the battery pack 25 preferably includes one or more rechargeable lithium-ion battery cells. When mounted on the battery mounting part 13, the battery pack 25 can supply power to the impact tool 1A. Each of the motor 6 and the light unit 17 is powered (energized) by current supplied by the battery pack 25.

The trigger lever 14 is provided on the grip part 22. The trigger lever 14 is manipulated (pressed) by the operator to start the motor 6. A switch body 11 is disposed rearward of the trigger lever 14. The switch body 11 is disposed in the interior of the grip part 22. By manipulating (pressing, squeezing) the trigger lever 14, the switch body 11 is actuated. By actuating the switch body 11, a trigger signal is generated. The controller 18 switches the motor 6 between driving (energized) and stopped (not energized) based on the trigger signal.

The forward/reverse (rotation) switching lever 15 is provided at the upper portion of the grip part 22. The forward/reverse switching lever 15 is manipulated (slid left or right) by the operator. By manipulating the forward/reverse switching 15, the direction of rotation of the motor 6 is switched from one of the forward (clockwise) and reverse (counterclockwise) directions to the other. By switching the direction of rotation of the motor 6, the direction of rotation of the spindle 8 is switched.

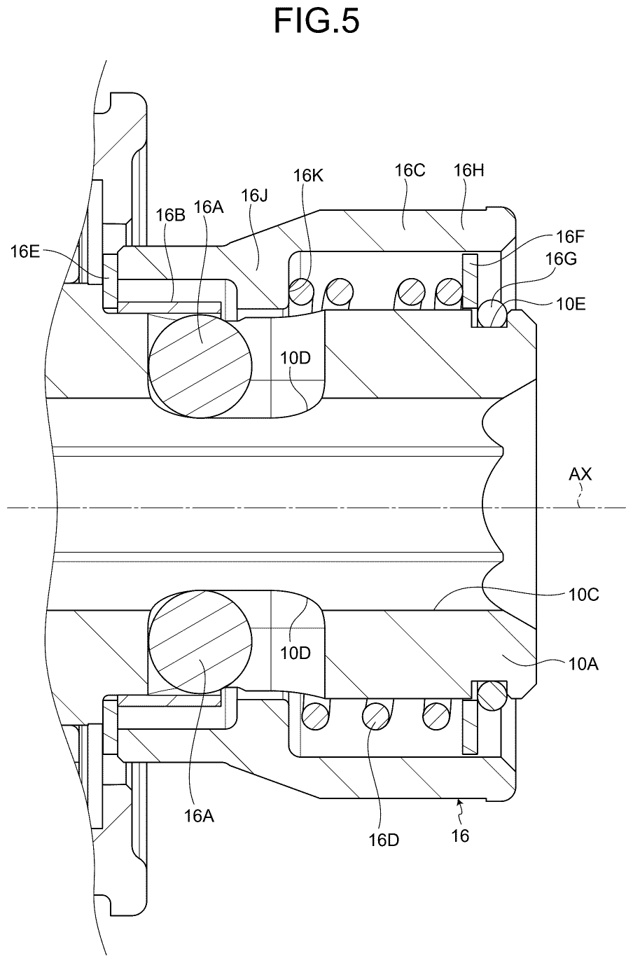

FIG. 5 is a longitudinal cross-sectional view that shows the tool holding mechanism according to the first embodiment. The anvil 10 has the bit hole 10C into which a tool accessory (driver bit) is insertable. The bit hole 10C extends rearward from the front end of the anvil shaft portion 10A. The tool accessory is held in the tool holding mechanism 16 while being inserted into the bit hole 10C.

The tool holding mechanism 16 is disposed around the front portion of the anvil 10. The tool holding mechanism 16 holds the tool accessory that has been inserted into the bit hole 10C of the anvil 10. The tool holding mechanism 16 detachably holds the tool accessory.

The tool holding mechanism 16 comprises balls 16A, a leaf spring 16B, a sleeve 16C, a coil spring 16D, a positioning member 16E, a washer 16F, and a support ring 16G.

The anvil 10 has support recessed parts 10D that support the balls 16A. The support recessed parts 10D are formed on the outer circumference of the anvil shaft portion 10A. In the embodiment, two support recessed parts 10D are formed in the anvil shaft portion 10A.

The balls 16A are movably supported by the anvil 10. The balls 16A are located in the support recessed parts 10D. More specifically, one ball 16A is disposed in one support recessed part 10D.

Through holes are formed in the anvil shaft portion 10A; the through holes connect (extend from) the inner surface of the support recessed parts 10D and (to) the inner surface of the bit hole 10C. The balls 16A are disposed inside the bit hole 10C through at least a portion of the through holes while being supported in the support recessed parts 10D. The balls 16A can fix a tool accessory that has been inserted into the bit hole 10C. The balls 16A are movable between an engaged position that fixes the tool accessory and a release position that releases the fixing of the tool accessory.

The leaf spring 16B generates an elastic force that urges the balls 16A to move radially inward toward the engaged position. The leaf spring 16B is disposed around the anvil shaft portion 10A. The leaf spring 16B generates an elastic force that causes the balls 16A to move radially inward.

The sleeve 16C is a substantially cylindrical member. The sleeve 16C is disposed around the anvil shaft portion 10A. The sleeve 16C is axially movable along the anvil shaft portion 10A. The sleeve 16C can prevent the balls 16A, which are disposed in the engaged position, from escaping from the engaged position. The sleeve 16C can be moved axially to permit the balls 16A to move from the engaged position to the released position or vice versa.

The sleeve 16C has a cylindrical portion 16H and a protruding portion 16J that protrudes radially inward from the inner surface of the cylindrical portion 16H. The protrusion 16J is located in the middle of the cylinder portion 16H in the front-rear direction. The protruding portion 16J has a forward facing support surface 16K.

The sleeve 16C is movable along the anvil shaft portion 10A to a blocking position that prevents the balls 16A from moving radially outward and to a permitting position that permits radial outward movement of the balls 16A. The blocking position is defined rearwardly from the permitting position. The sleeve 16C is disposed in the permitting position by being moved forward.

By moving the sleeve 16C to the blocking position, the balls 16A, which are disposed in the engaged position, are prevented from moving radially outward. In other words, when the sleeve 16C is disposed in the blocking position, the balls 16A, which are disposed in the engaged position, are prevented (blocked) from escaping from the engaged position. By placing the sleeve 16C in the blocking position, the tool accessory is retained in a fixed state by the balls 16A.

By moving the sleeve 16C to the permitting position, the balls 16A, which are disposed in the engaged position, are permitted to move radially outward. That is, when moved to the permitting position, the sleeve 16C allows the balls 16A to move from the engaged position to the released position. In other words, the sleeve 16C, when disposed in the permitting position, allows the balls 16A, which are disposed in the engaged position, to escape from the engaged position. By placing the sleeve 16C in the permitting position, the tool accessory becomes releasable from the fixed state by the ball 16A.

The coil spring 16D generates an elastic force that urges the sleeve 16C to move rearward toward the blocking position. The coil spring 16D is disposed around the anvil shaft portion 10A. The blocking position is defined rearward of the permitting position.

The front end of the coil spring 16D is supported by (on) the washer 16F. The front surface of the washer 16F is supported by the support ring 16G. The support ring 16G is disposed in a retaining groove 10E in the front end of the outer circumference of the anvil shaft portion 10A. The rear end of the coil spring 16D is supported by the support surface 16K of the sleeve 16C.

The positioning member 16E is a ring-shaped member that is fixed to the outer circumference of the anvil shaft portion 10A. The positioning member 16E is fixed at a position such that it faces the rear end of the sleeve 16C. The positioning member 16E positions the sleeve 16C at the blocking position. The sleeve 16C, which is subjected to a rearwardly urging elastic force from the coil spring 16D, is disposed at the blocking position when it contacts the positioning member 16E.

The light unit 17 emits illumination light. The light unit 17 illuminates the anvil 10 and the surrounding area of the anvil 10 with illumination light. The light unit 17 illuminates the front end side of the anvil 10 with illumination light. The light unit 17 preferably includes chip-on-board light emitting diodes (COB LEDs), although other types of light sources may be utilized.

The light unit 17 is located at the front part of the hammer case 4. The light unit 17 is disposed around the front side tubular part 4B. The light unit 17 is disposed around the anvil shaft portion 10A via the front side tubular part 4B.

The controller 18 includes a computer system. The controller 18 outputs control commands to control at least each of the motor 6 and the light unit 17. As shown in FIG. 2, the controller 18 is held in a controller case 18A, which is housed in the battery holding part 23. The controller 18 includes a circuit board 18B on which a plurality of electronic components are mounted and a mold resin 18C that covers the circuit board 18B.

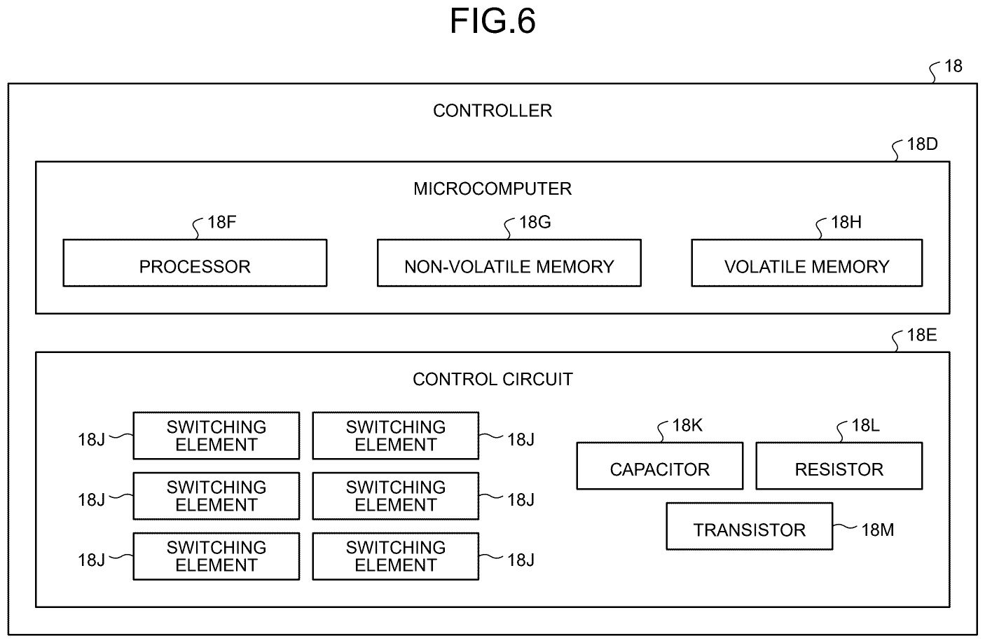

FIG. 6 is a block view that shows the controller according to the first embodiment. As shown in FIGS. 2 and 6, the controller 18 includes a microcomputer 18D and a control circuit 18E. The microcomputer 18D and the control circuit 18E are disposed on the circuit board 18B.

The microcomputer 18D includes a processor (microprocessor) 18F, such as a CPU (Central Processing Unit), non-volatile memory 18G, such as ROM (Read Only Memory) or storage, and volatile memory such as RAM (Random Access Memory) 18H.

The control circuit 18E includes a plurality of electronic components. The control circuit 18E includes six switching elements 18J, a capacitor 18K, a resistor 18L, and a transistor 18M. Metal-oxide-semiconductor field-effect transistors (MOSFETs) are exemplified as the switching elements 18J.

As shown in FIGS. 2, 3, and 4, the motor 6 is electrically connected to the controller 18 by a lead wire 61. Current from the battery pack 25 is supplied to the bus bar of the stator 26 via the controller 18 and the lead wire 61. Drive currents supplied to the bus bar are supplied to the coils 31. By turning the switching elements 18J ON and OFF, the drive currents supplied to the coils 31 are switched and the rotor 27 is caused to rotate. The upper end portion of the lead wire 61 is electrically connected to a lower end portion of the bus bar of the stator 26, and the lower end portion of the lead wire 61 is electrically connected to the upper surface of the controller 18. The lead wire 61 passes through the interior of the grip part 22. A portion of lead wire 61 passes rearward of the switch body 11 in the interior of the grip part 22.

The sensor board 37 is electrically connected to the controller 18 by a lead wire 62. The detection signal of the magnetic sensors of the sensor board 37 is transmitted to the controller 18 via the lead wire 62. The microcomputer 18D of the controller 18 controls the switching elements 18J based on the detection signal of the magnetic sensors. The upper end portion of the lead wire 62 is electrically connected to the lower end portion of the sensor board 37, and the lower end portion of the lead wire 62 is electrically connected to the upper surface of the controller 18. The lead wire 62 passes through the interior of the grip part 22. A portion of lead wire 62 passes rearward of the switch body 11 in the interior of the grip part 22.

The light unit 17 is electrically connected to the controller 18 by a lead wire 63. Current from the battery pack 25 is supplied to the light unit 17 via the controller 18 and the lead wire 63. By supplying current to the light unit 17, illumination light is emitted from the light unit 17. The upper end portion of the lead wire 63 is electrically connected to a lower end portion of the light unit 17, and the lower end portion of the lead wire 63 is electrically connected to the upper surface of the controller 18. The lead wire 63 passes through the interior of the motor housing part 21 and the interior of the grip part 22. A portion of lead wire 63 passes below hammer case 4 in the interior of the motor housing part 21. As shown in FIG. 3, a portion of the lead wire 63 contacts the lower portion of a screw boss into which a screw 2S is inserted. After having passed below a cushion member 51, which is described below, the lead wire 63 is drawn along the same path as a first lead wire 85 and a second lead wire 95. A portion of the lead wire 63 passes rearward of the switch body 11 in the interior of the grip part 22.

The impact tool 1A includes a first sensor board 80 that detects rotation of the anvil 10 and a second sensor board 90 that detects (linear, axial) movement of the hammer 47.

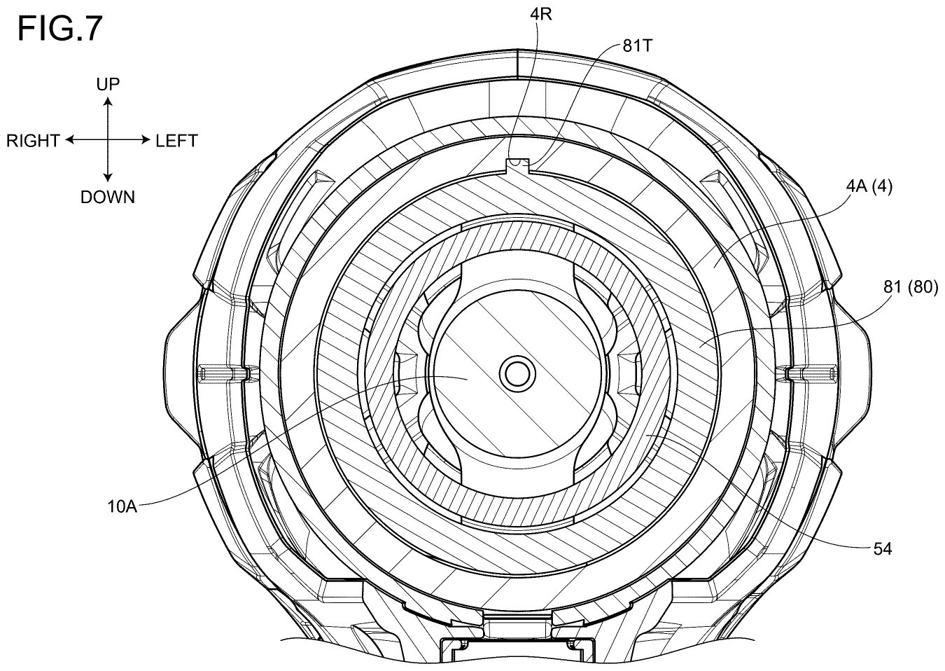

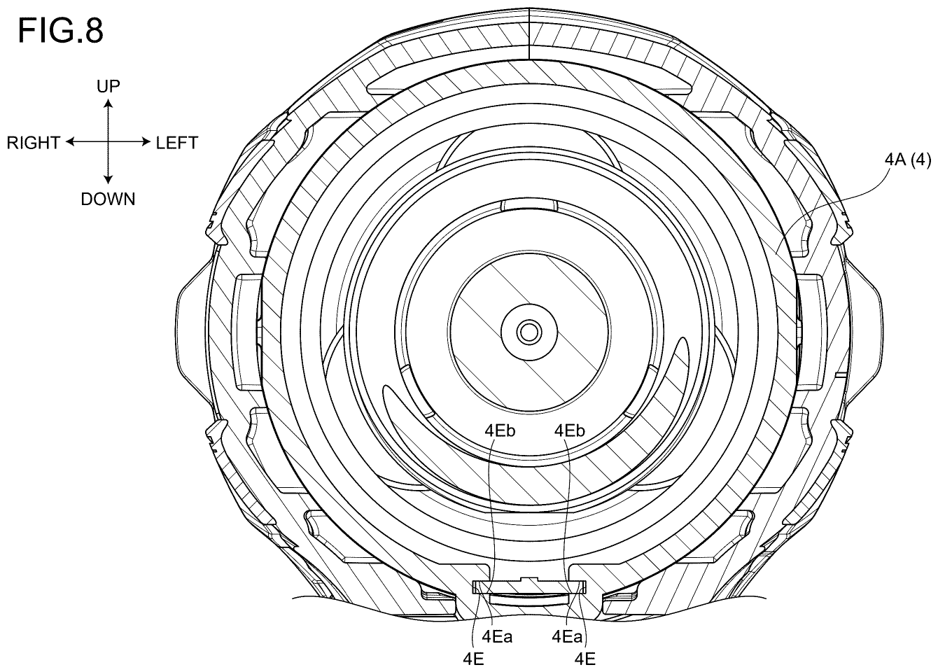

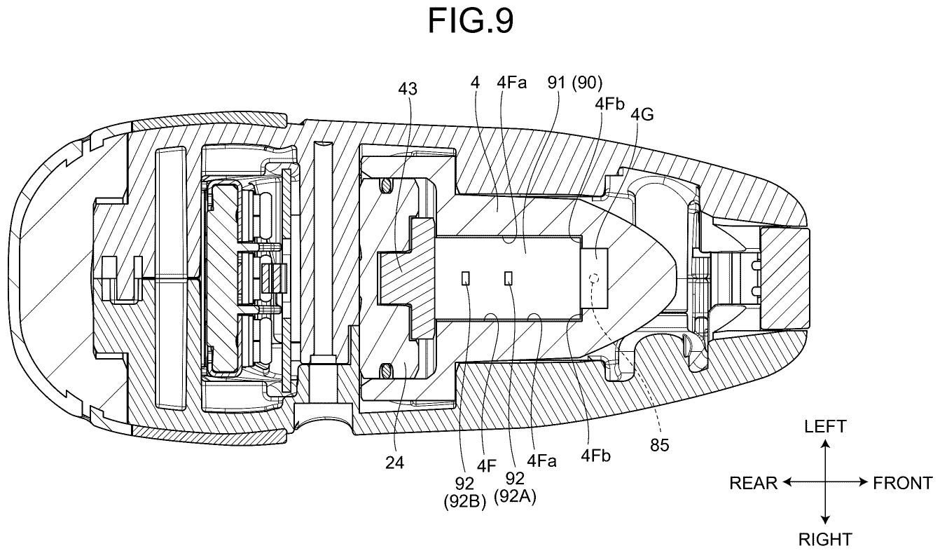

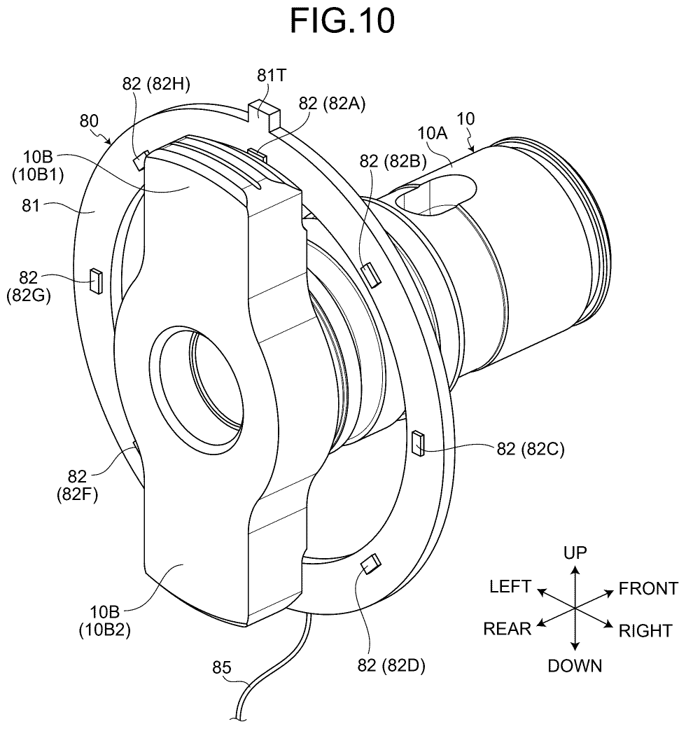

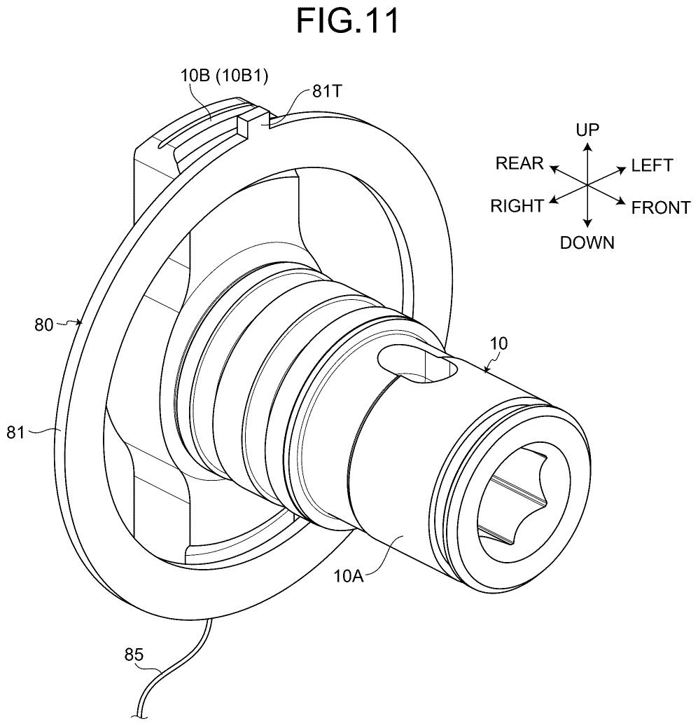

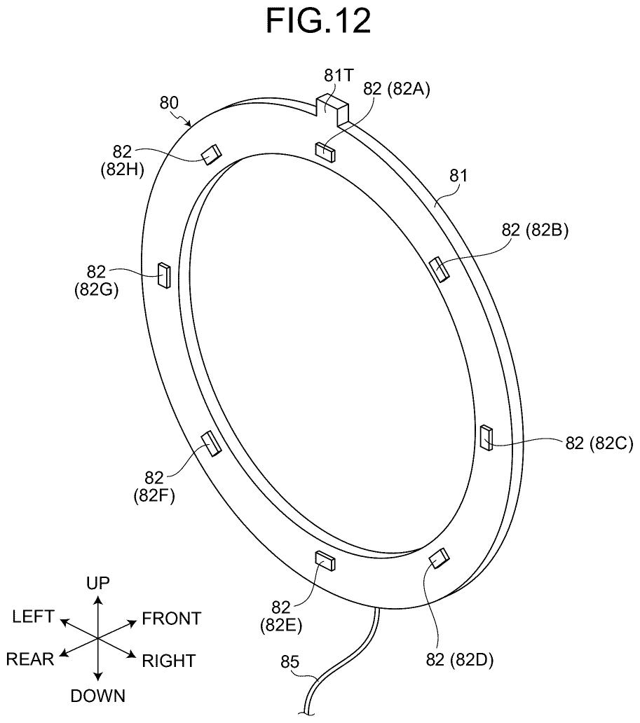

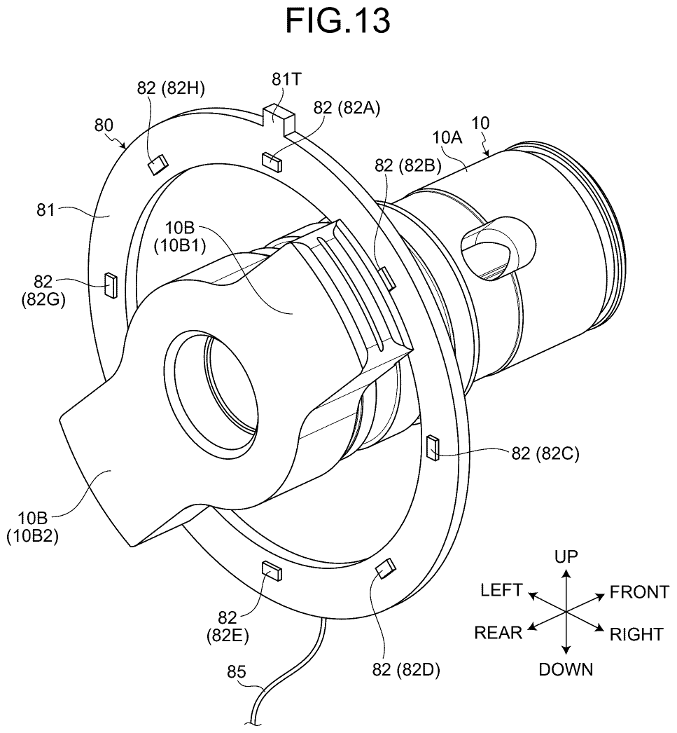

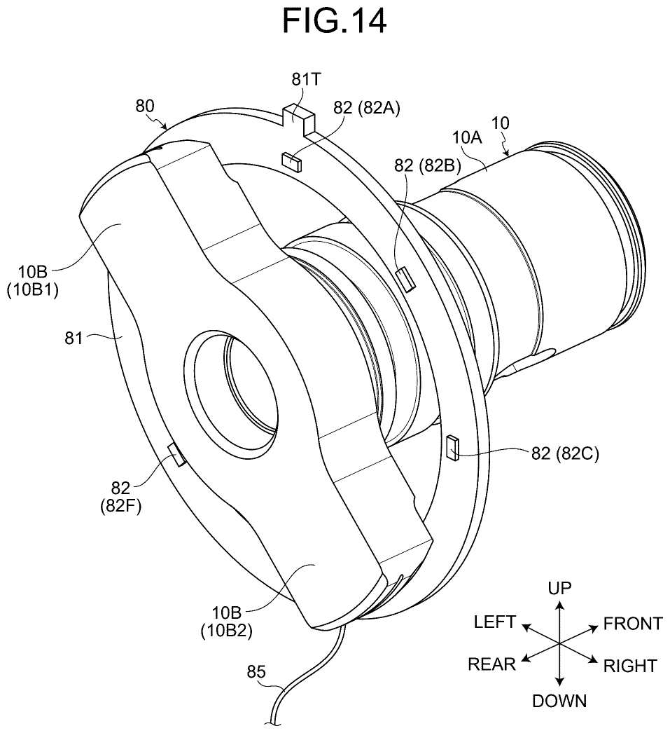

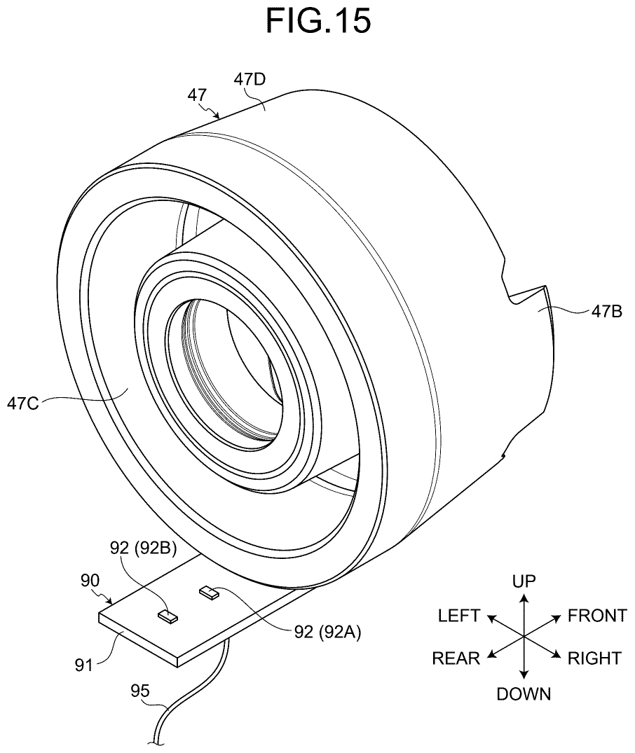

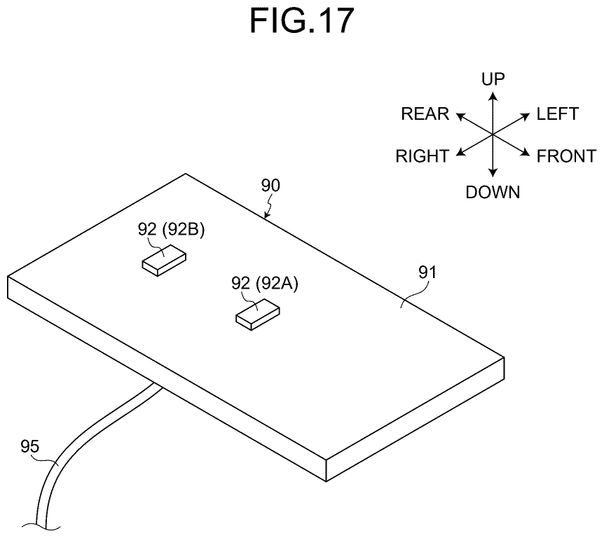

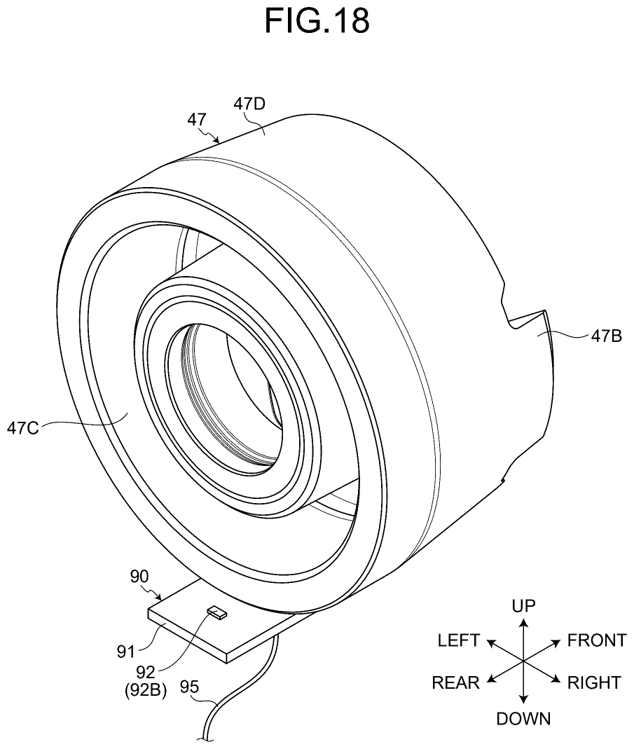

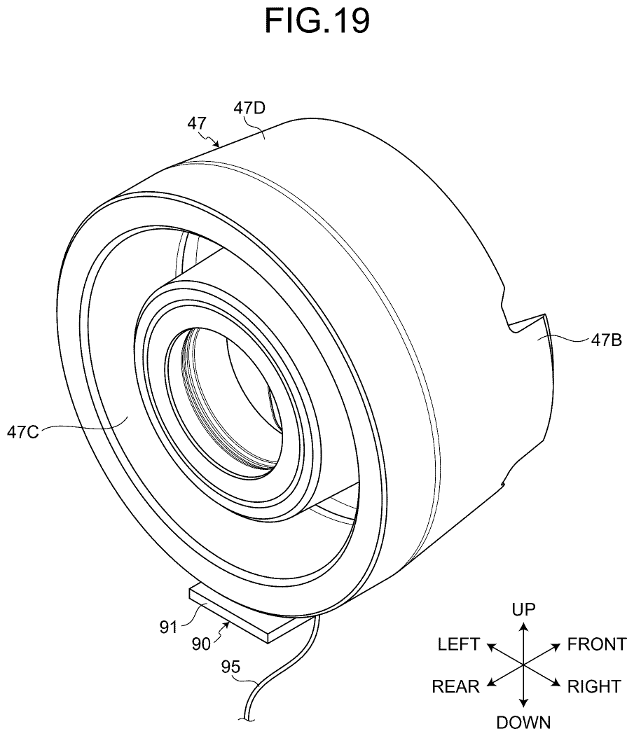

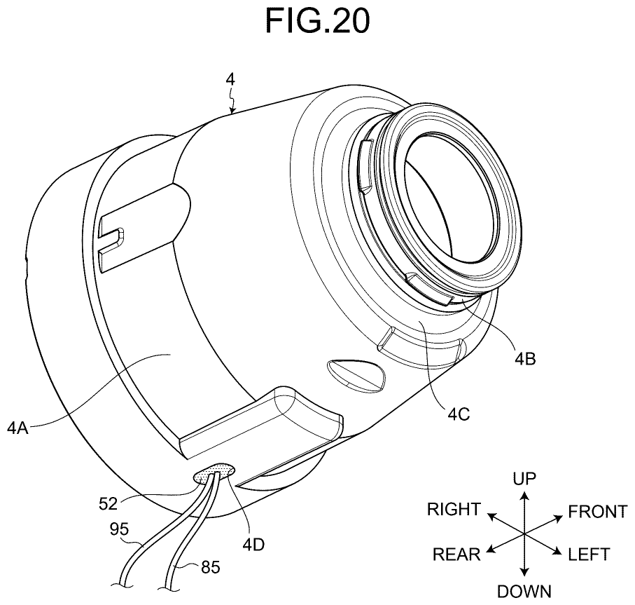

FIG. 7 is a cross-sectional view that shows the upper portion of the impact tool according to the first embodiment. FIG. 8 is a cross-sectional view that shows the upper portion of the impact tool according to the first embodiment. FIG. 9 is a cross-sectional view that shows the upper portion of the impact tool according to the first embodiment. FIG. 10 is a perspective view that shows the anvil and the first sensor board according to the first embodiment from the rear. FIG. 11 is a perspective view that shows the anvil and the first sensor board according to the first embodiment from the front. FIG. 12 is a perspective view that shows the first sensor board according to the first embodiment from the rear. FIG. 13 is a perspective view that shows the operation of the anvil according to the first embodiment from the rear. FIG. 14 is a perspective view that shows the operation of the anvil according to the first embodiment from the rear. FIG. 15 is a perspective view that shows the hammer and the second sensor board from the rear. FIG. 16 is a perspective view that shows the hammer and the second sensor board from the front. FIG. 17 is a perspective view that shows the second sensor board according to the first embodiment from the front. FIG. 18 is a perspective view from the rear for explaining movement of the hammer relative to the second sensor board according to the first embodiment. FIG. 19 is another perspective view from the rear that shows the hammer in a second axial position relative to the second sensor board according to the first embodiment. FIG. 20 is a perspective view that shows the hammer case 4 according to the first embodiment from below.

The anvil 10 has the rod-shaped anvil shaft portion 10A and the pair of anvil projections 10B that extend radially outward from the rear end portion of the anvil shaft portion 10A. The anvil projections 10B include a first anvil projection 10B1 and a second anvil projection 10B2. The first sensor board 80 detects rotation of the anvil 10 around rotational axis AX. The first sensor board 80 detects at least one of position, angular velocity, and angular acceleration of the anvil 10 in the direction of rotation around rotational axis AX.

As was explained above, the hammer 47 has the ring-shaped body portion 47D, the pair of hammer projections 47B provided at the front end of the body portion 47D, the hammer grooves 47A, in which the balls 48 are disposed, and the recessed part 47C provided in the rear portion of the body portion 47D. The second sensor board 90 detects movement of the hammer 47 in the axial (front-rear) direction. The second sensor board 90 detects at least one of position, movement speed, and movement acceleration of the hammer 47 in the axial direction.

Both of the first sensor board 80 and the second sensor board 90 are disposed in the interior of the hammer case 4. Both of the first sensor board 80 and the second sensor board 90 are fixed to the hammer case 4. The first sensor board 80 is supported on the rear surface of the ring-shaped part 4C of the hammer case 4. The second sensor board 90 is supported on the lower inner surface of the rear side tubular part 4A of the hammer case 4.

The first sensor board 80 has a first circuit board 81 and a plurality of first sensors 82 mounted on the rear surface of the first circuit board 81.

The first circuit board 81 may be a printed wiring board (PWB) or a printed circuit board (PCB) on which multiple electronic components are mounted. The first circuit board 81 is disposed at least partially around the anvil shaft portion 10A. In the present embodiment, the first circuit board 81 has a circular shape that extends completely around the anvil shaft portion 10A. The first circuit board 81 has a convex part 81T at an upper portion thereof. The convex part 81T protrudes upwardly from the upper portion of the first circuit board 81.

As shown in FIG. 7, a recessed part 4R, in which the convex part 81T is disposed, is provided on the inner circumference of the rear side tubular part 4A of the hammer case 4. By fitting the convex part 81T into the recessed part 4R, relative rotation between the hammer case 4 and the first sensor board 80 is blocked (prevented). In other words, by fitting the convex part 81T into the recessed part 4R, the position of the first sensor board 80 relative to the hammer case 4 in the direction of rotation is fixed.

As shown in FIG. 3, etc., the periphery of the rear surface of the first circuit board 81 is supported by the retaining ring 53. The retaining ring 53 contacts the peripheral edge of the rear surface of the first circuit board 81. The retaining ring 53 fits into a groove provided on the inner circumference of the rear side tubular part 4A. The first sensor board 80 is blocked from moving rearward by the retaining ring 53. The front surface of the first circuit board 81 contacts the rear surface of the ring-shaped part 4C. The position of the first sensor board 80 relative to the hammer case 4 in the front-rear direction is fixed by the retaining ring 53.

As shown in FIG. 3, etc., a washer 54 is disposed between the front surface of the anvil projections 10B and the outer ring of the rearward one of the anvil bearings 46. The anvil bearings 46 are rolling element bearings (e.g., ball bearings), and two are arranged in the front-rear direction. The front surface of the washer 54 contacts the rear surface of the outer ring of the rear anvil bearing 46. A portion of the front surface of the washer 54 also contacts the rear surface of the ring-shaped part 4C. The rear surface of the washer 54 contacts the front surface of the anvil projections 10B. The washer 54 prevents the anvil projections 10B from contacting the anvil bearings 46. Owing to the washer 54, the anvil bearing 46 are prevented from being damaged by the anvil projections 10B.

The first sensors 82 detect rotation of the anvil 10. The first sensors 82 are mounted on the rear surface of the first circuit board 81. The first sensors 82 are disposed facing the front surface of the anvil projections 10B.

The first sensors 82 include inductive sensors. Because the anvil 10 is made of metal, the first sensors 82 can detect rotation of the anvil 10 in a non-contacting manner. It is noted that rotation of the anvil 10 can be rephrased as the position of the anvil 10 in the rotational direction. In other words, the first sensors 82 can detect the position of the anvil 10 in the rotational direction in a non-contacting manner. Furthermore, rotation of the anvil 10 can also be said to be the number of rotations of the anvil 10. That is, the first sensors 82 can detect the number of rotations of the anvil 10 in a non-contacting manner.

The first sensors 82 are provided (disposed) in (around) the circumferential direction of rotational axis AX. In the present embodiment, eight of the first sensors 82 are provided at equal intervals in the circumferential direction on the rear surface of the first circuit board 81. The first sensors 82 include a first sensor 82A, a first sensor 82B, a first sensor 82C, a first sensor 82D, a first sensor 82E, a first sensor 82F, a first sensor 82G, and a first sensor 82H. In the circumferential direction, if the position of the upper portion of the first sensor board 81 is located at the 0° position, the position of the right portion is located at the 90° position, the position of the lower portion is located at the 180° position, and the position of the left portion is located at the 270° position, then the first sensor 82A is located at the 0° position, the first sensor 82B is located at the 45° position, the first sensor 82C is located at the 90° position, the first sensor 82D is located at the 135° position, the first sensor 82E is located at the 180° position, the first sensor 82F is located at the 225° position, the first sensor 82G is located at the 270° position, and the first sensor 82H is located at the 315° position.

FIG. 10 shows the state in which the first anvil projection 10B1 is facing the first sensor 82A and the second anvil projection 10B2 is facing the first sensor 82E. In the state shown in FIG. 10, the first sensor 82A detects the first anvil projection 10B1 and the first sensor 82E detects the second anvil projection 10B2.

FIG. 13 shows the state in which the anvil 10 has rotated 45° from the state shown in FIG. 10. In other words, FIG. 13 shows the state in which the first anvil projection 10B1 is facing the first sensor 82B and the second anvil projection 10B2 is facing the first sensor 82F. In the state shown in FIG. 13, the first sensor 82B detects the first anvil projection 10B1 and the first sensor 82F detects the second anvil projection 10B2.

FIG. 14 shows the anvil 10 rotated 315° from the state shown in FIG. 10. In other words, FIG. 14 shows the state in which the first anvil projection 10B1 is facing the first sensor 82H and the second anvil projection 10B2 is facing the first sensor 82D. In the state shown in FIG. 14, the first sensor 82H detects the first anvil projection 10B1 and the first sensor 82D detects the second anvil projection 10B2.

The second sensor board 90 has a second circuit board 91 and a plurality of second sensors 92 mounted on the upper surface of the second circuit board 91.

The second circuit board 91 can be a printed wiring board (PWB) or a printed circuit board (PCB) on which multiple electronic components are mounted. The second circuit board 91 is disposed facing the lower portion of the outer surface of the body portion 47D of the hammer 47. In the embodiment, the second circuit board 91 has a plate shape that faces the lower surface of the body portion 47D.

As shown in FIG. 8, a pair of grooves 4E, into which the sides of the second circuit board 91 are inserted, are provided in the lower part of the rear side tubular part 4A of the hammer case 4. The grooves 4E are elongated in the front-rear direction. The left portion of the second circuit board 91 fits into the left groove 4E. The right portion of the second circuit board 91 fits into the right groove 4E. The grooves 4E have a ceiling surface 4Ea that contacts the upper surface of the first circuit board 91 and a bottom surface 4Eb that contacts the bottom surface of the first circuit board 91. By respectively fitting the sides of the second circuit board 91 into the grooves 4E, the position of the second sensor board 90 relative to the hammer case 4 in the up-down direction is fixed.

As shown in FIG. 9, the grooves 4E have support surfaces 4F that support the second circuit board 91. The support surfaces 4F include lateral support surfaces 4Fa that support sides of the second circuit board 91 and a front support surface 4Fb that supports the front surface of the second circuit board 91. The lateral support surfaces 4Fa are provided on both the left and right sides of the second circuit board 91. The left side support surface 4Fa contacts the left side of the second circuit board 91. The right side support surface 4Fa contacts the right side of the second circuit board 91. The front support surface 4Fb contacts the front surface of the second circuit board 91. The rear surface of the second circuit board 91 contacts the lower front surface of the internal gear 43. The lateral support surfaces 4Fa fix the position of the second sensor board 90 relative to the hammer case 4 in the left-right direction. The front support surface 4Fb and the internal gear 43 fix the position of the second sensor board 90 relative to the hammer case 4 in the front-rear direction. The first lead wire 85, described below, passes through a space 4G defined between the front surface of the second circuit board 91 and the hammer case 4.

The second sensors 92 detect axial movement of the hammer 47. The second sensors 92 are mounted on the upper surface of the second circuit board 91. The second sensors 92 are disposed at positions that face the lower surface of the body portion 47D.

The second sensors 92 include inductive sensors. Because the hammer 47 is made of metal, the second sensors 92 can detect movement of the hammer 47 in a non-contacting manner. Movement of the hammer 47 can be rephrased as the position of the hammer 47 in the front-rear direction. In other words, the second sensors 92 can detect the position of the hammer 47 in the front-rear direction in a non-contacting manner. Furthermore, movement of the hammer 47 can also be rephrased as the movement speed of the hammer 47. In other words, the second sensors 92 can detect the moving speed of the hammer 47 in a non-contacting manner.

The second sensors 92 are provided (arranged) in the axial direction. In the embodiment, two second sensors 92 are provided in the axial direction on the upper surface of the second circuit board 91. The second sensors 92 include a second sensor 92A and a second sensor 92B. The second sensor 92A is disposed more forward than the second sensor 92B.

FIG. 15 shows the state in which the hammer 47 does not face each of the second sensor 92A and the second sensor 92B. In the state shown in FIG. 15, neither the second sensor 92A nor the second sensor 92B detects the hammer 47.

FIG. 18 shows the state in which hammer 47 has moved rearward from the state shown in FIG. 15. FIG. 18 shows the state in which hammer 47 and the second sensor 92A are facing each other whereas the hammer 47 and the second sensor 92B are not facing each other. In the state shown in FIG. 18, the second sensor 92A detects the hammer 47 and the second sensor 92B does not detect the hammer 47.

FIG. 19 shows the anvil 10 moved rearward from the state shown in FIG. 18. FIG. 19 shows the state in which the hammer 47 and each of the second sensor 92A and the second sensor 92B are facing each other. In the state shown in FIG. 19, each of the second sensor 92A and the second sensor 92B detects the hammer 47.

The first circuit board 81 is electrically connected to the controller 18 by the first lead wire 85. The second circuit board 91 is electrically connected to the controller 18 by the second lead wire 95. The detection data of the first sensors 82 is transmitted to the controller 18 via the first lead wire 85. The detection data of the second sensors 92 is transmitted to the controller 18 via the second lead wire 95. The controller 18 controls the tightening torque when the impact tool 1A tightens a fastening component (fastener), such as a bolt, screw or nut, based on the detection data of the first sensor 82 and the second sensor 92. The controller 18 controls the tightening torque by controlling the rotation speed of the motor 6 based on the detection data of the first sensor 82 and the second sensor 92. The controller 18 estimates the current tightening torque based on the detection data of the first sensor 82 and the second sensor 92 and then controls the rotation speed of the motor 6 such that the fastening component is to be tightened at the target tightening torque (the specified range of torque).

Both of the first circuit board 81 and the second circuit board 91 are disposed in the interior of the hammer case 4. The hammer case 4 has a hole 4D through which each of the first lead wire 85 and the second lead wire 95 passes. After exiting the hammer case 4 through the hole 4D, each of the first lead wire 85 and the second lead wire 95 passes through the interior of the grip part 22 to connect to the controller 18. Both of the first lead wire 85 and second lead wire 95 pass rearward of the switch body 11 in the interior of the grip part 22.

The cushion member 51 is arranged to cover the edge of the hole 4D. The cushion member 51 is a substantially tubular member. Each of the first lead wire 85 and the second lead wire 95 passes through a passageway in the interior of the cushion member 51. A sponge 52 is disposed in the passageway of the cushion member 51. The sponge 52 fills the gap between the inner surface of the cushion member 51 and the outer surface of the first lead wire 85. The sponge 52 also fills the gap between the inner surface of the cushion member 51 and the outer surface of the second lead wire 95. When grease (lubricant) is disposed in the interior of the hammer case 4, the grease is prevented by the sponge 52 from leaking from the interior of the hammer case 4 to the outside through the passageway of the cushion member 51.

The upper end portion of the first lead wire 85 is connected to a lower end portion of the first sensor board 80, and the lower end portion of the first lead wire 85 is connected to the upper surface of the controller 18. The first lead wire 85, which extends from the lower end of the first sensor board 80, passes below the hammer 47 in the interior of the hammer case 4 and through the space 4G on the front side of the second sensor board 90, which was described with reference to FIG. 9, to below the second sensor board 90. The first lead wire 85, which has been drawn rearward below the second sensor board 90, passes through the passageway of the cushion member 51 to below the hammer case 4. The first lead wire 85, which has been drawn rearward below the hammer case 4, leads into the interior of the grip part 22. The first lead wire 85 passes rearward of the switch body 11 in the interior of the grip part 22. After passing through the passageway of the cushion member 51, the wiring paths of the first lead wire 85 and the lead wire 63 are substantially the same.

The first lead wire 85 is partitioned (and joined) in the interior of the grip part 22. That is, as shown in FIG. 2, the portion of the first lead wire 85, which extends from the lower end of the first sensor board 80, and the portion of the first lead wire 85, which extends from the upper surface of the controller 18, are electrically connected via a connector 85C disposed within the grip part 22. If replacement of the first sensor board 80 and/or the controller 18 ever becomes necessary, then the replacement can be facilitated by detaching the connector 85C.

The upper end portion of the second lead wire 95 is electrically connected to the lower surface of the second sensor board 90, and the lower end portion of the second lead wire 95 is electrically connected to the upper surface of the controller 18. The second lead wire 95, which extends from the lower side of the second sensor board 90, passes through the passageway in the cushion member 51 to below the hammer case 4. The second lead wire 95, which has been drawn rearward below the hammer case 4, leads into the interior of the grip part 22. The second lead wire 95 passes rearward of the switch body 11 in the interior of the grip part 22. After passing through the passageway of the cushion member 51, the wiring paths of the second lead wire 95, the first lead wire 85, and the lead wire 63 are substantially the same.

The second lead wire 95 is also partitioned (and joined) in the interior of the grip part 22. That is, as shown in FIG. 2, the portion of the second lead wire 95, which extends from the lower side of the second sensor board 90, and the portion of the second lead wire 95, which extends from the upper portion of the controller 18, are electrically connected via a connector 95C. If replacement of the second sensor board 90 and/or the controller 18 ever becomes necessary, then the replacement can be facilitated by detaching the connector 95C.

As explained above, in the embodiment, rotation of the anvil 10 is detected by the first sensor board 80 and (linear, axial) movement of the hammer 47 is detected by the second sensor board 90 in the impact tool 1A, which is an impact driver. The controller 18 can control the tightening torque based on the detection data output by the first sensors 82 and the second sensors 92.

### Second Embodiment

The second embodiment is described below. In the following description, identical or equivalent components to those of the above-mentioned embodiment are indicated with the same symbols, and the description of the components is simplified or omitted.

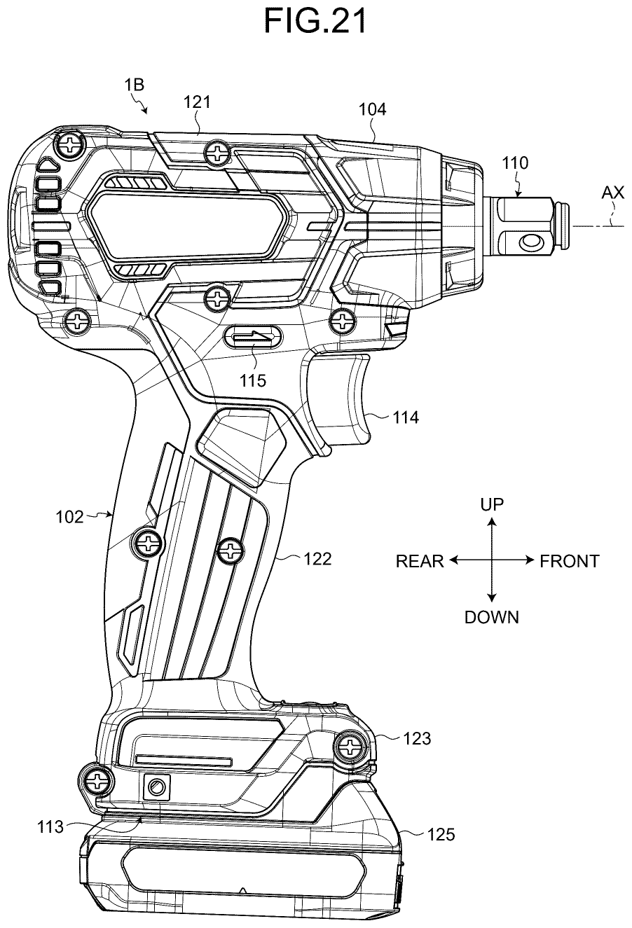

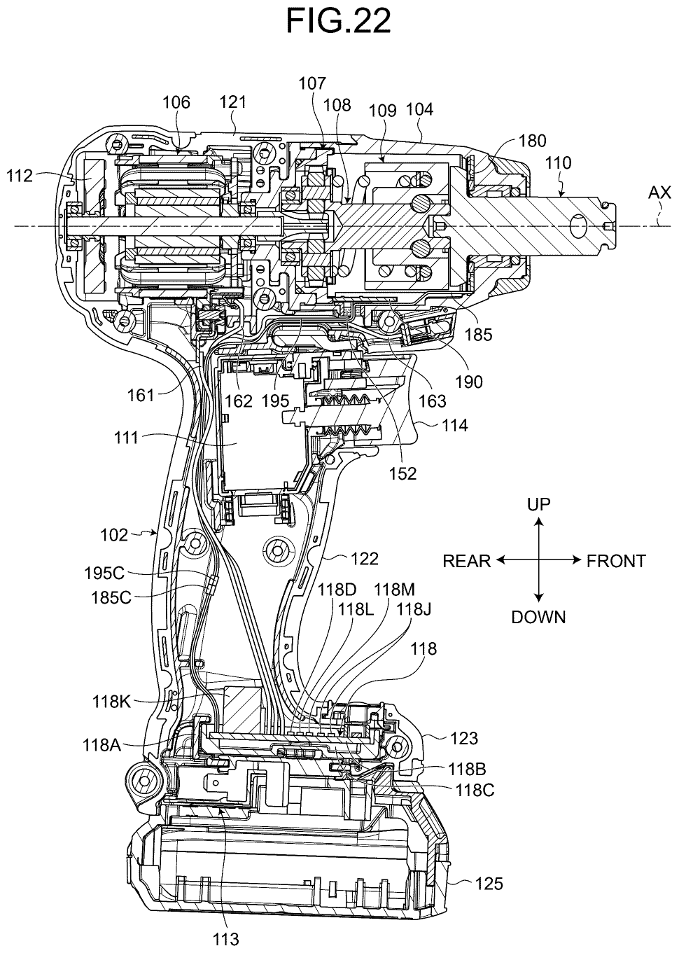

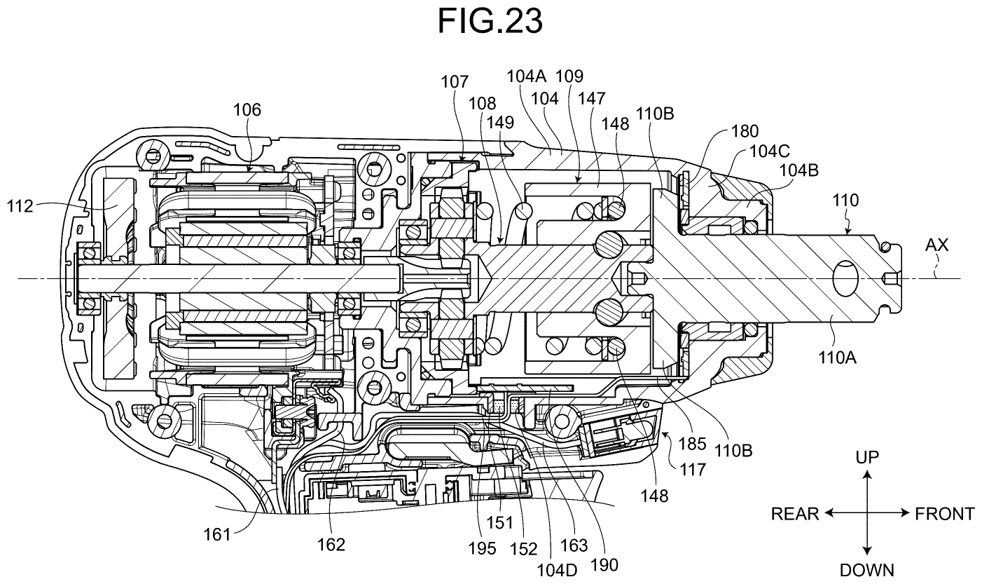

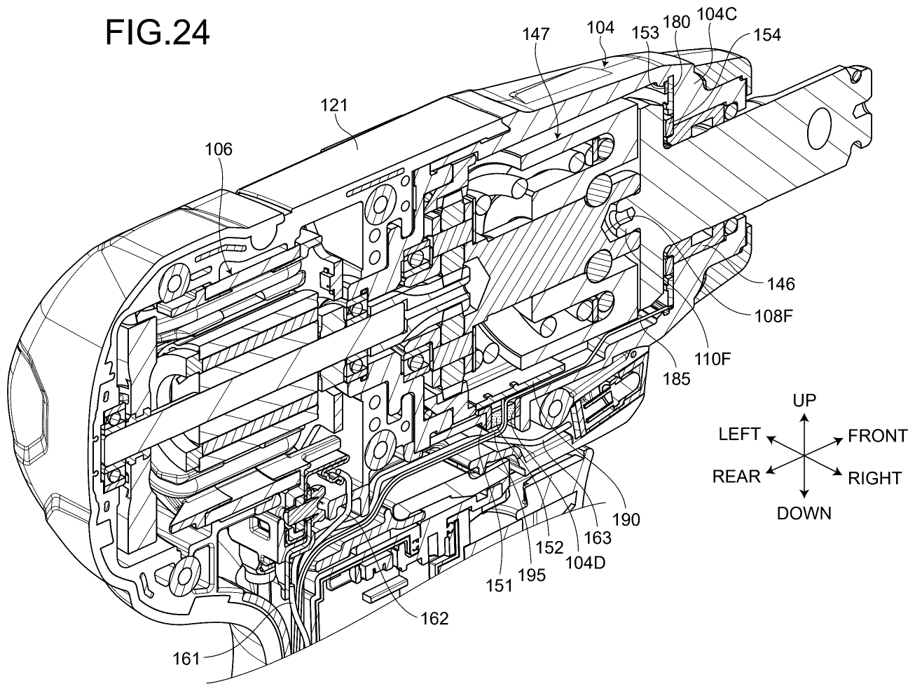

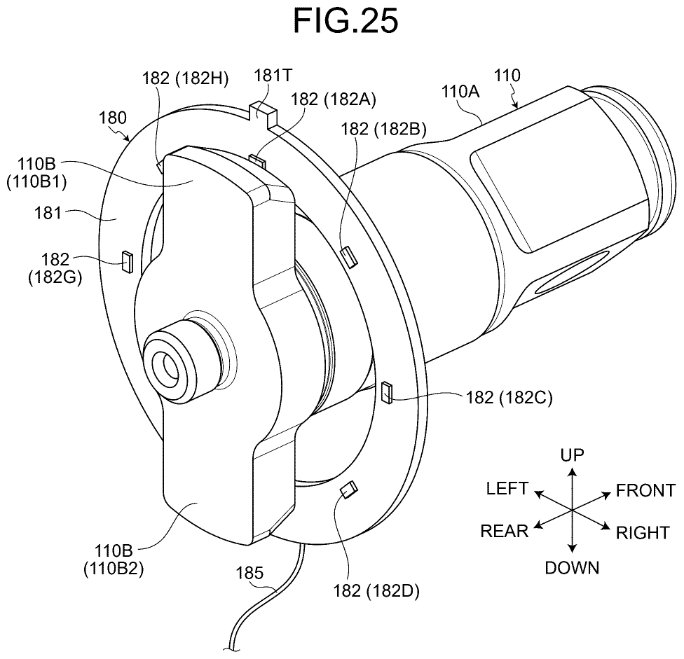

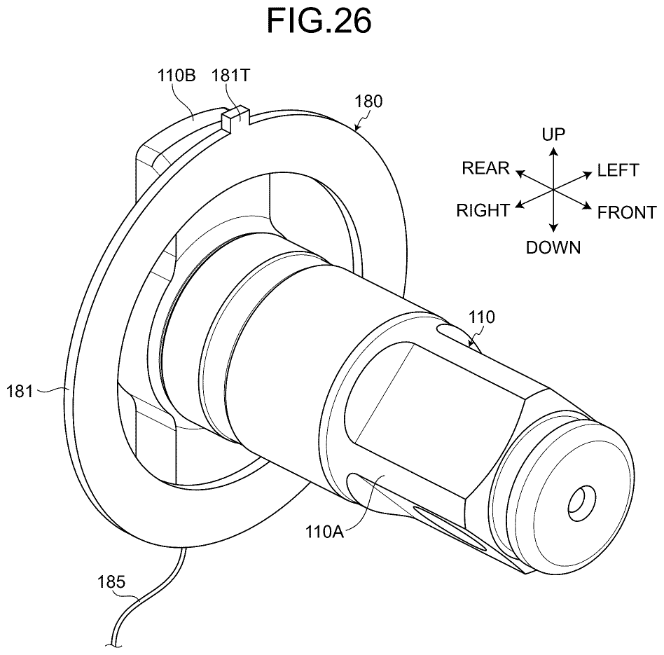

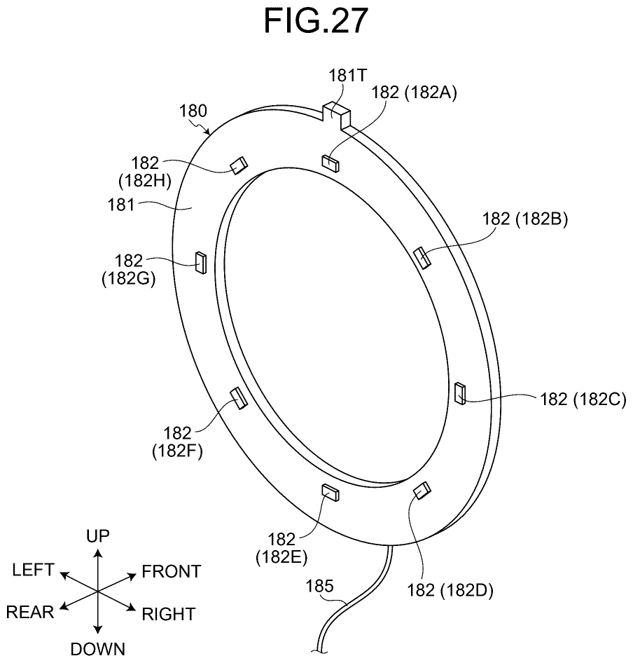

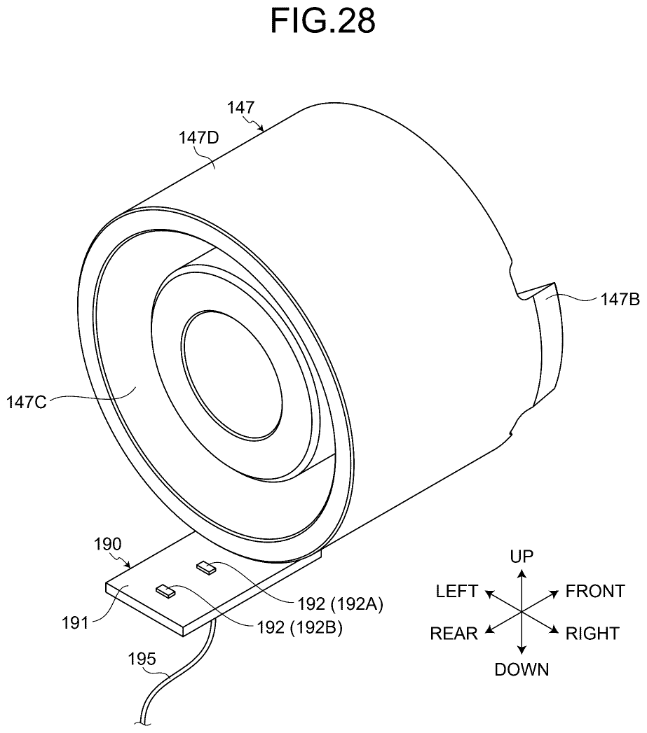

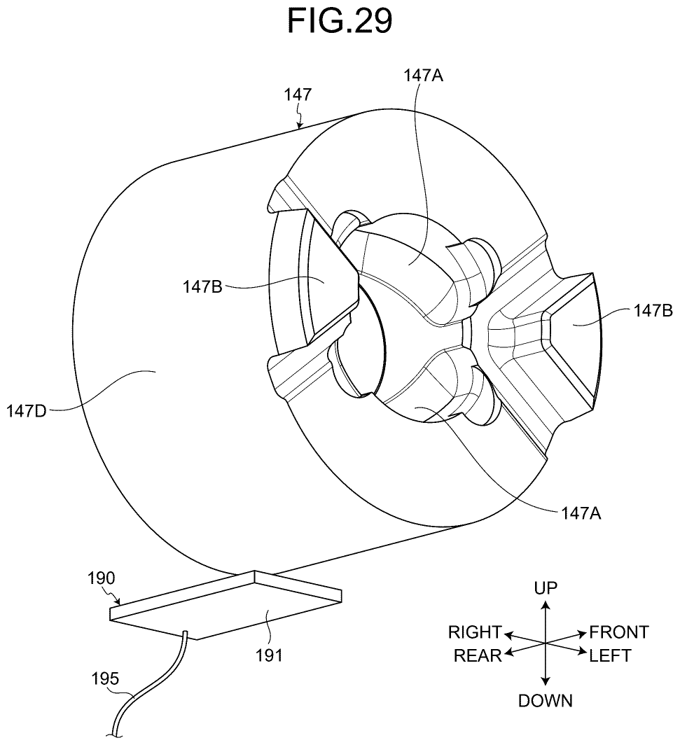

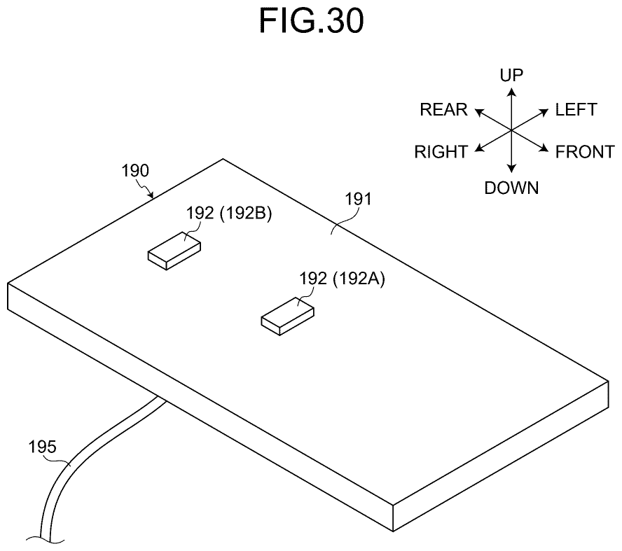

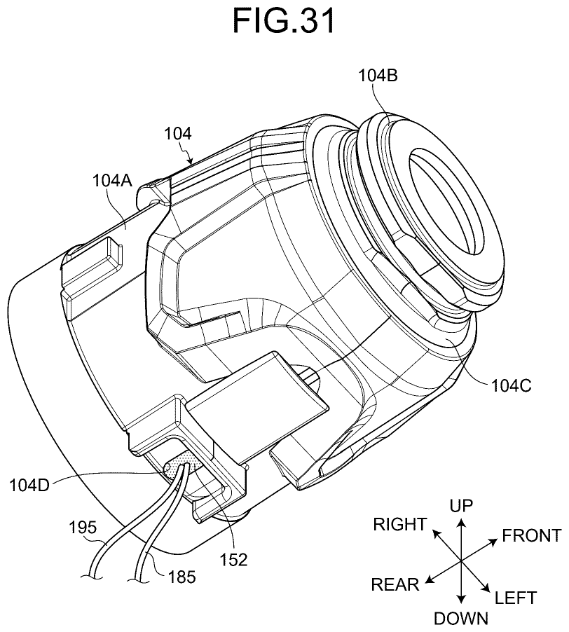

FIG. 21 is a side view that shows an impact tool according to the second embodiment. FIG. 22 is a cross-sectional view that shows the impact tool according to the second embodiment. FIG. 23 is a longitudinal cross-sectional view that shows the upper portion of the impact tool according to the second embodiment. FIG. 24 is a perspective cross-sectional view that shows the upper portion of the impact tool according to the second embodiment. FIG. 25 is a perspective view that shows the anvil and the first sensor board according to the second embodiment from the rear. FIG. 26 is a perspective view that shows the anvil and the first sensor board according to the second embodiment from the front. FIG. 27 is a perspective view that shows the first sensor board according to the second embodiment from the rear. FIG. 28 is a perspective view that shows the hammer and the second sensor board from the rear. FIG. 29 is a perspective view that shows the hammer and the second sensor board according to the second embodiment from the front. FIG. 30 is a perspective view that shows the second sensor board according to the second embodiment from the front. FIG. 31 is a perspective view that shows the hammer case according to the second embodiment from below.

In the second embodiment, the impact tool 1B is an impact wrench. Similar to the first embodiment, the impact tool 1B comprises a housing 102, a hammer case 104, a motor 106, a reduction mechanism 107, a spindle 108, an impact mechanism 109, an anvil 110, a fan 112, a battery mounting part 113, a trigger lever 114, a forward/reverse switching lever 115, a first sensor board 180, a second sensor board 190, and a controller 118.

The housing 102 is made of a synthetic resin. In the present embodiment, the housing 102 is made of nylon. The housing 102 is constituted by a pair of half-split housings on either side.

The housing 102 has a motor housing part 121, a grip part 122, and a battery holding part 123.

The motor housing part 121 is tubular shaped. The motor housing part 121 houses the motor 106 and the rear portion of the hammer case 104.

The grip part 122 protrudes downward from motor housing part 121. The trigger lever 114 is provided at the upper portion of the grip part 122. The grip part 122 is gripped by the operator.

The battery holding part 123 is connected to the lower end of the grip part 122. In each of the front-rear and left-right directions, the dimensions of the outer shape of the battery holding part 123 are larger than the dimensions of the outer shape of the grip part 122.

The hammer case 104 functions as a gear case that houses the reduction mechanism 107. That is, the hammer case 104 houses the reduction mechanism 107. The hammer case 104 also houses the spindle 108. The hammer case 104 also houses the impact mechanism 109. The hammer case 104 also houses a portion of the anvil 110. The hammer case 104 is made of metal. In the present embodiment, hammer case 104 is again made of aluminum. The hammer case 104 is tubular shaped.

The hammer case 104 includes a rear side tubular part 104A, a front side tubular part 104B, and a ring-shaped part 104C. The front side tubular part 104B is disposed more forward than the rear side tubular part 104A. The outer diameter of the rear side tubular part 104A is larger than the outer diameter of the front side tubular part 104B. The inner diameter of the rear side tubular part 104A is larger than the inner diameter of the front side tubular part 104B. The ring-shaped part 104C is arranged to connect the front end of the rear side tubular part 104A with the rear end of the front side tubular part 104B.

The hammer case 104 is connected to the front portion of the motor housing part 121. The motor housing part 121 is fixed to the rear portion of the hammer case 104.

The motor 106 is the motive power source for the impact tool 1B. The motor 106 generates a rotational force. The motor 106 is an electric motor. The motor 106 is preferably an inner rotor-type brushless motor. The motor 106 is housed in the motor housing part 121 of the housing 102.

The reduction mechanism 107 transmits the rotational force of the motor 106 to the spindle 108 and the anvil 110. The reduction mechanism 107 is housed in the rear side tubular part 104A of the hammer case 104. The reduction mechanism 107 has a plurality of gears. The reduction mechanism 107 is disposed more forward than the motor 106.

The spindle 108 is rotated by the rotational force of motor 106. The spindle 108 is disposed more forward than at least a portion of motor 106. At least a portion of the spindle 108 is disposed forward of the reduction mechanism 107.

The impact mechanism 109 is driven by the motor 106. More specifically, the rotational force of the motor 106 is transmitted to the impact mechanism 109 via the reduction mechanism 107 and the spindle 108. In some modes of operation, the impact mechanism 109 impacts (strikes) the anvil 110 in the rotational direction based on the rotational force of the spindle 108, which is rotated by the motor 106. The impact mechanism 109 includes a hammer 147, balls 148, and a coil spring 149. The impact mechanism 109, which includes the hammer 147, is housed in the hammer case 104.

The hammer 147 is disposed more forward than the reduction mechanism 107. The hammer 147 is housed in the rear side tubular part 104A. The hammer 147 is disposed around the spindle 108. The hammer 147 is supported by the spindle 108. The balls 148 are disposed between the spindle 108 and the hammer 147.

The hammer 147 has a body portion 147D, hammer grooves 147A and hammer projections 147B. The body portion 147D is disposed around the spindle 108. The body portion 147D is ring-shaped. A recessed part 147C is provided in the rear portion of the body portion 147D. The recessed part 147C is recessed forward from the rear end of the body portion 147D. The recessed part 147C is ring-shaped. The hammer projections 147B project forward from the body portion 147D. Two hammer projections 147B are provided.

The hammer 147 is rotated by the motor 106. More specifically, the rotational force of motor 106 is transmitted to the hammer 147 via the reduction mechanism 107 and the spindle 108. The hammer 147 is rotatable with the spindle 108 based on the rotational force of the spindle 108, which is rotated by the motor 106. The rotational axis of the hammer 147 coincides with the rotational axis of the spindle 108 and rotational axis AX of the motor 106. The hammer 147 rotates around rotational axis AX.

The balls 148 are made of metal, such as steel. The balls 148 are disposed between the spindle 108 and the hammer 147. The hammer 147 has hammer grooves 147A in which at least portions of the balls 148 are respectively disposed. The hammer grooves 147A are provided on portions of the inner surface of the body portion 147D.

The coil spring 149 generates an elastic force that urges the hammer 147 to move forward. A ring-shaped recessed part 147C is provided in the rear surface of the hammer 147. The recessed part 147C is recessed forward from the rear surface of the hammer 147. The front end of the coil spring 149 is disposed in the interior of the recessed part 147C.

The anvil 110 is the output part of the impact tool 1B. The anvil 110 is rotated by the rotational force of the motor 106. At least a portion of the anvil 110 is disposed more forward than the hammer 147.

The anvil 110 has a rod-shaped anvil shaft portion 110A and anvil projections 110B. The anvil projections 110B are provided on the rear end portion of the anvil 110. The anvil projections 110B project radially outward from the rear end portion of the anvil shaft portion 110A.

The hammer projections 147B are configured to contact the anvil projections 110B. By driving the motor 106 in the state in which the hammer projections 147B are in continuous contact with the anvil projections 110B, the anvil 110 rotates with the hammer 147 and the spindle 108.

The battery mounting part 113 is disposed at the lower portion of the battery holding part 123. A battery pack 125 is mounted on the battery mounting part 113. The battery pack 125 is detachable from the battery mounting part 113.

The trigger lever 114 is provided on the grip part 122. The trigger lever 114 is manipulated (pressed) by the operator to start the motor 106. The switch body 111 is disposed rearward of the trigger lever 114. The switch body 111 is disposed in the interior of the grip part 122. By manipulating the trigger lever 114, the switch body 111 is actuated. By actuating the switch body 111, a trigger signal is generated. The controller 118 switches the motor 106 between driving and stopped based on the trigger signal.

The forward/reverse (rotation) switching lever 115 is provided at the upper portion of the grip part 122. The forward/reverse switching lever 115 is manipulated by the operator. By manipulating the forward/reverse switching lever 115, the direction of rotation of the motor 106 is switched from one of the forward and reverse directions to the other. By switching the direction of rotation of the motor 106, the direction of rotation of the spindle 108 is switched.

The controller 118 includes a computer system. The controller 118 outputs control commands that control at least each of the motor 106 and the light unit 117. As shown in FIG. 22, the controller 118 is housed in the battery holding part 123 in the state in which it is held in the controller case 118A. The controller 118 includes a circuit board 118B, on which a plurality of electronic components are mounted, and a mold resin 118C that covers the circuit board 118B.

As shown in FIG. 22, the controller 118 includes a microcomputer 118D. The microcomputer 118D is disposed on the circuit board 118B.

The microcomputer 118D includes a processor (microprocessor) such as a CPU (Central Processing Unit), nonvolatile memory or storage such as ROM (Read Only Memory), and volatile memory such as RAM (Random Access Memory).

The controller 118 includes six switching elements 118J, a capacitor 118K, a resistor 118L, and a transistor 118M. Metal-oxide-semiconductor field-effect transistors (MOSFET) are exemplified as the switching elements 118J.

As shown in FIGS. 22, 23, and 24, the motor 106 is electrically connected to the controller 118 by a lead wire 161. Current from the battery pack 125 is supplied to the bus bar of the motor 106 via the controller 118 and the lead wire 161. The upper end portion of the lead wire 161 is electrically connected to the lower end portion of the bus bar of the motor 106, and the lower end portion of the lead wire 161 is electrically connected to an upper portion of the controller 118. The lead wire 161 passes through the interior of grip part 122. A portion of the lead wire 161 passes rearward of the switch body 111 in the interior of the grip part 122.

A sensor board that detects the rotation of the rotor of the motor 106 is electrically connected to the controller 118 by a lead wire 162. The detection signal output by the sensor board is transmitted to controller 118 via the lead wire 162. The microcomputer 118D of the controller 118 controls the switching elements 118J based on the detection signal of the magnetic sensors on the sensor board. The upper end portion of lead wire 162 is electrically connected to the lower end portion of the sensor board, and the lower end portion of the lead wire 162 is electrically connected to the upper surface of controller 118. The lead wire 162 passes through the interior of the grip part 122. A portion of the lead wire 162 passes rearward of the switch body 111 in the interior of the grip part 122.

The light unit 117 is electrically connected to the controller 118 by a lead wire 163. Current from the battery pack 125 is supplied to the light unit 117 via the controller 118 and the lead wire 163. By supplying current to the light unit 117, illumination light is emitted from the light unit 117. The upper end portion of lead wire 163 is electrically connected to the light unit 117, and the lower end portion of lead wire 163 is electrically connected to the upper surface of the controller 118. The lead wire 163 passes through the interior of the motor housing part 121 and the interior of the grip part 122. A portion of the lead wire 163 passes below hammer case 104 in the interior of motor housing part 121. After passing below a cushion member 151, which is described below, the lead wire 163 is drawn along the same path as the first lead wire 185 and the second lead wire 195. A portion of the lead wire 163 passes rearward of the switch body 111 in the interior of the grip part 122.

The impact tool 1B includes a first sensor board 180 that detects rotation of the anvil 110 and a second sensor board 190 that detects (linear, axial) movement of the hammer 147.

The anvil 110 has a rod-shaped anvil shaft portion 110A and a pair of anvil projections 110B that extend radially outward from the rear end portion of the anvil shaft portion 110A. The anvil projections 110B include a first anvil projection 110B1 and a second anvil projection 110B2. The first sensor board 180 detects rotation of the anvil 110 around rotational axis AX. The first sensor board 180 detects at least one of position, angular velocity, and angular acceleration of the anvil 110 in the direction of rotation around rotational axis AX.

The hammer 147 has a ring-shaped body portion 147D, a pair of hammer projections 147B provided on a front end portion of the body portion 147D, hammer grooves 147A, in which the balls 148 are respectively disposed, and a recessed part 147C provided in the rear portion of the body 147D. The second sensor board 190 detects movement of the hammer 147 in the axial (front-rear) direction. The second sensor board 190 detects at least one of position, movement speed, and movement acceleration of the hammer 147 in the axial direction.

Both of the first sensor board 180 and the second sensor board 190 are disposed in the interior of the hammer case 104. Both of the first sensor board 180 and the second sensor board 190 are fixed to the hammer case 104. The first sensor board 180 is supported on the rear surface of the ring-shaped part 104C of the hammer case 104. The second sensor board 190 is supported on the lower inner surface of the rear side tubular part 104A of the hammer case 104.

The first sensor board 180 comprises a first circuit board 181 and a plurality of first sensors 182 mounted on the rear surface of the first circuit board 181.

The first circuit board 181 can be a printed wiring board (PWB) or a printed circuit board (PCB) on which multiple electronic components are mounted. The first circuit board 181 is disposed at least partially around the anvil shaft portion 110A. In the embodiment, the first circuit board 181 has a circular shape that is disposed completely around the anvil shaft portion 110A. The first circuit board 181 has a convex part 181T at an upper portion thereof. The convex part 181T protrudes upward from the upper portion of the first circuit board 181.

As in the first embodiment described above, the position of the first sensor board 180 relative to the hammer case 104 in the direction of rotation is fixed by disposing the convex part 181T in a recessed part provided in the inner circumference of the rear side tubular part 104A of the hammer case 104.

The periphery of the rear surface of the first circuit board 181 is supported by (on) the retaining ring 153. The retaining ring 153 contacts the peripheral edge of the rear surface of the first circuit board 181. The retaining ring 153 fits into a groove provided in the inner circumference of the rear side tubular part 104A. The first sensor board 180 is blocked from moving rearward by the retaining ring 153. The front surface of the first circuit board 181 contacts the rear surface of the ring-shaped part 104C. The retaining ring 153 fixes the position of the first sensor board 180 relative to the hammer case 104 in the front-rear direction.

A washer 154 is disposed between the front surface of the anvil projections 110B and an anvil bearing 146. The anvil bearing 146 is a plain bearing made of oil impregnated metal. The front surface of the washer 154 contacts the rear surface of the anvil bearing 146. A portion of the front surface of the washer 154 also contacts the rear surface of the ring-shaped part 104C. The rear surface of the washer 154 contacts the front surface of the anvil projections 110B. The washer 154 blocks the anvil projections 110B from contacting the anvil bearing 146. That is, the anvil bearing 146 is prevented from being damaged by the anvil projections 110B by the washer 154.

The first sensors 182 detect rotation of the anvil 110. The first sensors 182 are mounted on the rear surface of the first circuit board 181. The first sensors 182 are disposed at positions that face the front surface of the anvil projections 110B.

The first sensors 182 include inductive sensors. Because the anvil 110 is made of metal, the first sensors 182 can detect rotation of the anvil 110 in a non-contacting manner. Rotation of the anvil 110 can be rephrased as the position of the anvil 110 in the rotational direction. In other words, the first sensors 182 can detect the position of the anvil 110 in the rotational direction in a non-contacting manner. Furthermore, rotation of the anvil 110 can also be said to be the number of rotations of the anvil 110. That is, the first sensors 182 can detect the number of rotations of the anvil 110 in a non-contacting manner.

The first sensors 182 are provided (arranged) in (around) the circumferential direction of rotational axis AX. In the embodiment, eight first sensors 182 are provided at equal intervals in the circumferential direction on the rear surface of the first circuit board 181. The first sensors 182 include a first sensor 182A, a first sensor 182B, a first sensor 182C, a first sensor 182D, a first sensor 182E, a first sensor 182F, a first sensor 182G and a first sensor 182H. In the circumferential direction, if the position of the upper portion of the first sensor board 181 is located at the 0° position, the position of the right portion is located at the 90° position, the position of the lower portion is located at the 180° position, and the position of the left portion is located at the 270° position, then the first sensor 182A is located at the 0° position, the first sensor 182B is located at the 45° position, the first sensor 182C is located at the 90° position, the first sensor 182D is located at the 135° position, the first sensor 182E is located at the 180° position, the first sensor 182F is located at the 225° position, the sensor 182G is located at the 270° position, and the first sensor 182H is located at the 315° position.

FIG. 25 shows the state in which the first anvil projection 110B1 and the first sensor 182A are facing each other and the second anvil projection 110B2 and the first sensor 182E are facing each other. In the state shown in FIG. 25, the first sensor 182A detects the first anvil projection 110B1 and the first sensor 182E detects the second anvil projection 110B2.

In the state in which the anvil 110 is rotated 45° from the state shown in FIG. 25 and the first anvil projection 110B1 is facing the first sensor 182B and the second anvil projection 110B2 is facing the first sensor 182F, the first sensor 182B detects the first anvil projection 110B1 and the first sensor 182F detects the second anvil projection 110B2.

In the state in which the anvil 110 is rotated 315° from the state shown in FIG. 25 and the first anvil projection 110B1 is facing the first sensor 182H and the second anvil projection 110B2 is facing the first sensor 182D, the first sensor 182H detects the first anvil projection 110B1 and the first sensor 182D detects the second anvil projection 110B2.

As in the first embodiment described above, a groove is provided in the lower part of the hammer case 104, in which the second circuit board 191 is disposed, and the position of the second sensor board 190 relative to the hammer case 104 is fixed thereby.

The second sensor board 190 comprises a second circuit board 191 and a plurality of second sensors 192 mounted on the upper surface of the second circuit board 191.

The second circuit board 191 may be a printed wiring board (PWB) or a printed circuit board (PCB) on which multiple electronic components are mounted. The second circuit board 191 is disposed at a position that faces the lower portion of the outer surface of the body portion 147D of the hammer 147. In the embodiment, the second circuit board 191 has a plate shape that faces the lower surface of the body portion 147D.

The second sensors 192 detect axial movement of the hammer 147. The second sensors 192 are mounted on the upper surface of the second circuit board 191. The second sensors 192 are disposed at positions that face the lower surface of the body portion 147D.

The second sensors 192 include inductive sensors. Because the hammer 147 is made of metal, the second sensors 192 can detect movement of the hammer 147 in a non-contacting manner. Movement of the hammer 147 can be rephrased as the position of the hammer 147 in the front-rear direction. In other words, the second sensors 192 can detect the position of the hammer 147 in the front-rear direction in a non-contacting manner. Furthermore, movement of the hammer 147 can also be rephrased as the movement speed of the hammer 147. In other words, the second sensors 192 can detect the moving speed of the hammer 147 in a non-contacting manner.

The second sensors 192 are provided (arranged) in (along) the axial direction. In the embodiment, two second sensors 192 are provided in the axial direction on the upper surface of the second circuit board 191. The second sensor 192 includes a second sensor 192A and a second sensor 192B. The second sensor 192A is disposed more forward than the second sensor 192B.

FIG. 28 shows a state in which the hammer 147 does not face each of the second sensor 192A and the second sensor 192B. In the state shown in FIG. 28, neither the second sensor 192A nor the second sensor 192B detects the hammer 147.

In the state in which the hammer 147 has moved rearward from the state shown in FIG. 28 and the hammer 147 and the second sensor 192A face each other and the hammer 147 and the second sensor 192B do not face each other, the second sensor 192A detects the hammer 147 and the second sensor 192B does not detect the hammer 147.

In the state in which the hammer 147 has moved further rearward and the hammer 147 is facing each of the second sensor 192A and the second sensor 192B, each of the second sensor 192A and the second sensor 192B detects the hammer 147. It is noted that the second sensor 192B may detect the hammer 147 and the second sensor 192A may not detect the hammer 147.

The first circuit board 181 and the controller 118 are electrically connected by the first lead wire 185. The second circuit board 191 and the controller 118 are electrically connected by the second lead wire 195. The detection data of the first sensors 182 is transmitted to the controller 118 via the first lead wire 185. The detection data of the second sensors 192 is transmitted to the controller 118 via the second lead wire 195. The controller 118 controls the tightening torque when the impact tool 1B tightens a fastening component, such as a bolt or nut, based on the detection data output by the first sensors 182 and the second sensors 192. The controller 118 controls the tightening torque by controlling the rotation speed of the motor 106 based on the detection data of the first sensor 182 and the second sensor 192. The controller 118 estimates the current tightening torque based on the detection data of the first sensor 182 and the second sensor 192 and then controls the rotation speed of the motor 106 such that the fastening component is to be tightened at the target tightening torque (the specified range of torque).

Both of the first circuit board 181 and the second circuit board 191 are disposed in the interior of the hammer case 104. The hammer case 104 has a hole 104D through which the first lead wire 185 and the second lead wire 195 pass. The first lead wire 185 and the second lead wire 195 exit the hammer case 104 through the hole 104D and then pass through the interior of the grip part 122 to connect to the controller 118. The first lead wire 185 and the second lead wire 195 pass rearward of the switch body 111 in the interior of the grip part 122.

As can be seen in FIG. 24, a rearward protruding convex portion 110F is provided on the rear end of anvil 110. A recessed part 108F into which the convex portion 110F is inserted is provided at the front end of the spindle 108. The first lead wire 185 passes below the convex portion 110F and the recessed part 108F.

The cushion member 151 is arranged to cover the edge of the hole 104D. The cushion member 151 is a substantially tubular member. Each of the first lead wire 185 and the second lead wire 195 passes through a passageway in the interior of the cushion member 151. A sponge 152 is disposed in the passageway of the cushion member 151. The sponge 152 fills the gap between the inner surface of the cushion member 151 and the outer surface of the first lead wire 185. The sponge 152 also fills the gap between the inner surface of the cushion member 151 and the outer surface of the second lead wire 195. When grease (lubricant) is disposed in the interior of the hammer case 104, the grease is blocked by the sponge 152 from leaking from the interior of the hammer case 104 to the outside through the passage of the cushion member 151.

The upper end portion of the first lead wire 185 is electrically connected to a lower end portion of the first sensor board 180, and the lower end portion of the first lead wire 185 is electrically connected to the upper surface of the controller 118. The first lead wire 185, which extends from the lower end of the first sensor board 180, passes below the hammer 147 in the interior of the hammer case 104 and leads to below the second sensor board 190. The first lead wire 185, which is drawn rearward below the second sensor board 190, passes through the passageway in the cushion member 151 to below the hammer case 104. The first lead wire 185, which is drawn rearward below the hammer case 104, leads into the interior of the grip part 122. The first lead wire 185 passes rearward of the switch body 111 in the interior of the grip part 122. After passing through the passageway of the cushion member 151, the wiring paths of the first lead wire 185 and the lead wire 163 are substantially the same.

The first lead wire 185 is partitioned (and joined) in the interior of the grip part 122. As shown in FIG. 22, the portion of the first lead wire 185, which extends from the lower end portion of the first sensor board 180, and the portion of the first lead wire 185, which extends from the upper surface of the controller 118, are electrically connected via a connector 185C. If replacement of the first sensor board 180 and/or the controller 118 becomes necessary, then the replacement can be facilitated by detaching the connector 185C.

The upper end portion of the second lead wire 195 is electrically connected to the lower surface of the second sensor board 190, and the lower end portion of the second lead wire 195 is electrically connected to the upper surface of the controller 118. The second lead wire 195, which extends from the lower side of the second sensor board 190, passes through the passageway in the cushion member 151 to below the hammer case 104. The second lead wire 195, which is drawn rearward below the hammer case 104, leads into the interior of the grip part 122. The second lead wire 195 passes rearward of the switch body 111 in the interior of the grip part 122. After passing through the passageway of the cushion member 151, the wiring paths of the second lead wire 195, the first lead wire 185, and the lead wire 163 are substantially the same.

The second lead wire 195 is also partitioned (and joined) in the interior of the grip part 122. As shown in FIG. 22, the portion of the second lead wire 195, which extends from the lower surface of the second sensor board 190, and the portion of the second lead wire 195, which extends from the upper surface of the controller 118, are electrically connected via a connector 195C. If replacement of the second sensor board 190 and/or the controller 118 becomes necessary, then the replacement can be facilitated by detaching the connector 195C.

As explained above, in the embodiment, rotation of the anvil 110 is detected by the first sensor board 180 and (axial, linear) movement of the hammer 147 is detected by the second sensor board 190 in the impact tool 1B, which is an impact wrench. The controller 118 can control the tightening torque based on the detection data output by the first sensors 182 and the second sensors 192.

### Third Embodiment

The third embodiment is described below. In the following description, the same symbols will be attached to the components that are the same or equivalent to those of the above-mentioned embodiments, and the description of the components will be simplified or omitted.

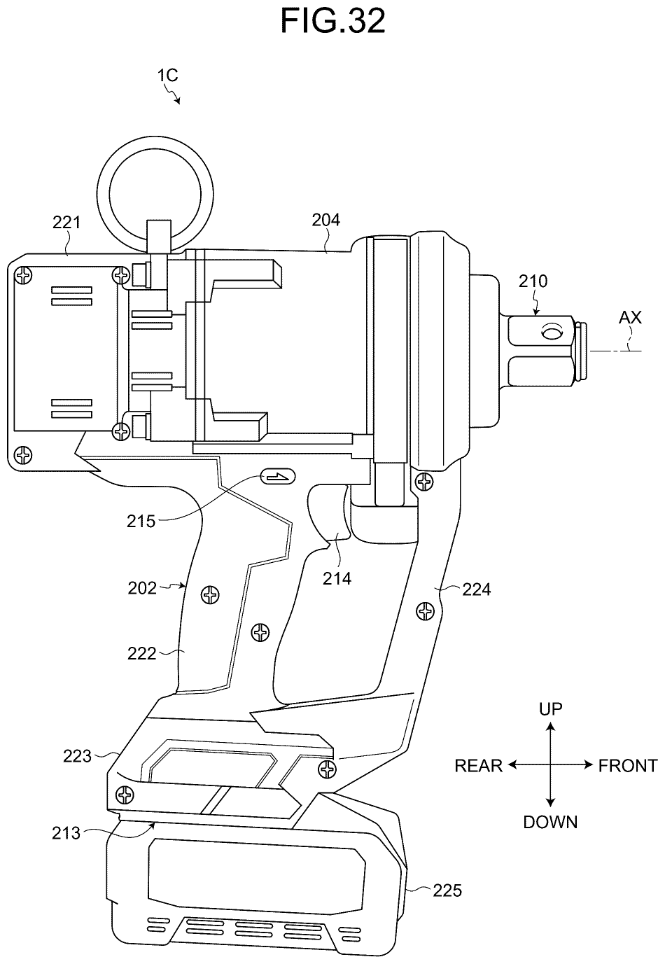

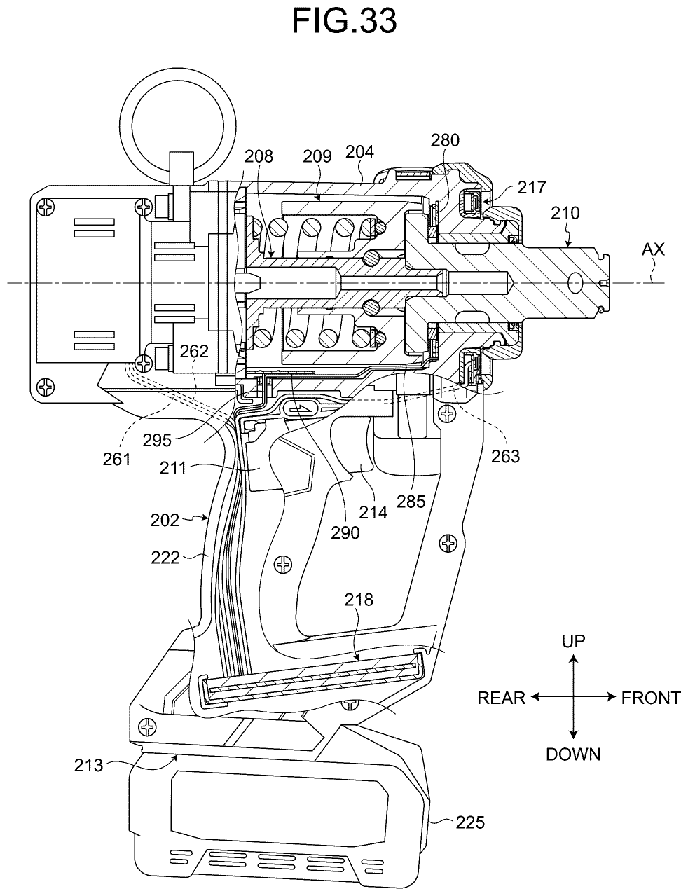

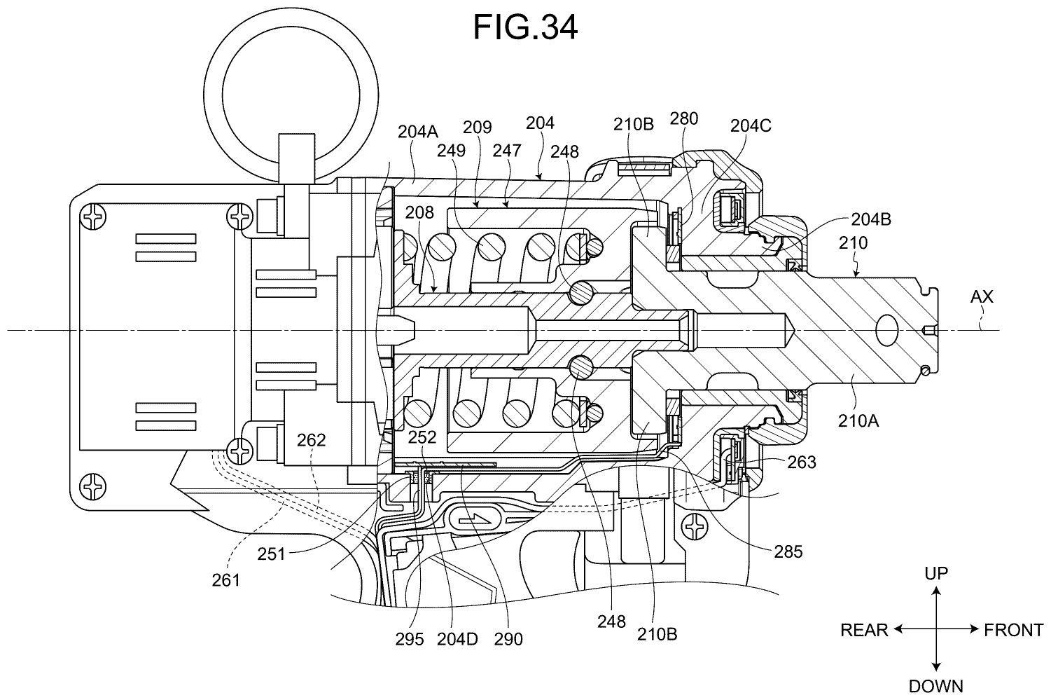

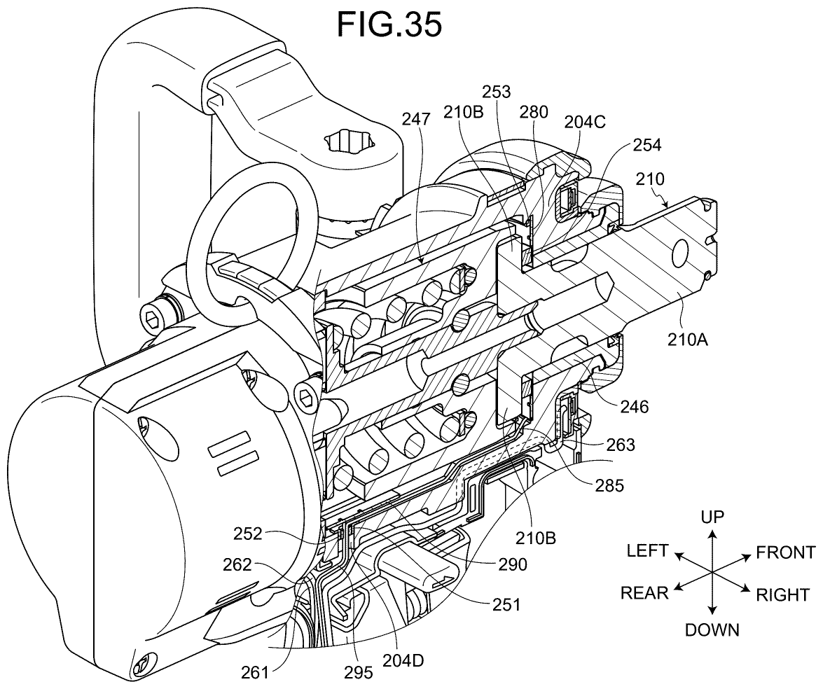

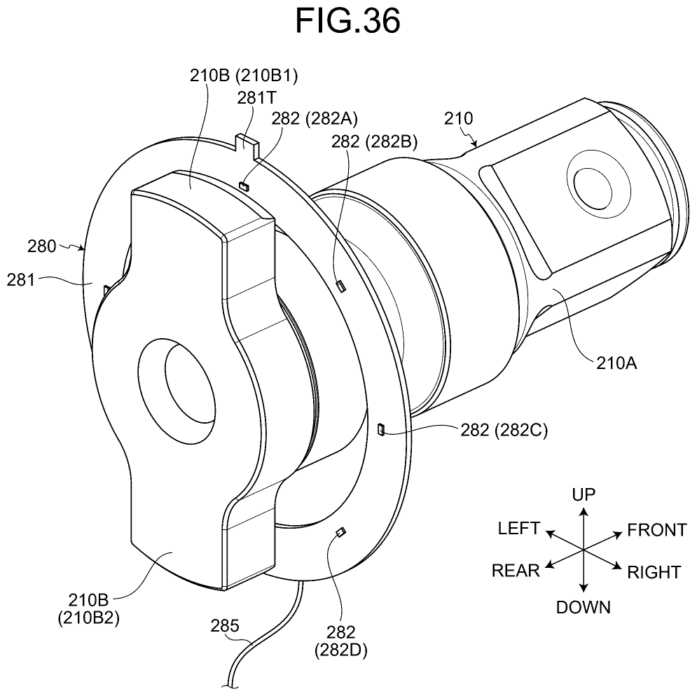

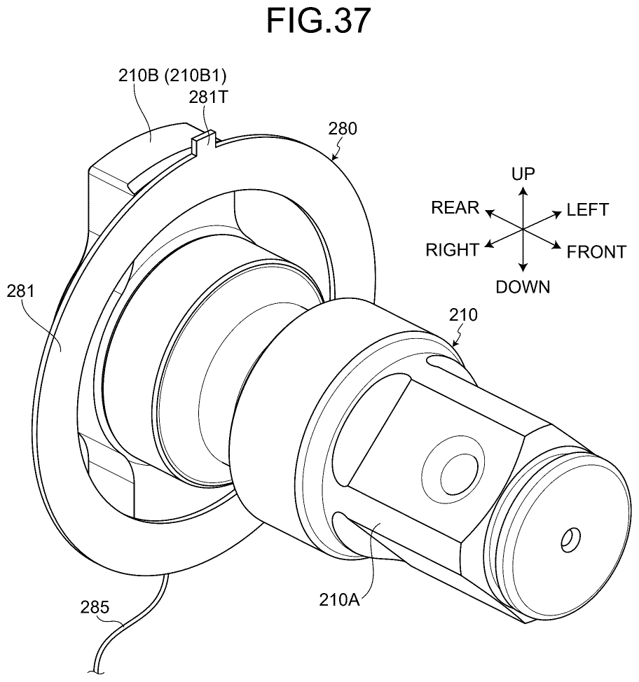

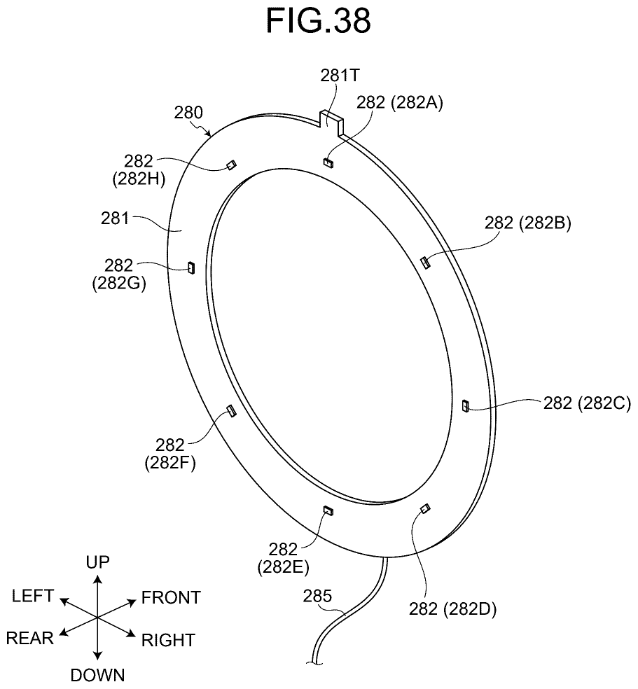

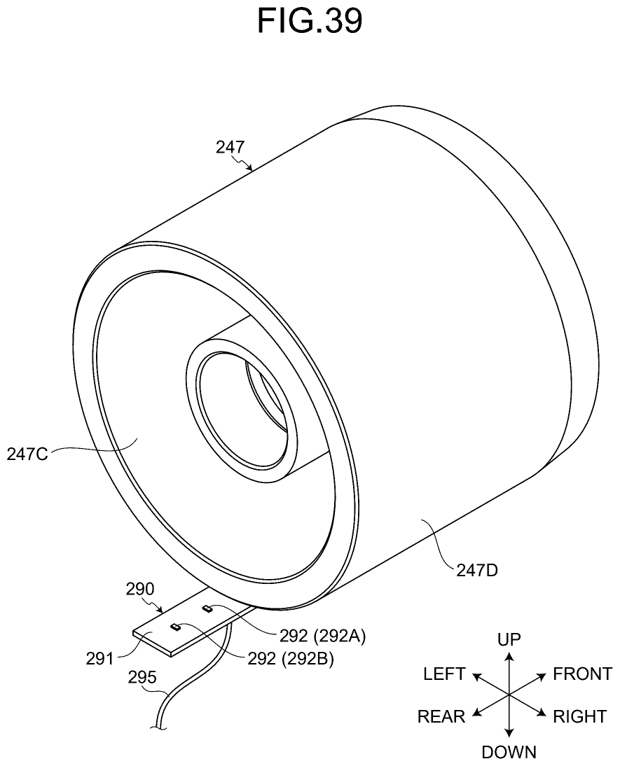

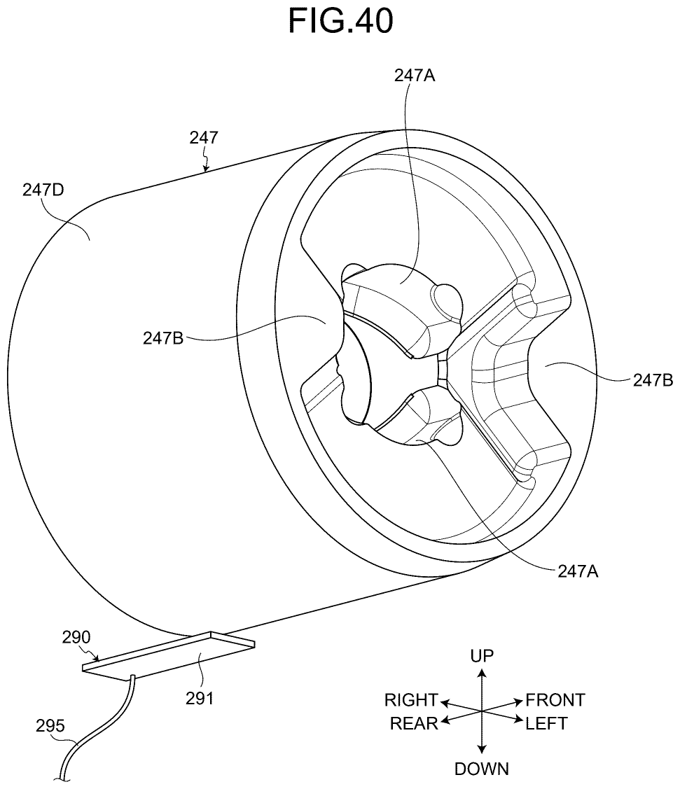

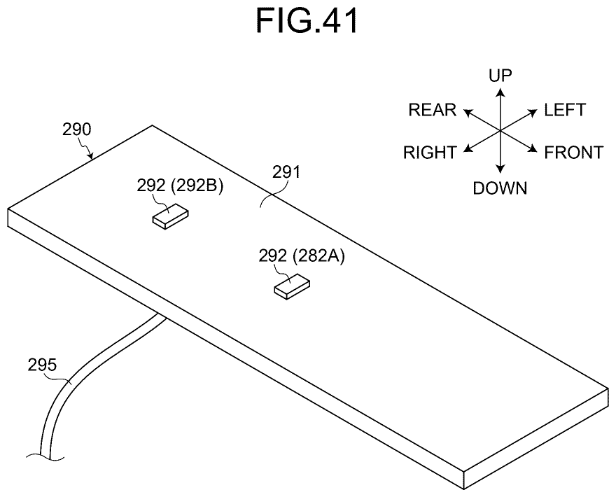

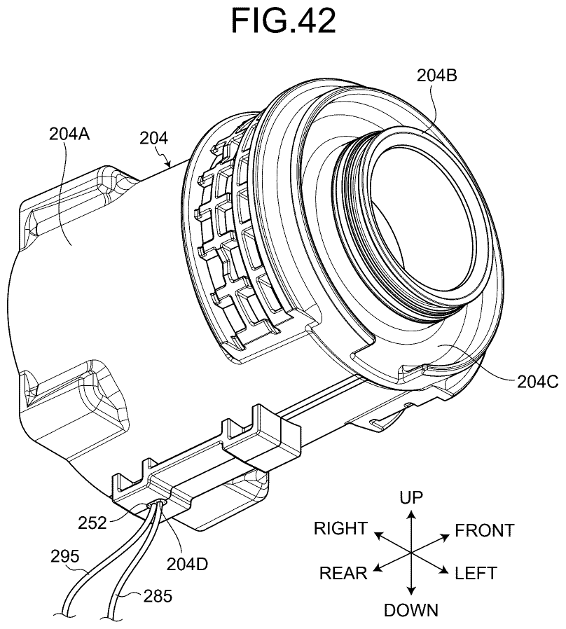

FIG. 32 is a side view that shows an impact tool according to the third embodiment. FIG. 33 is a cross-sectional view that shows the impact tool according to the third embodiment. FIG. 34 is a longitudinal cross-sectional view that shows the upper portion of the impact tool according to the third embodiment. FIG. 35 is a perspective cross-sectional view that shows the upper portion of the impact tool according to the third embodiment. FIG. 36 is a perspective view that shows the anvil and a first sensor board according to the third embodiment from the rear. FIG. 37 is a perspective view that shows the anvil and the first sensor board according to the third embodiment from the front. FIG. 38 is a perspective view that shows the first sensor board according to the third embodiment from the rear. FIG. 39 is a perspective view that shows the hammer and a second sensor board according to the third embodiment from the rear. FIG. 40 is a perspective view that shows the hammer and the second sensor board according to the third embodiment from the front. FIG. 41 is a perspective view that shows the second sensor board according to the third embodiment from the front. FIG. 42 is a perspective view that shows the hammer case according to the third embodiment from below.

In the third embodiment, the impact tool 1C is an impact wrench. Similar to the preceding embodiments, the impact tool 1C comprises a housing 202, a hammer case 204, a spindle 208, an impact mechanism 209, an anvil 210, a battery mounting part 213, a trigger lever 214, a forward/reverse switching lever 215, a first sensor board 280, a second sensor board 290, and a controller 218.

The housing 202 includes a motor housing part 221, a rear grip part 222, a battery holding part 223 and a front grip part 224.

The motor housing part 221 is tubular shaped. The rear grip part 222 extends downward from the motor housing part 221. The trigger lever 214 is provided at the upper portion of the rear grip part 222. The grip part 122 is configured to be gripped by the operator. The front grip part 224 is disposed more forward than the rear grip part 222. The battery holding portion 223 is connected to a lower end portion of the rear grip part 222 and a lower end portion of the front grip part 224.

The hammer case 204 includes a rear side tubular part 204A, a front side tubular part 204B, and a ring-shaped part 204C. The front side tubular portion 204B is disposed more forward than the rear side tubular part 204A. The outer diameter of the rear side tubular part 204A is larger than the outer diameter of the front side tubular portion 204B. The inner diameter of the rear side tubular part 204A is larger than the inner diameter of the front side tubular portion 204B. The ring-shaped part 204C is arranged to connect the front end of the rear side tubular part 204A with the rear end of the front side tubular portion 204B.

The hammer case 204 is connected to the front portion of the motor housing part 221. The motor housing part 221 is fixed to the rear portion of the hammer case 204.

The spindle 208 is rotated by the rotational force of a motor (not shown).

Similar to the preceding embodiments, the impact mechanism 209 includes a hammer 247, balls 248, and a coil spring 249. The impact mechanism 209, which includes the hammer 247, is housed in the hammer case 204.

The hammer 247 has a body portion 247D, hammer grooves 247A, and hammer projections 247B. The body portion 247D is disposed around the spindle 208. The body portion 247D is ring-shaped. A recessed part 247C is provided in the rear of the body portion 247D. The recessed part 247C is recessed forward from the rear end of the body portion 247D. The recessed part 247C is ring-shaped. The hammer projections 247B project forward from the body portion 247D. Two hammer projections 247B are provided.

The anvil 210 has a rod-shaped anvil shaft portion 210A and anvil projections 210B. The anvil projections 210B are provided on the rear end portion of the anvil 210. The anvil projections 210B project radially outward from the rear end portion of the anvil shaft portion 210A.

The battery mounting part 213 is disposed below the battery holding part 223. A battery pack 225 is mounted on the battery mounting portion 213. The battery pack 225 is detachable from the battery mounting portion 213.

The trigger lever 214 is provided on the rear grip part 222. The switch body 211 is disposed rearward of the trigger lever 214. The switch body 211 is disposed in the interior of the grip part 122. By manipulating the trigger lever 214, the switch body 211 is actuated. When the switch body 211 is actuated, a trigger signal is generated.

The forward/reverse (rotation) switching lever 215 is provided at an upper portion of the rear grip part 222. The forward/reverse switching lever 215 is manipulated by the operator.

The impact tool 1C includes a first sensor board 280 that detects rotation of the anvil 210 and a second sensor board 290 that detects (axial, linear) movement of the hammer 247.

As was noted above, the anvil 210 has the rod-shaped anvil shaft portion 210A and the pair of anvil projections 210B that extend radially outward from the rear end portion of the anvil shaft portion 210A. The first sensor board 280 detects rotation of the anvil 210 around rotational axis AX. The first sensor board 280 detects at least one of position, angular velocity, and angular acceleration of the anvil 210 in the direction of rotation around rotational axis AX.

As was noted above, the hammer 247 has the ring-shaped body portion 247D, the pair of hammer projections 247B provided at the front end of the body portion 247D, the hammer grooves 247A, in which the balls 248 are respectively disposed, and the recessed part 247C provided in the rear portion of the body part 247D. The second sensor board 290 detects movement of the hammer 247 in the axial (front-rear) direction. The second sensor board 290 detects at least one of position, movement speed, and movement acceleration of the hammer 247 in the axial direction.

The motor is electrically connected to the controller 218 by a lead wire 261. Current from the battery pack 225 is supplied to the motor via the controller 218 and the lead wire 261. An upper end portion of lead wire 261 is electrically connected to a lower end portion of the motor and a lower end portion of the lead wire 261 is electrically connected to the upper surface of controller 218. The lead wire 261 passes through the interior of rear grip part 222. A portion of the lead wire 261 passes rearward of the switch body 211 in the interior of the rear grip part 222.

A sensor board, which detects rotation of the rotor of the motor, and the controller 218 are connected by a lead wire 262. The detection signal from the sensor board is transmitted to the controller 218 via the lead wire 262. The controller 218 controls the motor based on the detection signal of magnetic sensors provided on the sensor board. An upper end portion of the lead wire 262 is electrically connected to a lower end portion of the sensor board, and a lower end portion of the lead wire 262 is electrically connected to the upper surface of controller 218. The lead wire 262 passes through the interior of rear grip part 222. A portion of the lead wire 262 passes rearward of the switch body 211 in the interior of rear grip part 222.

The light unit 217 is electrically connected to the controller 218 by a lead wire 263. Current from the battery pack 225 is supplied to the light unit 217 via the controller 218 and the lead wire 263. By supplying current to the light unit 217, illumination light is emitted from the light unit 217. An upper end portion of lead wire 263 is electrically connected to a lower end portion of light unit 217, and a lower end portion of the lead wire 263 is electrically connected to the upper surface of controller 218. The lead wire 263 passes through the interior of rear grip part 222. A portion of the lead wire 263 passes below hammer case 204. The lead wire 263 passes below a cushion member 251, which is described below, and then is drawn along the same path as a first lead wire 285 and a second lead wire 295. A portion of the lead wire 263 passes rearward of the switch body 211 in the interior of rear grip part 222.

Both of the first sensor board 280 and the second sensor board 290 are disposed in the interior of the hammer case 204. Both of the first sensor board 280 and the second sensor board 290 are fixed to the hammer case 204. The first sensor board 280 is supported on the rear surface of the ring-shaped part 204C of the hammer case 204. The second sensor board 290 is supported on the lower inner surface of the rear side tubular part 204A of the hammer case 204.

As was mentioned above, the anvil 210 has the rod-shaped anvil shaft portion 210A and the pair of anvil projections 210B that extends radially outward from the rear end portion of anvil shaft portion 210A. The anvil projections 210B include a first anvil projection 210B1 and a second anvil projection 210B2. The first sensor board 280 detects rotation of the anvil 210 around rotational axis AX. The first sensor board 280 detects at least one of position, angular velocity, and angular acceleration of the anvil 210 in the direction of rotation around rotational axis AX.

The first sensor board 280 comprises a first circuit board 281 and a plurality of first sensors 282 mounted on the rear surface of the first circuit board 281.

The first circuit board 281 can be a printed wiring board (PWB) or a printed circuit board (PCB) on which multiple electronic components are mounted. The first circuit board 281 is disposed at least partially around the anvil shaft portion 210A. In the embodiment, the first circuit board 281 has a circular shape that is disposed (extends) completely around the anvil shaft portion 210A. The first circuit board 281 has a convex part 281T at an upper portion thereof. The convex part 281T protrudes upward from the upper portion of the first circuit board 281.

As in the embodiments described above, by disposing the convex part 281T in a recessed part provided on the inner surface of the hammer case 204, the position of the first sensor board 280 relative to the hammer case 204 in the direction of rotation is fixed.

The periphery of the rear surface of the first circuit board 281 is supported by (on) a retaining ring 253. The retaining ring 253 contacts the peripheral edge of the rear surface of the first circuit board 281. The retaining ring 253 fits into a groove provided on the inner circumference of the rear side tubular part 204A. The first sensor board 280 is blocked from moving rearward by the retaining ring 253. The front surface of the first circuit board 281 contacts the rear surface of the ring-shaped part 204C. The position of the first sensor board 280 relative to the hammer case 204 in the front-rear direction is fixed by the retaining ring 253.

As can be seen in FIG. 35, a washer 254 is disposed between the front surface of the anvil projections 210B and the outer ring of an anvil bearing 246. The anvil bearing 246 is a plain bearing made of oil impregnated metal. The front surface of the washer 254 contacts the rear surface of the anvil bearing 246. A portion of the front surface of the washer 254 also contacts the rear surface of the ring-shaped part 204C. The rear surface of washer 254 contacts the front surface of the anvil projections 210B. The washer 254 blocks the anvil projection 210B from contacting the anvil bearing 246. That is, the anvil bearing 246 is prevented from being damaged by the anvil projections 210B by the washer 254.

The first sensors 282 detect the rotation of the anvil 210. The first sensors 282 are mounted on the rear surface of the first circuit board 281. The first sensors 282 are disposed at positions that face the front surface of the anvil projections 210B.

The first sensors 282 include inductive sensors. Because the anvil 210 is made of metal, the first sensors 282 can detect rotation of the anvil 210 in a non-contacting manner. Rotation of the anvil 210 can be rephrased as the position of anvil 210 in the direction of rotation. In other words, the first sensors 282 can detect the position of the anvil 210 in the rotational direction in a non-contacting manner. Furthermore, rotation of the anvil 210 can also be said to be the number of rotations of the anvil 210. That is, the first sensors 282 can detect the number of rotations of the anvil 210 in a non-contacting manner.

The first sensors 282 are provided (arranged) in (along) the circumferential direction of rotational axis AX. In the embodiment, eight first sensors 282 are provided at equal intervals in the circumferential direction on the rear surface of the first circuit board 281. The first sensors 282 include a first sensor 282A, a first sensor 282B, a first sensor 282C, a first sensor 282D, a first sensor 282E, a first sensor 282F, a first sensor 282G, and a first sensor 282H. In the circumferential direction, if the position of the upper portion of the first sensor board 281 is located at the 0° position, the position of the right portion is located at the 90° position, the position of the lower portion is located at the 180° position, and the position of the left portion is located at the 270° position, then the first sensor 282A is located at the 0° position, the first sensor 282B is located at the 45° position, the first sensor 282C is located at the 90° position, the first sensor 282D is located at the 135° position, the first sensor 282E is located at the 180° position, the first sensor 282F is located at the 225° position, the first sensor 282G is located at the 270° position, and the first sensor 282H is located at the 315° position.

In the state in which the anvil 210 is rotated 45° from the state shown in FIG. 36 and the first anvil projection 210B1 is facing the first sensor 282B and the second anvil projection 210B2 is facing the first sensor 282F, the first sensor 282B detects the first anvil projection 210B1 and the first sensor 282F detects the second anvil projection 210B2.

In the state in which the anvil 210 is rotated 315° from the state shown in FIG. 36 and the first anvil projection 210B1 is facing the first sensor 282H and the second anvil projection 210B2 is facing first sensor 282D, the first sensor 282H detects the first anvil projection 210B1 and the first sensor 282D detects the second anvil projection 210B2.

As in the first and second embodiments described above, a groove is provided in the lower part of the hammer case 204, in which the second circuit board 291 is disposed, and the position of the second sensor board 290 relative to the hammer case 204 is fixed.

The second sensor board 290 comprises a second circuit board 291 and a plurality of second sensors 292 mounted on the upper surface of the second circuit board 291.

The second circuit board 291 can be a printed wiring board (PWB) or a printed circuit board (PCB) on which multiple electronic components are mounted. The second circuit board 291 is disposed facing the lower portion of the outer surface of the body portion 247D of the hammer 247. In the embodiment, the second circuit board 291 has a plate shape that faces the lower surface of the body portion 247D.

The second sensors 292 detect axial movement of the hammer 247. The second sensors 292 are mounted on the upper surface of the second circuit board 291. The second sensors 292 are disposed at positions that face the lower surface of the body portion 247D.

The second sensors 292 include inductive sensors. Because the hammer 247 is made of metal, the second sensor 292 can detect movement of the hammer 247 in a non-contacting manner. Movement of the hammer 247 can be rephrased as the position of the hammer 247 in the front-rear direction. In other words, the second sensors 292 can detect the position of the hammer 247 in the front-rear direction in a non-contacting manner. Furthermore, movement of the hammer 247 can be rephrased as the movement speed of the hammer 247. In other words, the second sensors 292 can detect the moving speed of the hammer 247 in a non-contacting manner.

The second sensors 292 are provided in the axial direction. In the embodiment, two second sensors 292 are provided (arranged) in the axial direction on the upper surface of the second circuit board 291. The second sensors 292 include a second sensor 292A and a second sensor 292B. The second sensor 292A is disposed more forward than the second sensor 292B.

FIG. 39 shows the state in which the hammer 247 does not face each of the second sensors 292A and 292B. In the state shown in FIG. 39, neither the second sensor 292A nor the second sensor 292B detects the hammer 247.

In the state in which the hammer 247 has moved rearward from the state shown in FIG. 39 and the hammer 247 and the second sensor 292A face each other and the hammer 247 and the second sensor 292B do not face each other, the second sensor 292A detects the hammer 247 and the second sensor 292B does not detect the hammer 247.

In the state in which the hammer 247 has moved further rearward and the hammer 247 is facing each of the second sensors 292A and 292B, each of the second sensors 292A and 292B detects the hammer 247. It is noted that the second sensor 292B may detect the hammer 247 and the second sensor 292A may not detect the hammer 247.

The first circuit board 281 and the controller 218 are electrically connected by the first lead wire 285. The second circuit board 291 and the controller 218 are electrically connected by the second lead wire 295. The detection data of the first sensors 282 is transmitted to the controller 218 via the first lead wire 285. The detection data of the second sensors 292 is transmitted to the controller 218 via the second lead wire 295. The controller 218 controls the tightening torque when the impact tool 1C tightens a fastening component, such as a bolt or nut, based on the detection data output by the first sensors 282 and the second sensors 292. The controller 218 controls the tightening torque by controlling the rotation speed of the motor based on the detection data of the first sensor 282 and the second sensor 292. The controller 218 estimates the current tightening torque based on the detection data of the first sensor 282 and the second sensor 292 and then controls the rotation speed of the motor such that the fastening component is to be tightened at the target tightening torque (the specified range of torque).

Both of the first circuit board 281 and the second circuit board 291 are disposed in the interior of the hammer case 204. The hammer case 204 has a hole 204D through which the first lead wire 285 and the second lead wire 295 pass. After the first lead wire 285 and second lead wire 295 exit the hammer case 204 through the hole 204D, they pass through the interior of the rear grip part 222 and connect to the controller 218. The first lead wire 285 and second lead wire 295 pass rearward of the switch body 211 in the interior of the rear grip part 222.

The cushion member 251 is arranged to cover the edge of the hole 204D. The cushion member 251 is a substantially tubular member. Each of the first lead wire 285 and the second lead wire 295 passes through a passageway in the interior of the cushion member 251. A sponge 252 is disposed in the passageway of the cushion member 251. The sponge 252 fills the gap between the inner surface of the cushion member 251 and the outer surface of the first lead wire 285. The sponge 252 also fills the gap between the inner surface of the cushion member 251 and the outer surface of the second lead wire 295. When grease (lubricant) is disposed in the interior of the hammer case 204, the grease is blocked by the sponge 252 from leaking from the interior of the hammer case 204 to the outside through the passage of the cushion member 251.

An upper end portion of the first lead wire 285 is electrically connected to a lower end portion of the first sensor board 280, and a lower end portion of the first lead wire 285 is electrically connected to the upper surface of the controller 218. The first lead wire 285, which extends from the lower end of the first sensor board 280, passes below the hammer 247 in the interior of the hammer case 204 to below the second sensor board 290. The first lead wire 285, which is drawn rearward below the second sensor board 290, passes through the passageway in the cushion member 251 to below the hammer case 204. The first lead wire 285, which is drawn rearward below the hammer case 204, leads into the interior of the rear grip part 222. The first lead wire 285 passes rearward of the switch body 211 in the interior of the rear grip part 222. After passing through the passageway of the cushion member 251, the wiring paths of the first lead wire 285 and the lead wire 263 are substantially the same.

An upper end portion of the second lead wire 295 is electrically connected to the lower surface of the second sensor board 290, and a lower end portion of the second lead wire 295 is electrically connected to the upper surface of the controller 218. The second lead wire 295, which extends from the lower surface of the second sensor board 290, passes through the passageway in the cushion member 251 to below the hammer case 204. The second lead wire 295, which is drawn rearward below the hammer case 204, leads to the interior of the rear grip part 222. The second lead wire 295 passes rearward of the switch body 211 in the interior of the rear grip part 222. After passing through the passageway of the cushion member 251, the wiring paths of the second lead wire 295, the first lead wire 285 and the lead wire 263 are substantially the same.

As explained above, in the embodiment, rotation of the anvil 210 is detected by the first sensor board 280 and (axial, linear) movement of the hammer 247 is detected by the second sensor board 290 in the impact tool 1C, which is an impact wrench. The controller 218 can control the tightening torque based on the detection data output by the first sensors 282 and the second sensors 292.

### Fourth Embodiment

The fourth embodiment is described below. In the following description, the same or equivalent components as in the above-mentioned embodiments are indicated with the same symbols, and the description of the components is simplified or omitted.

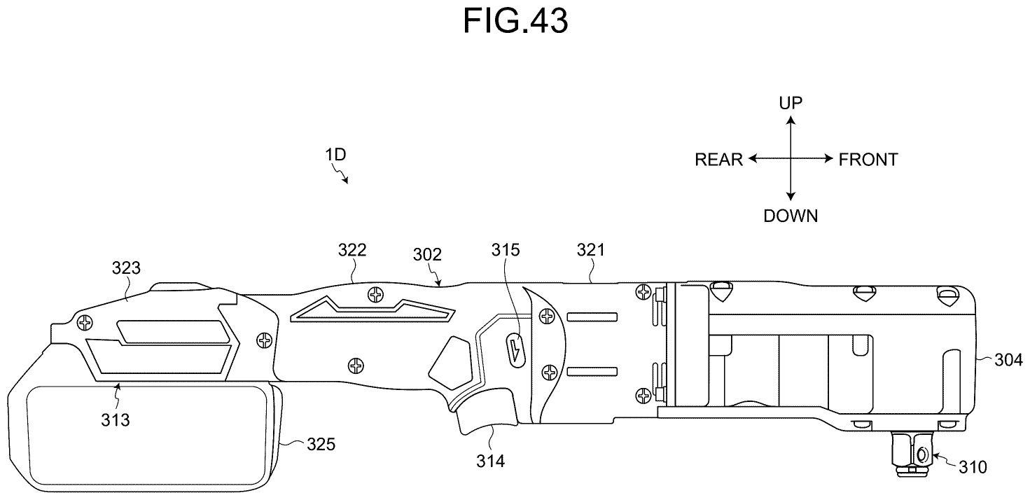

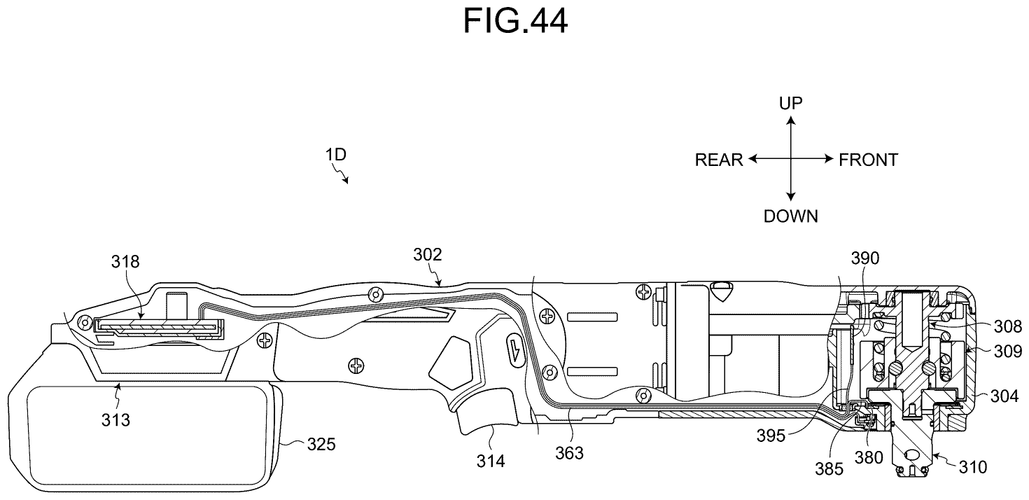

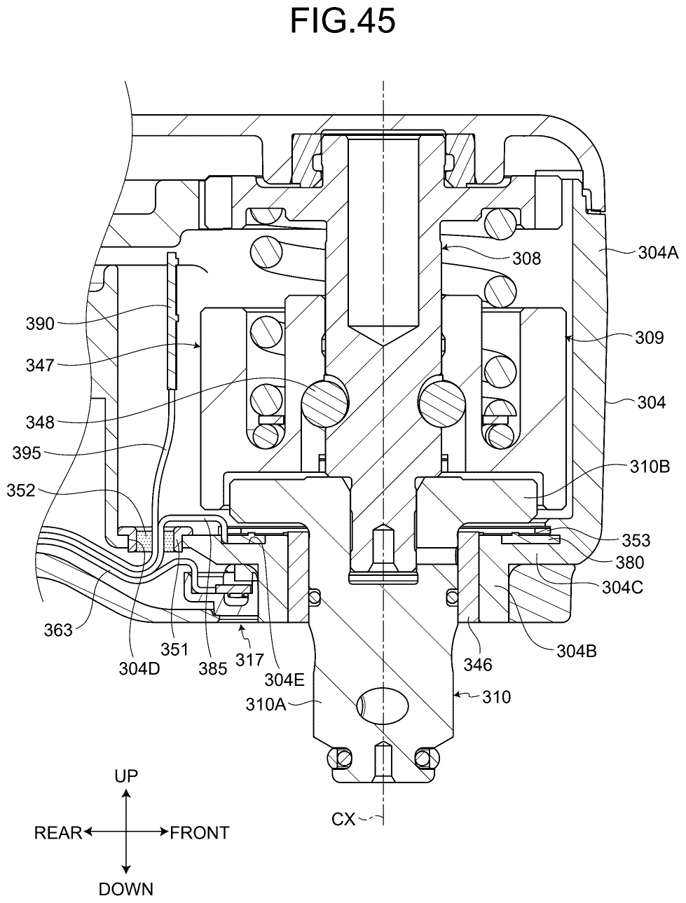

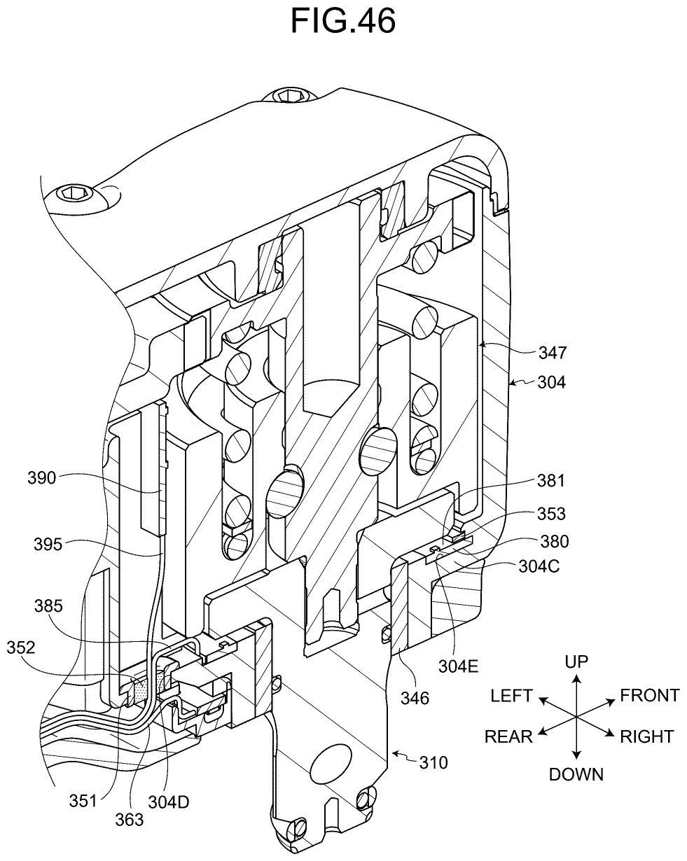

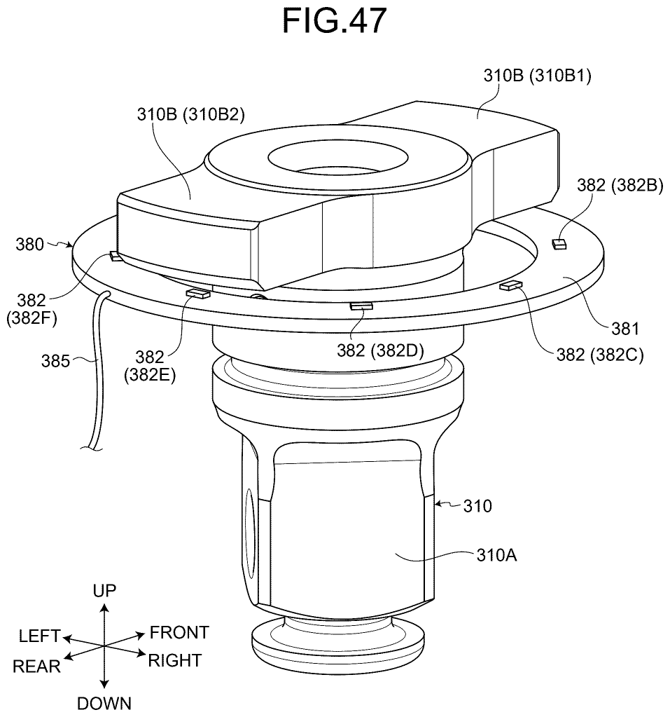

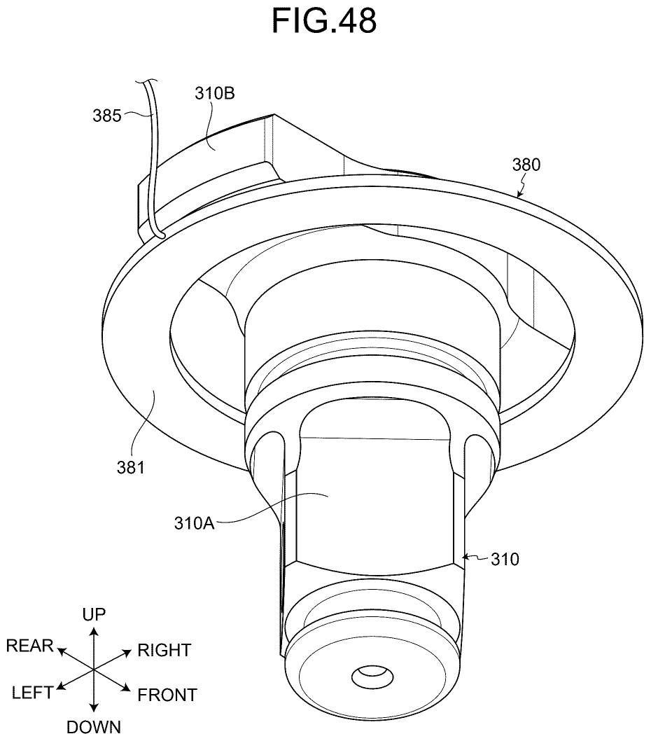

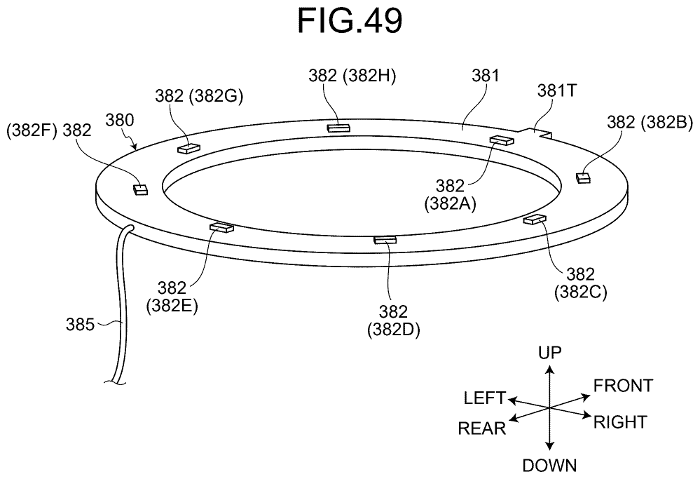

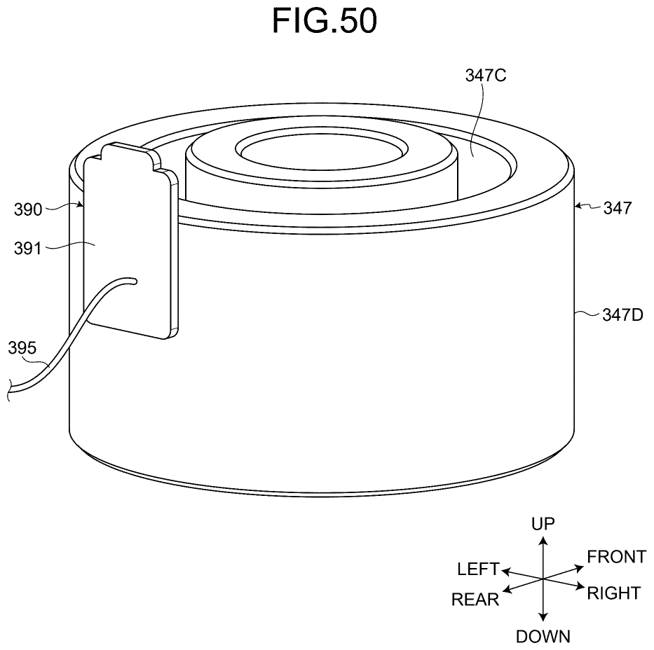

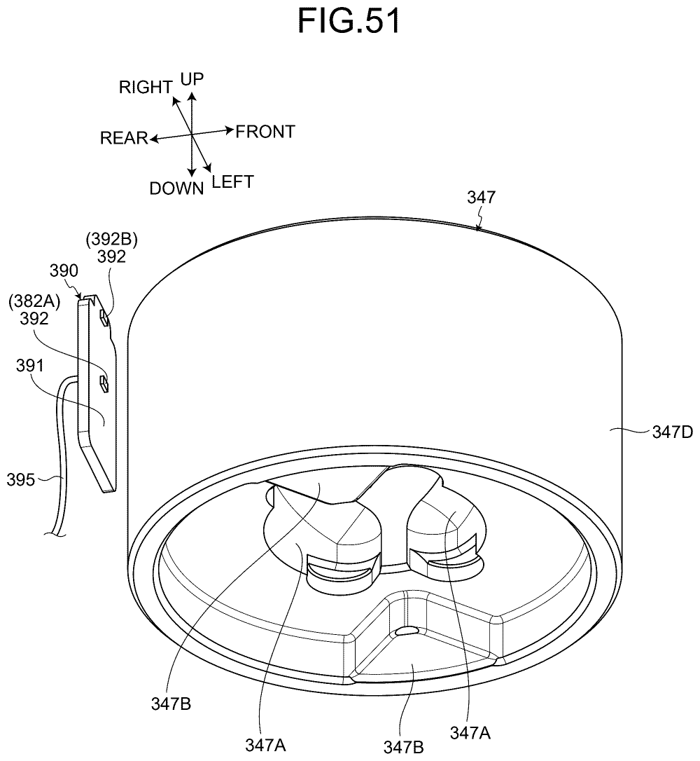

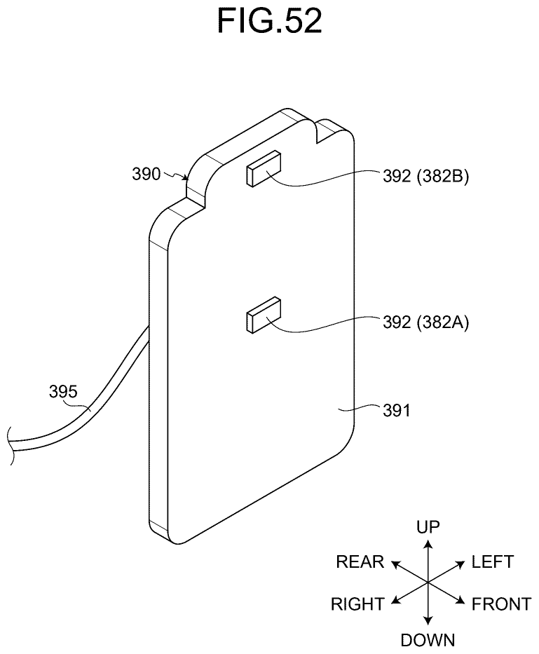

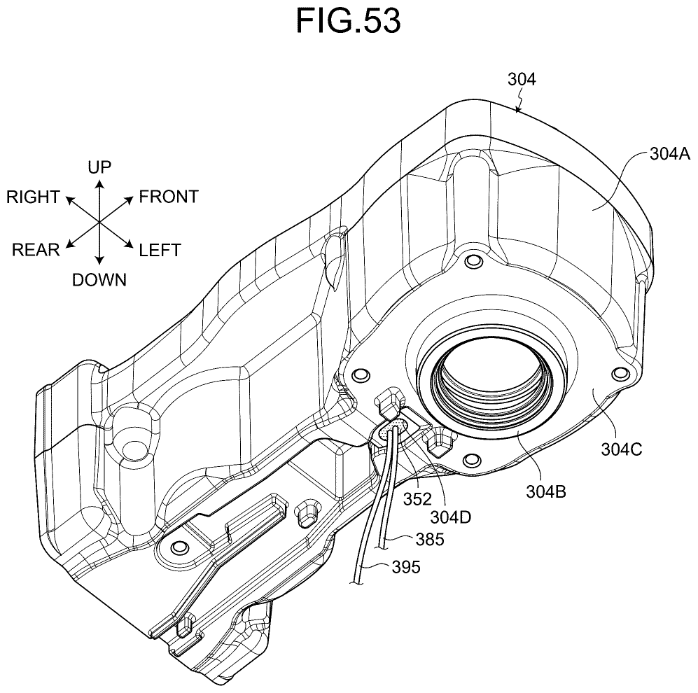

FIG. 43 is a side view that shows an impact tool according to the fourth embodiment. FIG. 44 is a cross-sectional view that shows the impact tool according to the fourth embodiment. FIG. 45 is a longitudinal cross-sectional view that shows the front portion of the impact tool according to the fourth embodiment. FIG. 46 is a perspective cross-sectional view that shows the front portion of the impact tool according to the fourth embodiment. FIG. 47 is a perspective view that shows the anvil and a first sensor board according to the fourth embodiment from the rear. FIG. 48 is a perspective view that shows the anvil and the first sensor board according to the fourth embodiment from the front. FIG. 49 is a perspective view that shows the first sensor board according to the fourth embodiment from the rear. FIG. 50 is a perspective view that shows the hammer and a second sensor board according to the fourth embodiment from the rear. FIG. 51 is a perspective view that shows the hammer and the second sensor board according to the fourth embodiment from the front. FIG. 52 is a perspective view that shows the second sensor board according to the fourth embodiment from the front. FIG. 53 is a perspective view that shows the hammer case according to the third embodiment from below.

In the embodiment, the impact tool 1D is an angle impact wrench. Similar to the preceding embodiments, the impact tool 1D comprises a housing 302, a hammer case 304, a spindle 308, an impact mechanism 309, an anvil 310, a battery mounting part 313, a trigger lever 314, a forward/reverse switching lever 315, a first sensor board 380, a second sensor board 390, and a controller 318.

The housing 302 has a motor housing part 321, a grip part 322, and a battery holding part 323.

The motor housing part 321 is tubular shaped. The grip part 322 extends rearward from motor housing part 321. The grip part 322 extends in the front-rear direction. The motor housing part 321 is connected to the grip part 322. The trigger lever 314 is provided on a lower portion of the grip part 322. The grip part 322 is gripped by the operator. The battery holding part 323 is connected to the rear end of the grip part 322.

The hammer case 304 includes an upper tubular part 304A, a lower tubular part 304B, and a ring-shaped part 304C. The lower tubular part 304B is disposed lower than the upper tubular part 304A. The outer diameter of the upper tubular part 304A is larger than the outer diameter of the lower tubular part 304B. The inner diameter of the upper tubular part 304A is larger than the inner diameter of the lower tubular part 304B. The ring-shaped part 304C is arranged to connect a lower end portion of the upper tubular part 304A with an upper end portion of the lower tubular part 304B.

The hammer case 304 is connected to a front portion of the motor housing part 321. The motor housing part 321 is fixed to a rear portion of the hammer case 304.

The spindle 308 is rotated by the rotational force of a motor (not shown). Rotational axis AX of the motor extends in the front-rear direction.

Similar to the preceding embodiments, the impact mechanism 309 includes a hammer 347, balls 348, and a coil spring 349. The impact mechanism 309, which includes the hammer 347, is housed in the hammer case 304.

Likewise, similar to the preceding embodiments, the hammer 347 has a body portion 347D, hammer grooves 347A, and hammer projections 347B. The body portion 347D is disposed around the spindle 308. The body portion 347D is ring-shaped. A recessed part 347C is provided in an upper portion of the body portion 347D. The recessed part 347C is provided so as to recess downwardly from an upper end portion of the body portion 347D. The recessed part 347C is ring-shaped. The hammer projections 347B project downwardly from the body portion 347D. Two hammer projections 347B are provided.

Similar to the preceding embodiments, the anvil 310 has a rod-shaped anvil shaft portion 310A and anvil projections 310B. However, in this embodiment, the anvil projections 310B are provided on an upper end portion of anvil 310. The anvil projections 310B project radially outward from the upper end portion of the anvil shaft portion 310A. The anvil 310 is configured to be impacted (struck) in the rotational direction by the hammer 347.

The anvil 310 extends in the up-down direction. Rotational axis CX of the anvil 310 extends in the up-down direction. Rotational axis AX of the motor (not shown) and rotational axis CX of the anvil 310 are orthogonal.

The battery mounting part 313 is disposed at a lower portion of the battery holding part 323. A battery pack 325 is mounted on the battery mounting part 313. The battery pack 325 is detachable from the battery mounting part 313.

Similar to the preceding embodiments, the impact tool 1D includes a first sensor board 380 that detects rotation of the anvil 310 and a second sensor board 390 that detects movement of the hammer 347.

As was noted above, the anvil 310 has the rod-shaped anvil shaft portion 310A and the pair of anvil projections 310B that extend radially outward from the upper end portion of anvil shaft portion 310A. The first sensor board 380 detects rotation of the anvil 310 around rotational axis CX. The first sensor board 380 detects at least one of position, angular velocity, and angular acceleration of the anvil 310 in the direction of rotation around rotational axis CX.

As was noted above, the hammer 347 has the ring-shaped body portion 347D, the pair of hammer projections 347B provided on a lower end portion of the body portion 347D, the hammer grooves 347A, in which the balls 348 are respectively disposed, and the recessed part 347C provided in a rear portion of the body portion 347D. The second sensor board 390 detects movement of the hammer 347 in the axial (up-down) direction. The second sensor board 390 detects at least one of position, movement speed, and movement acceleration of the hammer 347 in the axial direction.

Both of the first sensor board 380 and the second sensor board 390 are disposed in the interior of the hammer case 304. Both of the first sensor board 380 and the second sensor board 390 are fixed to the hammer case 304. The first sensor board 380 is supported on the upper surface of the ring-shaped part 304C of the hammer case 304. The second sensor board 390 is supported on a rear portion of the upper tubular part 304A of the hammer case 304.

The light unit 317 is electrically connected to the controller 318 by a lead wire 363. Current from the battery pack 325 is supplied to the light unit 317 via the controller 318 and the lead wire 363. By supplying current to the light unit 317, illumination light is emitted from the light unit 317. A front end portion of the lead wire 363 is electrically connected to the light unit 317, and a rear end portion of the lead wire 363 is electrically connected to the upper surface of the controller 318. The lead wire 363 passes through the interior of grip part 322. A portion of lead wire 363 passes below hammer case 304. After passing below the cushion member 351 (described below), the lead wire 363 is drawn along the same path as a first lead wire 385 and a second lead wire 395.

The anvil projections 310B include a first anvil projection 310B1 and a second anvil projection 310B2. The first sensor board 380 detects rotation of the anvil 310 around rotational axis CX. The first sensor board 380 detects at least one of position, angular velocity, and angular acceleration of the anvil 310 in the direction of rotation around rotational axis CX.

The first sensor board 380 comprises a first circuit board 381 and a plurality of first sensors 382 mounted on the rear surface of the first circuit board 381.

The first circuit board 381 may be a printed wiring board (PWB) or a printed circuit board (PCB) on which multiple electronic components are mounted. The first circuit board 381 is disposed at least partially around the anvil shaft portion 310A. In the embodiment, the first circuit board 381 has a circular shape that completely encircles the anvil shaft portion 310A. The first sensor board 380 is disposed in a recessed part 304E in the upper surface of the ring-shaped part 304C. The first circuit board 381 has a convex part 381T at a front portion thereof. The convex part 381T protrudes forward from the front portion of the first circuit board 381. The position of the first sensor board 380 relative to the hammer case 304 in the rotational direction is fixed by the convex part 381T.

The periphery of the upper surface of the first circuit board 381 is supported by the retaining ring 353. The retaining ring 353 contacts the periphery of the upper surface of the first circuit board 381. The retaining ring 353 fits into a groove provided on the inner circumference of the hammer case 304. The first sensor board 380 is blocked from moving upward by the retaining ring 353. The lower surface of the first circuit board 381 contacts the upper surface of the ring-shaped part 304C. The position of the first sensor board 380 relative to the hammer case 304 in the up-down direction is fixed by the retaining ring 353.

An anvil bearing 346, which rotatably supports the anvil 310, is a plain bearing made of oil-impregnated metal. An upper end portion of the anvil bearing 346 is disposed above the first circuit board 381. Since the upper end portion of the anvil bearing 346 is disposed more upward than the upper surface of the first circuit board 381, contact between the anvil projections 310B and the first circuit board 381 is blocked.

The first sensors 382 detect rotation of the anvil 310. The first sensors 382 are mounted on the upper surface of the first circuit board 381. The first sensors 382 are disposed at positions that face the lower surface of the anvil projections 310B.

The first sensors 382 include inductive sensors. Because the anvil 310 is made of metal, the first sensors 382 can detect rotation of the anvil 310 in a non-contacting manner. Rotation of the anvil 310 can be rephrased as the position of the anvil 310 in the direction of rotation. In other words, the first sensors 382 can detect the position of the anvil 310 in the rotational direction in a non-contacting manner. Furthermore, rotation of anvil 310 can also be said to be the number of rotations of the anvil 310. That is, the first sensors 382 can detect the number of rotations of the anvil 310 in a non-contacting manner.

The first sensors 382 are provided (arranged) in (around) the circumferential direction of the rotational axis CX. In the embodiment, eight first sensors 382 are provided at equal intervals in the circumferential direction on the upper surface of the first circuit board 381. The first sensors 382 include a first sensor 382A, a first sensor 382B, a first sensor 382C, a first sensor 382D, a first sensor 382E, a first sensor 382F, a first sensor 382G and a first sensor 382H. In the circumferential direction, if the position of the front portion of the first sensor board 381 is located at the 0° position, the position of the right portion is located at the 90° position, the position of the rear portion is located at the 180° position, and the position of the left portion is located at the 270° position, then the first sensor 382A is located at the 0° position, the first sensor 382B is located at the 45° position, the first sensor 382C is located at the 90° position, the first sensor 382D is located at the 135° position, the first sensor 382E is located at the 180° position, the first sensor 382F is located at the 225° position, the first sensor 382G is located at the 270° position, and the sensor 382H is located at the 315° position.

FIG. 47 shows the state in which the first anvil projection 310B1 is facing the first sensor 382A and the second anvil projection 310B2 is facing the first sensor 382E. In the state shown in FIG. 47, the first sensor 382A detects the first anvil projection 310B1 and the first sensor 382E detects the second anvil projection 310B2.

In the state in which the anvil 310 is rotated 45° from the state shown in FIG. 47 and the first anvil projection 310B1 is facing the first sensor 382B and the second anvil projection 310B2 is facing the first sensor 382F, the first sensor 382B detects the first anvil projection 310B1 and the first sensor 382F detects the second anvil projection 310B2.

In the state in which the anvil 310 is rotated 315° from the state shown in FIG. 47 and the first anvil projection 310B1 is facing the first sensor 382H and the second anvil projection 310B2 is facing the first sensor 382D, the first sensor 382H detects the first anvil projection 310 B1 and the first sensor 382D detects the second anvil projection 310B2.

The second sensor board 390 comprises a second circuit board 391 and a plurality of second sensors 392 mounted on the upper surface of the second circuit board 391.

The second circuit board 391 may be a printed wiring board (PWB) or a printed circuit board (PCB) on which multiple electronic components are mounted. The second circuit board 391 is disposed at a position that faces the rear portion of the outer surface of the body portion 347D of the hammer 347. In the present embodiment, the second circuit board 391 has a plate shape that faces the rear surface of the body portion 347D.

The second sensors 392 detect axial movement of the hammer 347. The second sensors 392 are mounted on the front surface of the second circuit board 391. The second sensors 392 are disposed at positions that face the rear surface of the body portion 347D.

The second sensors 392 include inductive sensors. Because the hammer 347 is made of metal, the second sensors 392 can detect movement of the hammer 347 in a non-contacting manner. Movement of the hammer 347 can be rephrased as the position of the hammer 347 in the up-down direction. In other words, the second sensors 392 can detect the position of the hammer 347 in the up-down direction in a non-contacting manner. Furthermore, movement of the hammer 347 can be rephrased as the movement speed of the hammer 347. In other words, the second sensors 392 can detect the moving speed of the hammer 347 in a non-contacting manner.

The second sensors 392 are provided (arranged) in (along) the axial direction. In the embodiment, two second sensors 392 are provided in the axial direction on the front surface of the second circuit board 391. The second sensors 392 include a second sensor 392A and a second sensor 392B. The second sensor 392A is disposed more downward than the second sensor 392B.

In the state in which the hammer 347 is not facing each of the second sensors 392A and 392B, neither of the second sensors 392A and 392B detects the hammer 347.

In the state in which the hammer 347 and the second sensor 392A are facing each other whereas the hammer 347 and the second sensor 392B are not facing each other, the second sensor 392A detects the hammer 347 and the second sensor 392B does not detect the hammer 347.

In the state in which the hammer 347 faces each of the second sensors 392A and 392B, both of the second sensors 392A and 392B detect the hammer 347. It is noted that the second sensor 392B may detect the hammer 347 and the second sensor 392A may not detect the hammer 347.

The first circuit board 381 is electrically connected to the controller 318 by the first lead wire 385. The second circuit board 391 and the controller 318 are electrically connected by the second lead wire 395. The detection data of the first sensors 382 is transmitted to the controller 318 via the first lead wire 385. The detection data of the second sensors 392 is transmitted to the controller 318 via the second lead wire 395. The controller 318 controls the tightening torque when the impact tool 1D tightens a fastening component, such as a bolt or nut, based on the detection data output by the first sensors 382 and the second sensors 392. The controller 318 controls the tightening torque by controlling the rotation speed of the motor based on the detection data of the first sensor 382 and the second sensor 392. The controller 318 estimates the current tightening torque based on the detection data of the first sensor 382 and the second sensor 392 and then controls the rotation speed of the motor such that the fastening component is to be tightened at the target tightening torque (the specified range of torque).

Both of the first circuit board 381 and the second circuit board 391 are disposed in the interior of the hammer case 304. The hammer case 304 has a hole 304D through which the first lead wire 385 and the second lead wire 395 pass. After the first lead wire 385 and the second lead wire 395 exit the hammer case 304 through the hole 304D, they pass through the interior of the grip part 322 and connect to the controller 318.

The cushion member 351 is arranged to cover the edge of the hole 304D. The cushion member 351 is a substantially cylindrical member. Each of the first lead wire 385 and the second lead wire 395 passes through the passageway in the interior of the cushion member 351. A sponge 352 is disposed in the passageway of the cushion member 351. The sponge 352 fills the gap between the inner surface of the cushion member 351 and the outer surface of the first lead wire 385. The sponge 352 also fills the gap between the inner surface of the cushion member 351 and the outer surface of the second lead wire 395. When grease (lubricant) is disposed in the interior of the hammer case 304, the grease is blocked by the sponge 352 from leaking from the interior of the hammer case 304 to the outside through the passage of the cushion member 351.

A front end portion of the first lead wire 385 is electrically connected to the first sensor board 380, and a rear end portion of the first lead wire 385 is electrically connected to the controller 318. After the first lead wire 385, which extends from the first sensor board 380, is drawn rearward in the interior of the hammer case 304, it passes through the passageway in the cushion member 351 to below the hammer case 304. The first lead wire 385, which is drawn rearward below the hammer case 304, leads into the interior of the grip part 322. After passing through the passageway of the cushion member 351, the wiring paths of the first lead wire 385 and the lead wire 363 are substantially the same.

A front end portion of the second lead wire 395 is electrically connected to a lower end portion of the second sensor board 390, and a rear end portion of the second lead wire 395 is electrically connected to the controller 318. The second lead wire 395, which extends from the second sensor board 390, passes through the passageway in the cushion member 351 to below the hammer case 304. The second lead wire 395, which is drawn rearward below the hammer case 304, leads into the interior of the grip part 322. After passing through the passageway of the cushion member 351, the wiring paths of the second lead wire 395, the first lead wire 385, and the lead wire 263 are substantially the same.

As explained above, in the embodiment, rotation of the anvil 310 is detected by the first sensor board 380 and (axial, linear) movement of the hammer 347 is detected by the second sensor board 390 in the impact tool 1D, which is an impact wrench. The controller 318 can control the tightening torque based on the detection data output by the first sensors 382 and the second sensors 392.

### Fifth Embodiment

The fifth embodiment is described below. In the following description, identical or equivalent components to the above-mentioned embodiments are indicated with the same symbols, and the description of the components is simplified or omitted.

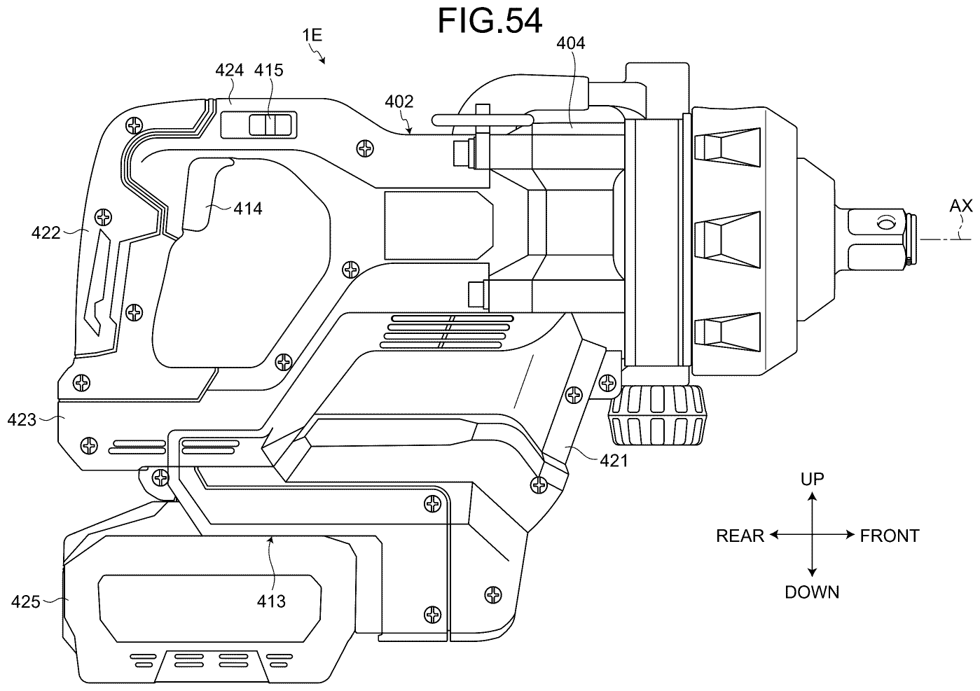

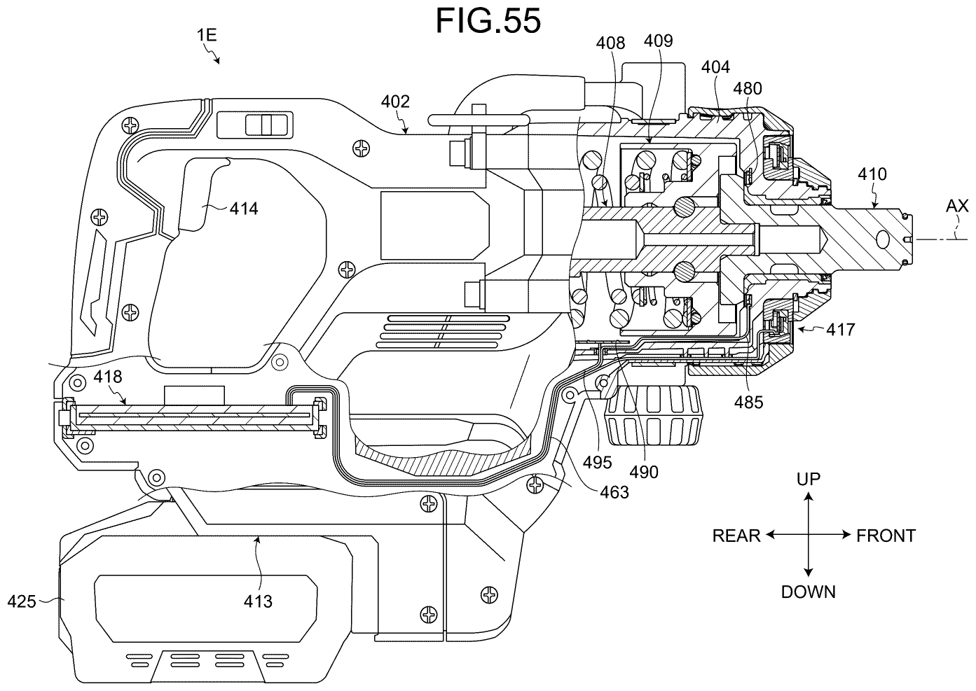

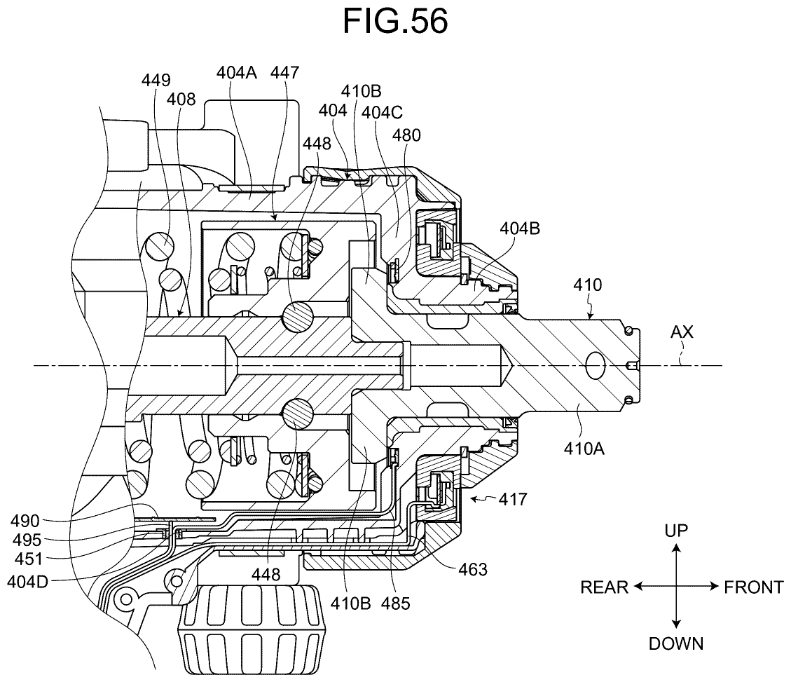

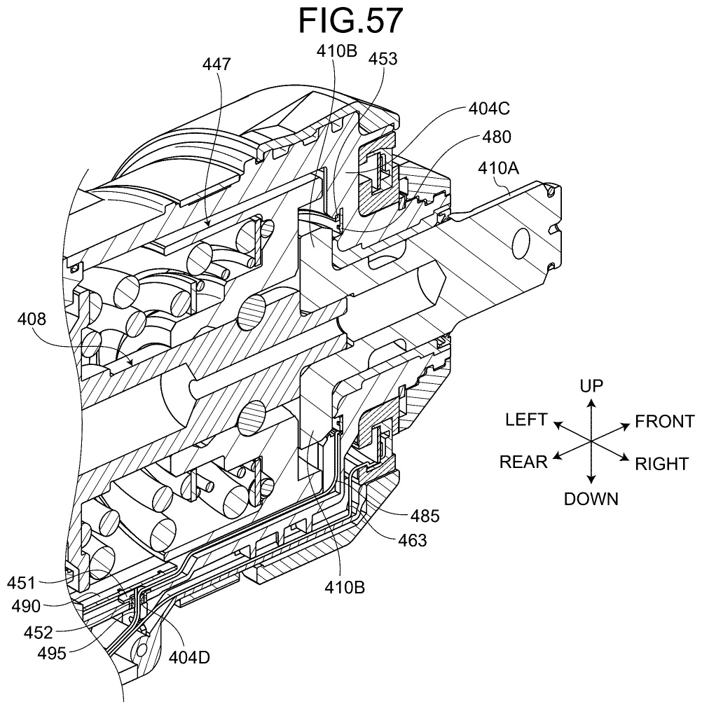

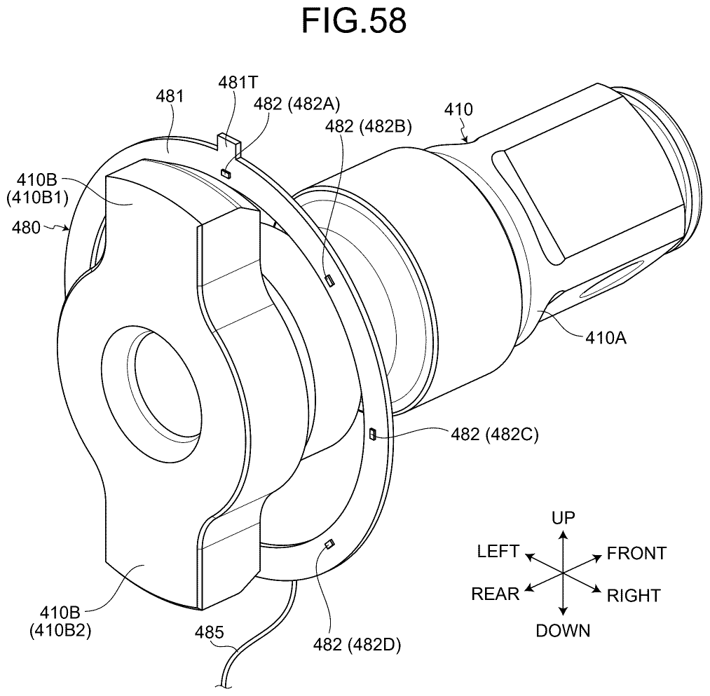

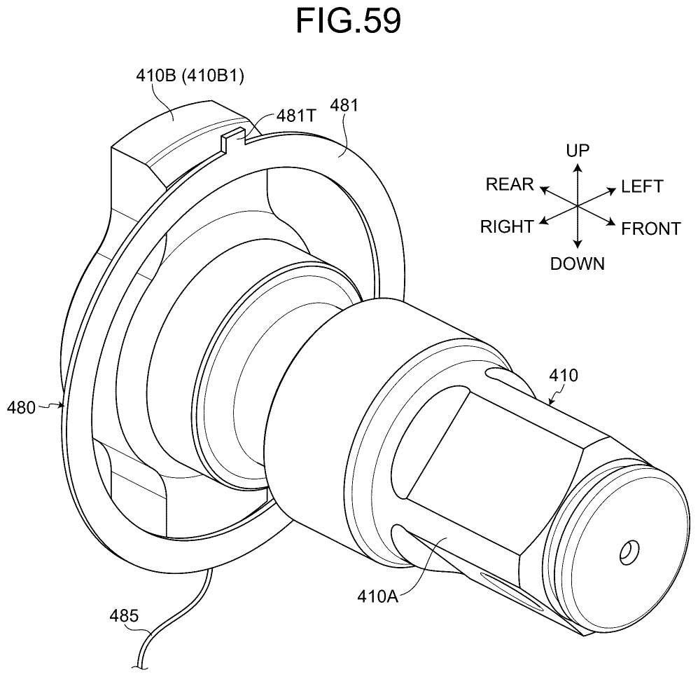

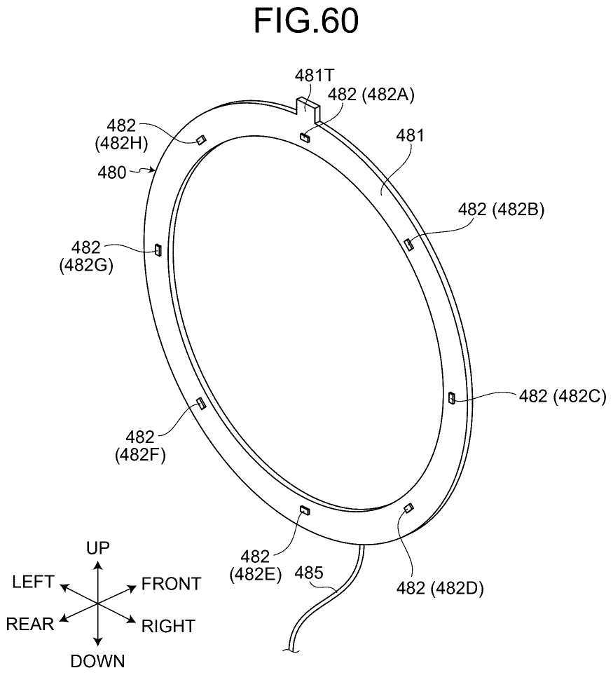

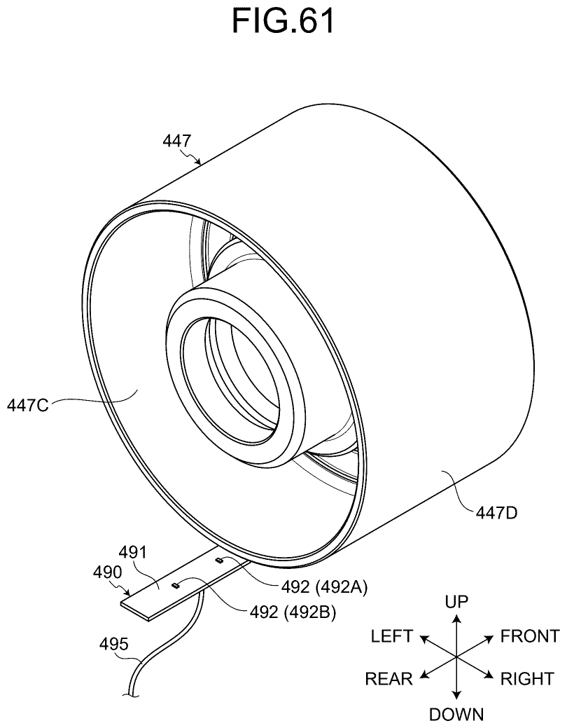

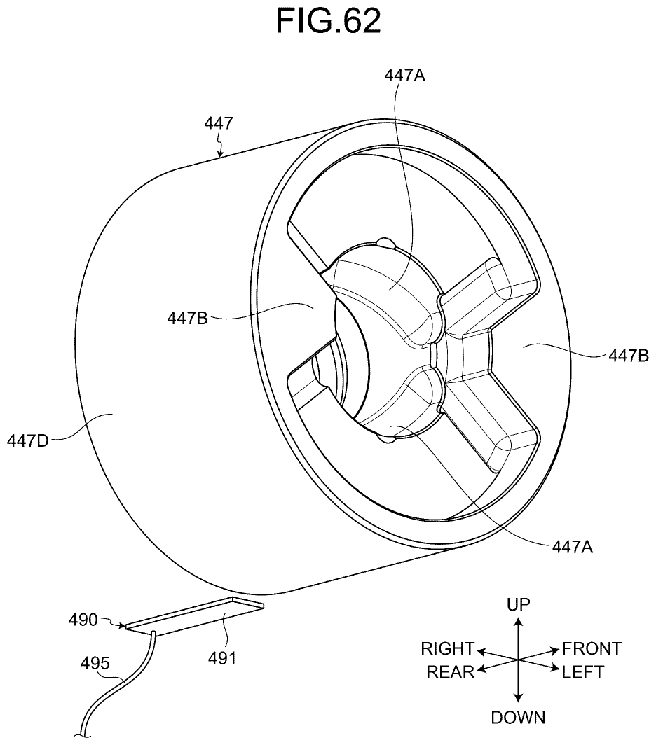

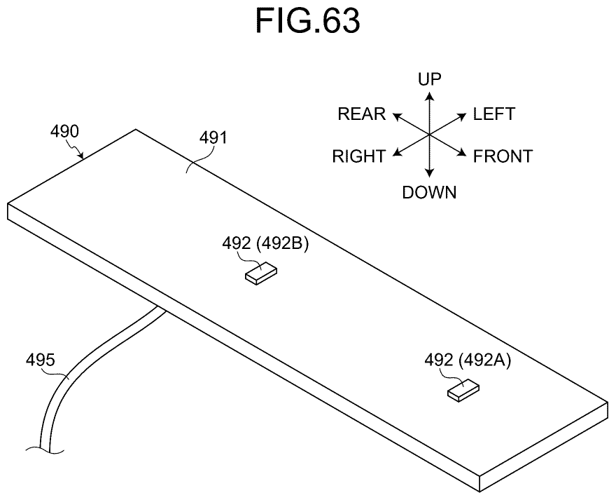

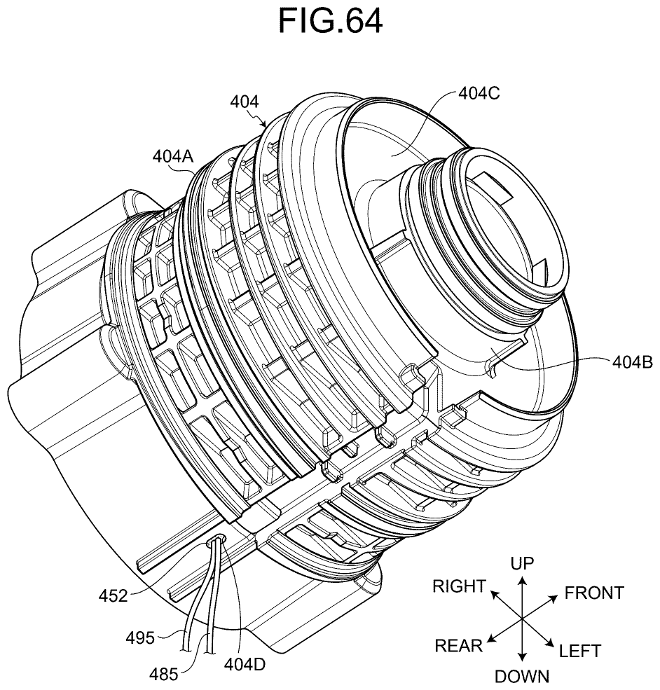

FIG. 54 is a side view that shows an impact tool according to the fifth embodiment. FIG. 55 is a cross-sectional view that shows the impact tool according to the fifth embodiment. FIG. 56 is a longitudinal cross-sectional view that shows the front portion of the impact tool according to the fifth embodiment. FIG. 57 is a perspective cross-sectional view that shows the front portion of the impact tool according to the fifth embodiment. FIG. 58 is a perspective view that shows the anvil and a first sensor board according to the fifth embodiment from the rear. FIG. 59 is a perspective view that shows the anvil and the first sensor board according to the fifth embodiment from the front. FIG. 60 is a perspective view that shows the first sensor board according to the fifth embodiment from the rear. FIG. 61 is a perspective view that shows the hammer and a second sensor board according to the fifth embodiment from the rear. FIG. 62 is a perspective view that shows the hammer and the second sensor board according to the fifth embodiment from the front. FIG. 63 is a perspective view that shows the second sensor board according to the fifth embodiment from the front. FIG. 64 is a perspective view that shows the hammer case according to the fifth embodiment from below.

In the embodiment, the impact tool 1E is an impact wrench. Similar to the preceding embodiments, the impact tool 1E comprises a housing 402, a hammer case 404, a spindle 408, an impact mechanism 409, an anvil 410, a battery mounting part 413, a trigger lever 414, a forward/reverse changeover lever 415, a first sensor board 480, a second sensor board 490, and a controller 418.

The housing 402 comprises a motor housing part 421, a rear grip part 422, a battery holding part 423, and an upper grip part 424.

The motor housing part 421 is tubular shaped. The rear grip part 422 is disposed rearward of the motor housing part 421. The trigger lever 414 is provided on a front portion of the rear grip part 422. The rear grip part 422 is configured to be gripped by the operator. The upper grip part 424 connects the upper portion of rear grip part 422 to the motor housing part 421. The battery holding part 423 is connected to a lower end portion of the rear grip part 422.

The hammer case 404 includes a rear side tubular part 404A, a front side tubular part 404B, and a ring-shaped part 404C. The front side tubular portion 404B is disposed more forward than the rear side tubular part 404A. The outer diameter of the rear side tubular part 404A is larger than the outer diameter of the front side tubular portion 404B. The inner diameter of the rear side tubular part 404A is larger than the inner diameter of the front side tubular portion 404B. The ring-shaped part 404C is arranged to connect a front end portion of the rear side tubular part 404A with a rear end portion of the front side tubular portion 404B.

The hammer case 404 is connected to a front portion of the motor housing part 421. The motor housing part 421 is fixed to a rear portion of the hammer case 404.

The spindle 408 is rotated by the rotational force of a motor (not shown). Rotational axis AX of the motor extends in the front-rear direction.

Similar to the preceding embodiments, the impact mechanism 409 comprises a hammer 447, balls 448, and a coil spring 449. The impact mechanism 409, which includes the hammer 447, is housed in the hammer case 404.

Similar to the preceding embodiments, the hammer 447 has a body portion 447D, hammer grooves 447A and hammer projections 447B. The body portion 447D is disposed around the spindle 408. The body portion 447D is ring-shaped. A recessed part 447C is provided in a rear portion of the body portion 447D. The recessed part 447C is recessed forward from a rear end portion of the body portion 447D. The recessed part 447C is ring-shaped. The hammer projections 447B project forward from the body portion 447D. Two hammer projections 447B are provided.

The anvil 410 has a rod-shaped anvil shaft portion 410A and anvil projections 410B. The anvil projections 410B are provided on the rear end portion of the anvil 410. The anvil projections 410B project radially outward from the rear end portion of the anvil shaft portion 410A.

The battery mounting part 413 is disposed below the battery holding part 423. A battery pack 425 is mounted on the battery mounting part 413. The battery pack 425 detachable from the battery mounting part 413.

The impact tool 1E includes a first sensor board 480 that detects rotation of the anvil 410 and a second sensor board 490 that detects movement of the hammer 447.

As was mentioned above, the anvil 410 has the rod-shaped anvil shaft portion 410A and the pair of anvil projections 410B that extend radially outward from the rear end portion of anvil shaft portion 410A. The first sensor board 480 detects rotation of the anvil 410 around rotational axis CX. The first sensor board 480 detects at least one of position, angular velocity, and angular acceleration of the anvil 410 in the direction of rotation around rotational axis CX.

As was mentioned above, the hammer 447 has the ring-shaped body portion 447D, the pair of hammer projections 447B provided on the front end portion of the body portion 447D, the hammer grooves 447A, in which the balls 448 are respectively disposed, and the recessed part 447C provided in the rear portion of the body portion 447D. The second sensor board 490 detects movement of the hammer 447 in the axial (left-right) direction. The second sensor board 490 detects at least one of position, movement speed, and movement acceleration of the hammer 447 in the axial direction.

Both of the first sensor board 480 and the second sensor board 490 are disposed in the interior of the hammer case 404. Both of the first sensor board 480 and the second sensor board 490 are fixed to the hammer case 404. The first sensor board 480 is supported on the rear surface of the ring-shaped part 404C of the hammer case 404. The second sensor board 490 is supported on the lower portion of the rear side tubular part 404A of the hammer case 404.

As can be seen in FIGS. 56 and 57, the light unit 417 is electrically connected to the controller 418 by a lead wire 463. Current from the battery pack 425 is supplied to the light unit 417 via the controller 418 and the lead wire 463. By supplying current to the light unit 417, illumination light is emitted from the light unit 417. A front end portion of the lead wire 463 is electrically connected to the light unit 417, and a rear end portion of the lead wire 463 is electrically connected to the upper surface of the controller 418. The lead wire 463 passes through the lower part of the interior of the motor housing part 421. A portion of the lead wire 463 passes below the hammer case 404. After passing underneath a cushion member 451 (described below), the lead wire 463 is drawn along the same path as a first lead wire 485 and a second lead wire 495.

The anvil projections 410B include a first anvil projection 410B1 and a second anvil projection 410B2. The first sensor board 480 detects rotation of the anvil 410 around rotational axis AX. The first sensor board 480 detects at least one of position, angular velocity, and angular acceleration of the anvil 410 in the direction of rotation around rotational axis AX.

The first sensor board 480 comprises a first circuit board 481 and a plurality of first sensors 482 mounted on the rear surface of the first circuit board 481.

The first circuit board 481 can be a printed wiring board (PWB) or a printed circuit board (PCB) on which multiple electronic components are mounted. The first circuit board 481 is disposed at least partially around the anvil shaft portion 410A. In the present embodiment, the first circuit board 481 has a circular shape that surrounds the anvil shaft portion 410A. The first circuit board 481 has a convex part 481T at an upper portion thereof. The convex part 481T protrudes upward from the upper portion of the first circuit board 481. The position of the first sensor board 480 relative to the hammer case 404 in the rotational direction is fixed by the convex part 481T.

As can be seen in FIG. 57, the periphery of the rear surface of the first circuit board 481 is supported by a retaining ring 453. The retaining ring 453 contacts the peripheral edge of the rear surface of the first circuit board 481. The retaining ring 453 fits into a groove provided in in an inner circumferential surface of the hammer case 404. The first sensor board 480 is blocked from moving rearward by the retaining ring 453. The front surface of the first circuit board 481 contacts the rear surface of the ring-shaped part 404C. The position of the first sensor board 480 relative to the hammer case 404 in the front-rear direction by the retaining ring 453.

The first sensors 482 detect rotation of the anvil 410. The first sensors 482 are mounted on the rear surface of the first circuit board 481. The first sensors 482 are disposed at positions that face the front surface of the anvil projections 410B.

The first sensors 482 include inductive sensors. Because the anvil 410 is made of metal, the first sensors 482 can detect rotation of the anvil 410 in a non-contacting manner. Rotation of the anvil 410 can be rephrased as the position of the anvil 410 in the rotational direction. In other words, the first sensors 482 can detect the position of the anvil 410 in the rotational direction in a non-contacting manner. Furthermore, rotation of the anvil 410 can also be said to be the number of rotations of the anvil 410. That is, the first sensors 482 can detect the number of rotations of the anvil 410 in a non-contacting manner.

The first sensors 482 are provided (arranged) in (around) the circumferential direction. In the embodiment, eight first sensors 482 are provided at equal intervals in the circumferential direction on the rear surface of the first circuit board 481. The first sensors 482 include a first sensor 482A, a first sensor 482B, a first sensor 482C, a first sensor 482D, a first sensor 482E, a first sensor 482F, a first sensor 482G and a first sensor 482H. In the circumferential direction, if the position of the upper portion of the first sensor board 81 is located at the 0° position, the position of the right portion is located at the 90° position, the position of the lower portion is located at the 180° position, and the position of the left portion is located at the 270° position, then the first sensor 482A is located at the 0° position, the first sensor 482B is located at the 45° position, the first sensor 482C is located at the 90° position, the first sensor 482D is located at the 135° position, the first sensor 482E is located at the 180° position, the first sensor 482F is located at the 225° position, the first sensor 482G is located at the 270° position, and the first sensor 482H is located at the 315° position.

FIG. 58 shows the state in which the first anvil projection 410B1 and the first sensor 482A face each other and the second anvil projection 410B2 and the first sensor 482E face each other. In the state shown in FIG. 58, the first sensor 482A detects the first anvil projection 410B1 and the first sensor 482E detects the second anvil projection 410B2.

In the state in which the anvil 410 is rotated 45° from the state shown in FIG. 58 and the first anvil projection 410B1 is facing the first sensor 482B and the second anvil projection 410B2 is facing the first sensor 482F, the first sensor 482B detects the first anvil projection 410B1 and the first sensor 482F detects the second anvil projection 410B2.

In the state in which the anvil 410 rotates 315° from the state shown in FIG. 58 and the first anvil projection 410B1 and the first sensor 482H face each other and the second anvil projection 410B2 and the first sensor 482D face each other, the first sensor 482H detects the first anvil projection 410B1 and the first sensor 482D detects the second anvil projection 410B2.

The second sensor board 490 comprises a second circuit board 491 and a plurality of second sensors 492 mounted on the upper surface of the second circuit board 491.

The second circuit board 491 can be a printed wiring board (PWB) or a printed circuit board (PCB) on which multiple electronic components are mounted. The second circuit board 491 is disposed facing the rear portion of the outer surface of the body portion 447D of the hammer 447. In the present embodiment, the second circuit board 491 has a plate shape that faces the rear surface of the body portion 447D.

The second sensors 492 detect axial movement of the hammer 447. The second sensors 492 are mounted on the upper surface of the second circuit board 491. The second sensors 492 are disposed at positions that face the lower surface of the body portion 447D.

The second sensors 492 include inductive sensors. Because the hammer 447 is made of metal, the second sensors 492 can detect movement of the hammer 447 in a non-contacting manner. Movement of the hammer 447 can be rephrased as the position of the hammer 447 in the front-rear direction. In other words, the second sensors 492 can detect the position of the hammer 447 in the front-rear direction in a non-contacting manner. Furthermore, movement of the hammer 447 can be rephrased as the movement speed of the hammer 447. In other words, the second sensors 492 can detect the moving speed of the hammer 447 in a non-contacting manner.

The second sensors 492 are provided (arranged) in (along) the axial direction. In the embodiment, two second sensors 492 are provided in the axial direction on the upper surface of the second circuit board 491. The second sensors 492 include a second sensor 492A and a second sensor 492B. The second sensor 492A is disposed more forward than the second sensor 492B.

FIG. 61 shows the state in which the hammer 447 does not face each of the second sensors 492A and 492B. In the state shown in FIG. 61, neither of the second sensors 492A and 492B detects the hammer 447.

In the state in which the hammer 447 has moved rearward from the state shown in FIG. 61 and the hammer 447 and the second sensor 492A face each other and the hammer 447 and the second sensor 492B do not face each other, the second sensor 492A detects the hammer 447 and the second sensor 492B does not detect the hammer 447.

In the state in which the hammer 447 has moved further rearward and the hammer 447 is facing each of the second sensors 492A and 492B, both of the second sensors 492A and 492B detect the hammer 447. It is noted that the second sensor 492B may detect the hammer 447 and the second sensor 492A may not detect the hammer 447.

The first circuit board 481 is electrically connected to the controller 418 by the first lead wire 485. The second circuit board 491 and the controller 418 are electrically connected by the second lead wire 495. The detection data of the first sensors 482 is transmitted to the controller 418 via the first lead wire 485. The detection data of the second sensors 492 is transmitted to the controller 418 via the second lead wire 495. The controller 418 controls the tightening torque when the impact tool 1E tightens a fastening component, such as a bolt or nut, based on the detection data output by the first sensors 482 and the second sensors 492. The controller 418 controls the tightening torque by controlling the rotation speed of the motor based on the detection data of the first sensor 482 and the second sensor 492. The controller 418 estimates the current tightening torque based on the detection data of the first sensor 482 and the second sensor 492 and then controls the rotation speed of the motor such that the fastening component is to be tightened at the target tightening torque (the specified range of torque).

Both of the first circuit board 481 and the second circuit board 491 are disposed in the interior of the hammer case 404. The hammer case 404 has a hole 404D through which the first lead wire 485 and the second lead wire 495 pass. After exiting the hammer case 404 through the hole 404D, the first lead wire 485 and the second lead wire 495 are electrically connected to the controller 418.

The cushion member 451 is arranged to cover the edge of hole 404D. The cushion member 451 is a substantially tubular member. Each of the first lead wire 485 and the second lead wire 495 passes through the passageway in the interior of the cushion member 451. A sponge 452 is disposed in the passageway of the cushion member 451. The sponge 452 fills the gap between the inner surface of the cushion member 451 and the outer surface of the first lead wire 485. The sponge 452 also fills the gap between the inner surface of the cushion member 451 and the outer surface of the second lead wire 495. When grease (lubricant) is disposed in the interior of the hammer case 404, the grease is blocked by the sponge 452 from leaking from the interior of the hammer case 404 to the outside through the passage of the cushion member 451.

A front end portion of the first lead wire 485 is electrically connected to the first sensor board 480, and a rear end portion of the first lead wire 485 is electrically connected to the upper portion of the controller 418. The first lead wire 485, which extends from the first sensor board 480, passes below the hammer 447 in the interior of the hammer case 404 to below the second sensor board 490. The first lead wire 485, which is drawn rearward below the second sensor board 490, passes through the passageway in the cushion member 451 to below the hammer case 404. The first lead wire 485, which is drawn rearward below the hammer case 404, passes through the interior of the motor housing part 421 to the controller 418. After passing through the passageway of the cushion member 451, the wiring paths of the first lead wire 485 and the lead wire 463 are substantially the same.

A front end portion of the second lead wire 495 is electrically connected to the lower surface of the second sensor board 490, and a rear end portion of the second lead wire 495 is electrically connected to the upper surface of the controller 418. The second lead wire 495, which extends from the second sensor board 490, passes through the passageway in the cushion member 451 to below the hammer case 404. The second lead wire 495, which is drawn rearward below the hammer case 404, passes through the interior of the motor housing part 421 to the controller 418. After passing through the passageway of the cushion member 451, the wiring paths of the second lead wire 495, the first lead wire 485, and the lead wire 463 are substantially the same.

As explained above, in the embodiment, rotation of the anvil 410 is detected by the first sensor board 480 and (axial, linear) movement of the hammer 447 is detected by the second sensor board 490 in the impact tool 1E, which is an impact wrench. The controller 418 can control the tightening torque based on the detection data output by the first sensors 482 and the second sensors 492.

### Sixth Embodiment

The sixth embodiment is described below. In the following description, the same or equivalent components as in the above-mentioned embodiment are indicated with the same symbols, and the description of the components is simplified or omitted.

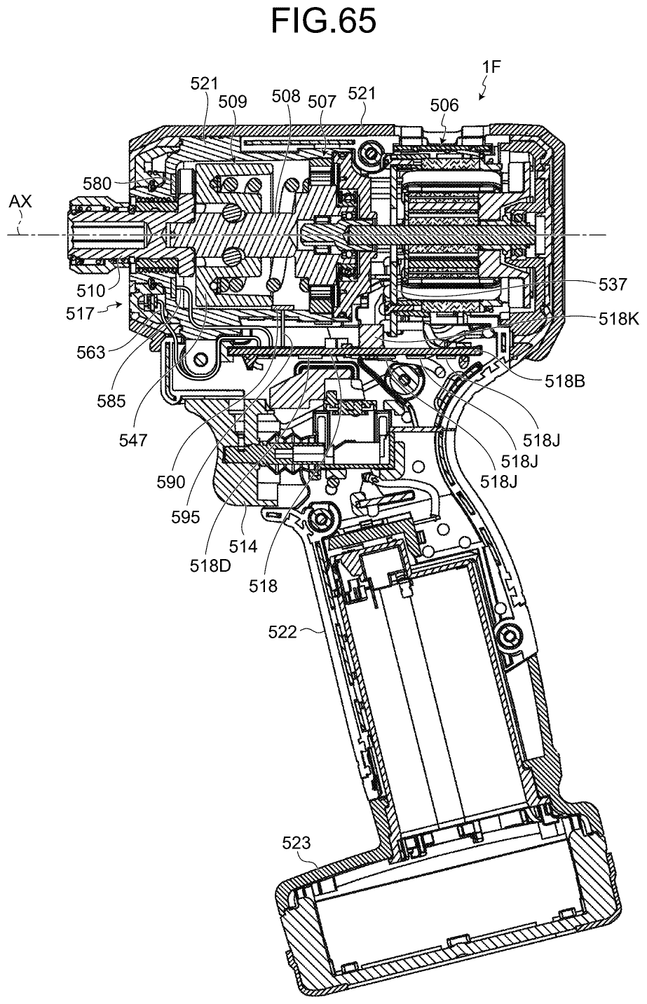

FIG. 65 is a cross-sectional view that shows an impact tool according to a sixth embodiment. The impact tool 1F is a modification (improvement) of an impact driver as disclosed in U.S. Patent Application Publication No. 2023/0256580. The impact tool 1F has a hammer case 504, a motor 506, a sensor board 537 that detects rotation of the rotor of the motor 506, a reduction mechanism 507, a spindle 508, an impact mechanism 509, an anvil 510, a trigger switch 514, a light unit 517, a controller 518, a motor housing part 521, grip part 522, a battery holding part 523, and a hammer 547. A first sensor board 580 and a second sensor board 590 according to the present teachings can also be provided in the impact tool 1F in order to enable detection of the rotational position of the anvil 510 and the axial position of the hammer 547.

The light unit 517 and the controller 518 are electrically connected by a lead wire 563. The first sensor board 580 and the controller 518 are electrically connected by a lead wire 585. The second sensor board 590 and the controller 518 are electrically connected by a lead wire 595. The controller 518 comprises a circuit board 518B, a microcomputer 518D, six switching elements 518J, and a capacitor 518K mounted on the circuit board 518B.

### Seventh Embodiment

The seventh embodiment is described below. In the following description, the same or equivalent components as in the above-mentioned embodiment are indicated with the same symbols, and the description of the components is simplified or omitted.

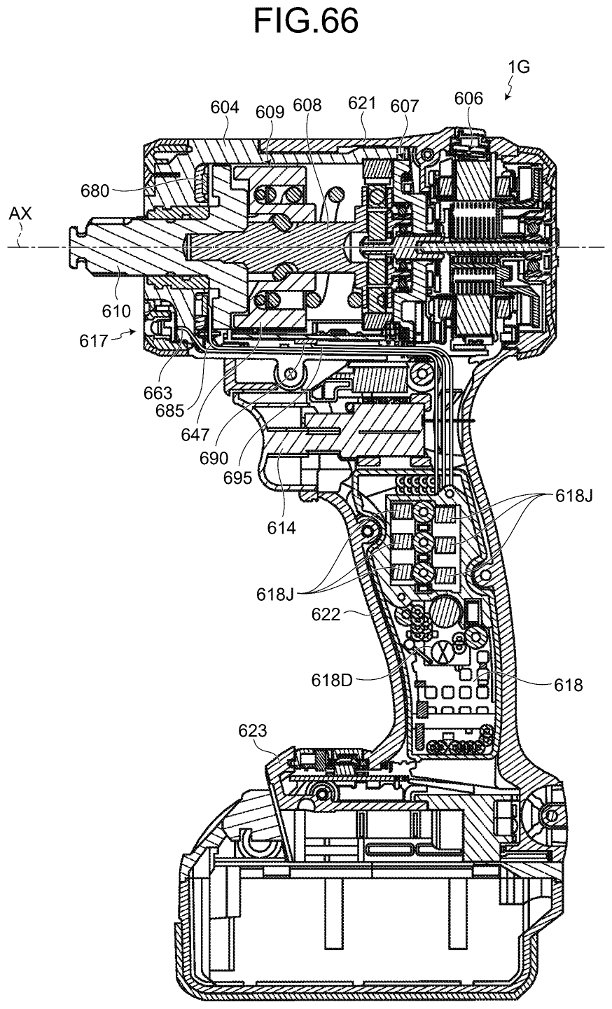

FIG. 66 is a cross-sectional view that shows an impact tool according to the seventh embodiment. The impact tool 1G is a modification (improvement) of an impact wrench as disclosed in U.S. Patent Application Publication No. 2023/0302611. The impact tool 1G comprises a hammer case 604, a motor 606, a reduction mechanism 607, a spindle 608, an impact mechanism 609, an anvil 610, a trigger switch 614, a motor housing part 621, a grip part 622, a battery holding part 623, and a hammer 647. A first sensor board 680 and a second sensor board 690 according to the present teachings can also be provided in the impact tool 1G in order to enable detection of the rotational position of the anvil 610 and the axial position of the hammer 647.

The light unit 617 and the controller 618 are electrically connected by a lead wire 663. The first sensor board 680 is electrically connected to the controller 618 by a lead wire 685. The second sensor board 690 is electrically connected to the controller 618 by a lead wire 695. The controller 618 comprises a microcomputer 618D and six switching elements 618J.

### Eighth Embodiment

The eighth embodiment is described below. In the following description, the same or equivalent components as in the above-mentioned embodiments are indicated with the same symbols, and the description of the components is simplified or omitted.

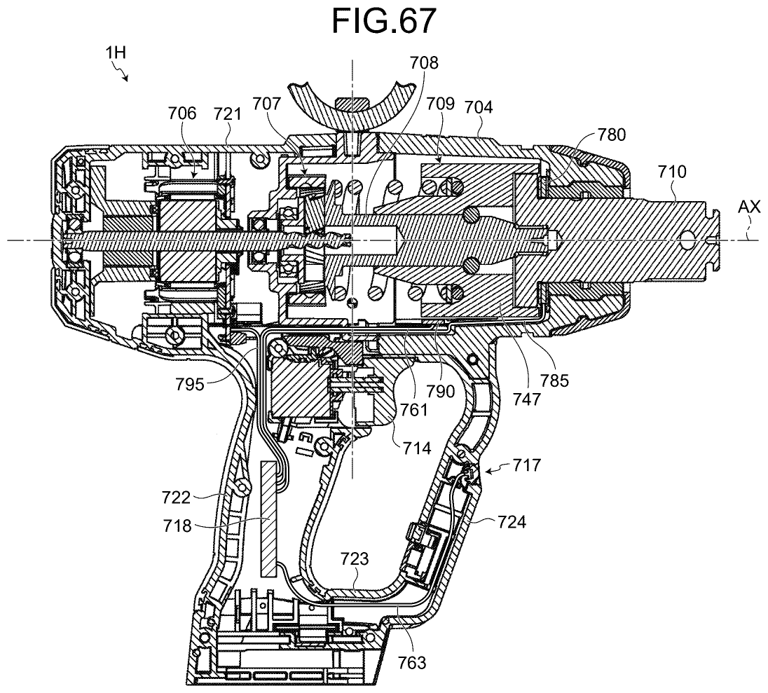

FIG. 67 is a cross-sectional view that shows an impact tool according to the eighth embodiment. The impact tool 1H is a modification (improvement) of an impact wrench as disclosed in U.S. Patent Application Publication No. 2022/0274246. The impact tool 1H comprises a hammer case 704, a motor 706, a reduction mechanism 707, a spindle 708, an impact mechanism 709, an anvil 710, a trigger switch 714, a motor housing part 721, a grip part 722, a battery holding part 723, and a hammer 747. A first sensor board 780 and a second sensor board 790 according to the present teachings can also be provided in the impact tool 1H in order to enable detection of the rotational position of the anvil 710 and the axial position of the hammer 747.

The light unit 717 and the controller 718 are electrically connected by a lead wire 763. The first sensor board 780 is electrically connected to the controller 718 by a lead wire 785. The second sensor board 790 and the controller 718 are electrically connected by a lead wire 761. The motor 706 and the controller 718 are electrically connected by a lead wire 795.

### Ninth Embodiment

The ninth embodiment is described below. In the following description, the same or equivalent components as in the above-mentioned embodiment are indicated with the same symbols, and the description of the components is simplified or omitted.

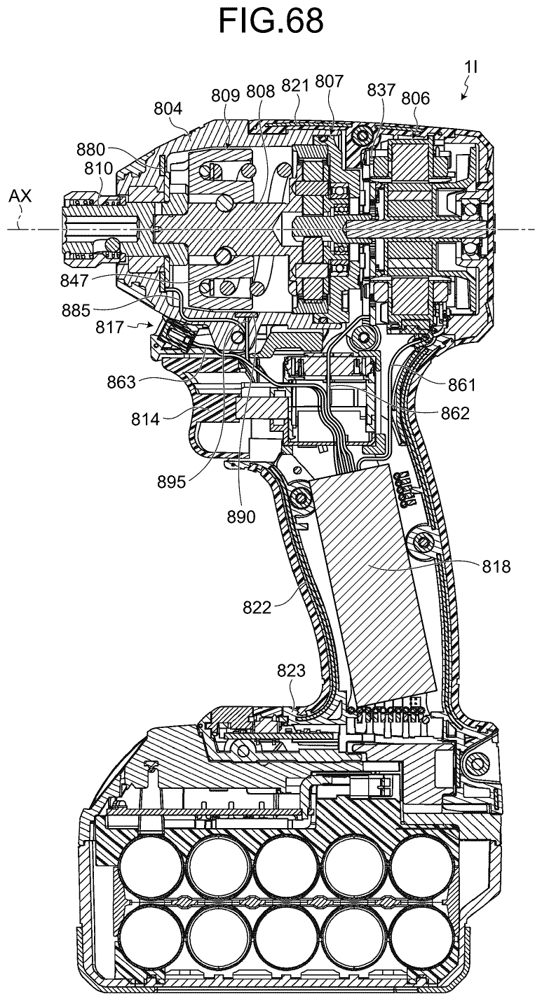

FIG. 68 is a cross-sectional view that shows an impact tool according to the ninth embodiment. The impact tool 1I is a modification (improvement) of an impact driver as disclosed in European Patent Application Publication No. 4260984. The impact tool 1I comprises a hammer case 804, a motor 806, a reduction mechanism 807, a spindle 808, an impact mechanism 809, an anvil 810, a trigger switch 814, a controller 818, a motor housing part 821, a grip part 822, a battery holding part 823 and a hammer 847. The controller 818 is located in the grip part 822. A first sensor board 880 and a second sensor board 890 according to the present teachings can also be provided in the impact tool 1I in order to enable detection of the rotational position of the anvil 810 and the axial position of the hammer 847.

The motor 806 and the controller 818 are electrically connected by a lead wire 861. The sensor board 837, which detects rotation of the rotor of motor 806, is electrically connected to the controller 818 by a lead wire 862. The light unit 817 and the controller 818 are electrically connected by a lead wire 863. The first sensor board 880 and controller 818 are electrically connected by a lead wire 885. The second sensor board 890 is electrically connected to the controller 818 by a lead wire 895.

### Tenth Embodiment

The tenth embodiment is described below. In the following description, the same or equivalent components as in the above-mentioned embodiment are indicated with the same symbols, and the description of the components is simplified or omitted.

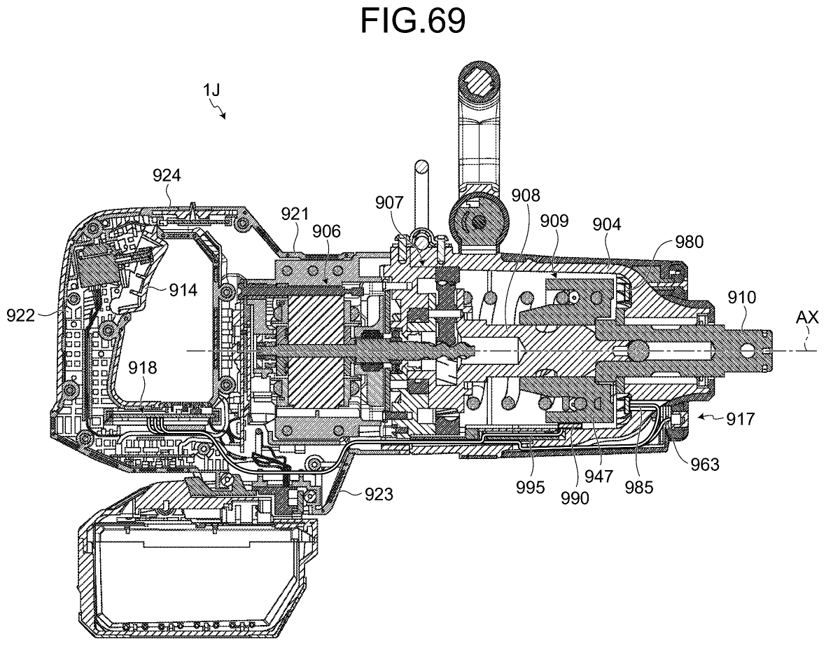

FIG. 69 is a cross-sectional view that shows an impact tool according to the tenth embodiment. The impact tool 1J is a modification (improvement) of an impact wrench as disclosed in U.S. Patent Application Publication No. 2023/0253855. The impact tool 1J comprises a hammer case 904, a motor 906, a reduction mechanism 907, a spindle 908, an impact mechanism 909, an anvil 910, a trigger switch 914, a controller 918, a motor housing part 921, a rear grip part 922, a battery holding part 923, an upper grip part 924, and a hammer 947. A first sensor board 980 and a second sensor board 990 according to the present teachings can also be provided in the impact tool 1J in order to enable detection of the rotational position of the anvil 910 and the axial position of the hammer 947.

The light unit 917 and the controller 918 are electrically connected by a lead wire 963. The first sensor board 980 and controller 918 are electrically connected by a lead wire 985. The second sensor board 990 is electrically connected to the controller 918 by a lead wire 995. After the lead wire 985 extends forward from a front portion of the first sensor board 980, passes through a through hole in the hammer case 904, and extended forward of the hammer case 904, it then extends rearward below the hammer case 904. A sponge for preventing grease leakage may be disposed in the through hole of the hammer case 904.

### Eleventh Embodiment

The eleventh embodiment is described below. In the following description, the same or equivalent components as in the above-mentioned embodiment are indicated with the same symbols, and the description of the components is simplified or omitted.

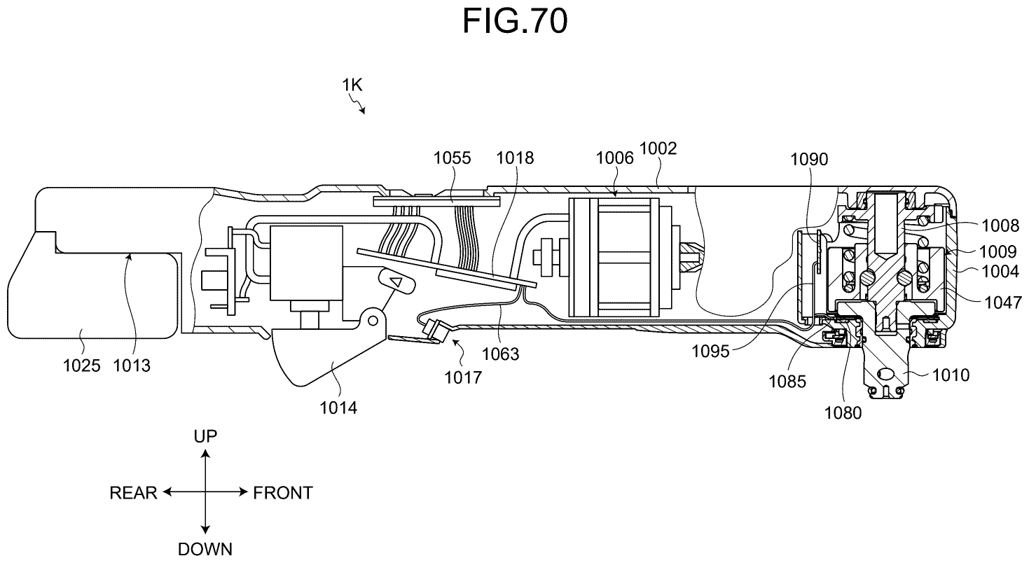

FIG. 70 is a cross-sectional view that shows an impact tool according to the eleventh embodiment. The impact tool 1K is an angle impact wrench. The impact tool 1K comprises a housing 1002, a hammer case 1004, a motor 1006, a reduction mechanism 1007, a spindle 1008, an impact mechanism 1009, an anvil 1010, a trigger lever 1014, a controller 1018, a hammer 1047, a battery mounting part 1013 and a torque changing panel 1055. A first sensor board 1080 and a second sensor board 1090 can also be provided in the impact tool 1K. A first lead wire 1085 is electrically connected to the first sensor board 1080 and a second lead wire 1095 is electrically connected to the second sensor board 1090. The battery mounting part 1013 is disposed on a rear portion of the housing 1002 and the torque changing panel 1055 is disposed on an upper portion of the housing 1002. A battery pack 1025 is mounted on the battery mounting part 1013.

The light unit 1017 and the controller 1018 are electrically connected by a lead wire 1063. The first sensor board 1080 is electrically connected to the controller 1018 by a lead wire 1085. The second sensor board 1090 and the controller 1018 are electrically connected by a lead wire 1095.

### Twelfth Embodiment

The twelfth embodiment is described below. In the following description, components that are identical or the same as those in the above-mentioned embodiments will be given the same symbols, and the description of the components will be simplified or omitted.

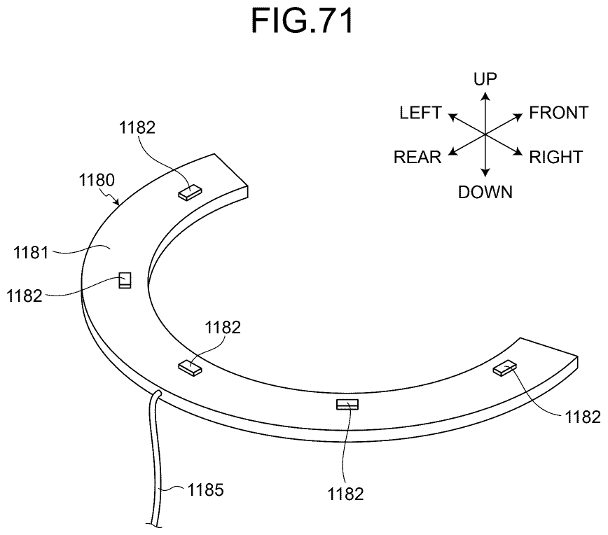

FIG. 71 is a perspective view that shows a first sensor board according to the twelfth embodiment. The first sensor board 1180 includes a first circuit board 1181 and first sensors 1182. A first lead wire 1185 is electrically connected to the first circuit board 1181. As shown in FIG. 71, the first circuit board 1181 does not have to be circular and may instead be, e.g., arc-shaped.

It is noted that, in any of the embodiments, the first sensor(s) and/or the second sensor(s) may be proximity sensors, which are capable of detecting the presence of nearby objects without any physical contact. For example, the proximity sensors may, e.g., emit an electromagnetic field or a beam of electromagnetic radiation (e.g., infrared) and then detect changes in the magnetic field or the return signal, respectively. In addition or in the alternative, the first sensor(s) and/or the second sensor(s) may be magnetic sensors (e.g., Hall effect sensors). In such an embodiment, a piece of magnetic material may be affixed to or embedded in the anvil projections and/or in the hammer so that the first sensor(s) and/or the second sensor(s) may detect rotational movement of the anvil and/or linear (axial) movement of the hammer by detecting changes in the magnetic fields emitted by the pieces of magnetic material. Naturally, other types of sensors also may be advantageously utilized within the scope of the present teachings.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved impact tools, such as impact wrenches and impact drivers.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the controllers described above, is also understood as a corresponding method step or as a feature of a method step. In an analogous manner, aspects which have been described in the context of or as a method step also represent a description of a corresponding block or detail or feature of a corresponding device, such as the control unit.

Depending on certain implementation requirements, exemplary embodiments of the controllers of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the controllers described above have been identified as “parts” or “steps”, it is understood that such parts or steps need not be physically separate or distinct electrical components, but rather may be different blocks of program code that are executed by the same hardware component, e.g., one or more microprocessors, and/or may be implemented using discrete hardware components.

### DESCRIPTION OF THE REFERENCE SIGNS

1A . . . impact tool, 1B . . . impact tool, 1C . . . impact tool, 1D . . . impact tool, 1E . . . impact tool, 1F . . . impact tool, 1G . . . impact tool, 1H . . . impact tool, 1I . . . impact tool, 1J . . . impact tool, 1K . . . impact tool, 2 . . . housing, 2S . . . screw, 3 . . . rear cover, 3S . . . screw, 4 . . . hammer case, 4A . . . rear side tubular part, 4B . . . front side tubular part, 4C . . . ring-shaped part, 4D . . . hole, 4E . . . groove, 4Ea . . . ceiling surface, 4Eb . . . bottom surface, 4F . . . support surface, 4Fa . . . side support surface, 4Fb . . . front support surface, 4G . . . space, 4R . . . recessed part, 5 . . . cover, 6 . . . motor, 7 . . . reduction mechanism, 8 . . . spindle, 8A . . . flange, 8B . . . spindle shaft, 8C . . . ring-shaped part, 8D . . . spindle groove, 9 . . . impact mechanism, 10 . . . anvil (output part), 10A . . . anvil shaft portion, 10B . . . anvil projection, 10B1 . . . first anvil projection, 10B2 . . . second anvil projection, 10C . . . bit hole, 10D . . . support recessed part, 10E . . . retaining groove, 11 . . . switch body, 12 . . . fan, 12A . . . bushing, 13 . . . battery mounting part, 14 . . . trigger lever, 15 . . . forward/reverse switching lever, 16 . . . tool holding mechanism, 16A . . . ball, 16B . . . leaf spring, 16C . . . sleeve, 16D . . . coil spring, 16E . . . positioning member, 16F . . . washer, 16G . . . support ring, 16H . . . cylindrical portion, 16J . . . protrusion, 16K . . . support surface, 17 . . . light unit, 18 . . . controller, 18A . . . controller case, 18B . . . circuit board, 18C . . . mold resin, 18D . . . microcomputer, 18E . . . control circuit, 18F . . . processor, 18G . . . nonvolatile 18H . . . volatile memory, 18J . . . switching element, 18K . . . capacitor, 18L . . . resistor, 18M . . . transistor, 19 . . . air intake port, 20 . . . exhaust port, 21 . . . motor housing part, 22 . . . grip part, 23 . . . battery holding part, 24 . . . bearing box, 25 . . . battery pack, 26 . . . stator, 27 . . . rotor, 28 . . . stator core, 29 . . . front insulator, 29S . . . screw, 30 . . . rear insulator, 31 . . . coil, 32 . . . rotor core part, 33 . . . rotor shaft part, 34 . . . rotor magnet, 35 . . . sensor magnet, 37 . . . sensor board, 39 . . . rotor bearing, 40 . . . rotor bearing, 41 . . . pinion gear, 42 . . . planetary gear, 42P . . . pin, 43 . . . internal gear, 44 . . . spindle bearing, 45 . . . washer, 46 . . . anvil bearing, 47 . . . hammer, 47A . . . hammer groove, 47B . . . hammer projection, 47C . . . recessed part, 47D . . . body portion, 48 . . . ball, 49 . . . coil spring, 50 . . . ball, 51 . . . cushion member, 52 . . . sponge, 53 . . . retaining ring, 54 . . . washer, 61 . . . lead wire, 62 lead wire, 63 . . . lead wire, 80 . . . first sensor board, 81 . . . first circuit board, 81T . . . convex part, 82 . . . first sensor, 82A . . . first sensor, 82B . . . first sensor, 82C . . . first sensor, 82D . . . first sensor, 82E . . . first sensor, 82F . . . first sensor, 82G . . . first sensor, 82H . . . first sensor, 85 . . . first lead wire, 85C . . . connector, 90 . . . second sensor board, 91 . . . second circuit board, 92 . . . second sensor, 92A . . . second sensor, 92B . . . second sensor, 95 . . . second lead wire, 95C . . . connector, 102 . . . housing 104 . . . hammer case, 104A . . . rear side tubular part, 104B . . . front side tubular part, 104C . . . ring-shaped part, 104D . . . hole, 106 . . . motor, 107 . . . reduction mechanism, 108 . . . spindle, 108F . . . recessed part, 109 . . . impact mechanism, 110 . . . anvil, 110A . . . anvil shaft portion, 110B . . . anvil projection, 110B1 . . . first anvil projection, 110B2 . . . second anvil projection, 110F . . . convex portion, 111 . . . switch body, 112 . . . fan, 113 . . . battery mounting part, 114 . . . trigger lever, 115 . . . forward/reverse switching lever, 117 . . . light unit, 118 . . . controller, 118A . . . controller case, 118B . . . circuit board, 118C . . . mold resin, 118D . . . microcomputer, 118J . . . switching element, 118K . . . capacitor, 118L . . . resistor, 118M . . . transistor, 121 . . . motor housing part, 122 . . . grip part, 123 . . . battery holding part, 125 . . . battery pack, 146 . . . anvil bearing, 147 . . . hammer, 147A . . . hammer groove, 147B . . . hammer projection, 147C . . . recessed part, 147D . . . body portion, 148 . . . ball, 149 . . . coil spring, 151 . . . cushion member, 152 . . . sponge, 153 . . . retaining ring, 154 . . . washer, 161 . . . lead wire, 162 . . . lead wire, 163 . . . lead wire, 180 . . . first sensor board, 181 . . . first circuit board, 181T . . . convex part, 182 . . . first sensor, 182A . . . first sensor, 182B . . . first sensor, 182C . . . first sensor, 182D . . . first sensor, 182E . . . first sensor, 182F . . . first sensor, 182G . . . first sensor, 182H . . . first sensor, 185 . . . first lead wire, 185C . . . connector, 190 . . . second sensor board, 191 . . . second circuit board, 192 . . . second sensor, 192A . . . second sensor, 192B . . . second sensor, 195 . . . second lead wire, 195C . . . connector, 202 . . . housing, 204 . . . hammer case, 204A . . . rear side tubular part, 204B . . . front cylinder, 204C . . . ring-shaped part, 204D . . . hole, 208 . . . spindle, 209 . . . impact mechanism, 210 . . . anvil, 210A . . . anvil shaft portion, 210B . . . anvil projection, 210B1 . . . first anvil projection, 210B2 . . . second anvil projecting portion, 211 . . . switch body, 213 . . . battery mounting part, 214 . . . trigger lever, 215 . . . forward/reverse switching lever, 217 . . . light unit, 218 . . . controller, 221 . . . motor housing part, 222 . . . rear grip part, 223 . . . battery holding part, 224 . . . front grip part, 225 . . . battery pack, 247 . . . hammer, 247A . . . hammer groove, 247B . . . hammer projection, 247C . . . recessed part, 247D . . . body portion, 248 . . . ball, 249 . . . coil spring, 251 . . . cushion member, 252 . . . sponge, 246 . . . anvil bearing, 253 . . . retaining ring, 254 . . . washer, 261 . . . lead wire, 262 . . . lead wire, 263 . . . lead wire, 280 . . . first sensor board, 281 . . . first circuit board, 281T . . . convex part, 282 . . . first sensor, 282A . . . first sensor, 282B . . . first sensor, 282C . . . first sensor, 282D . . . first sensor, 282E . . . first sensor, 282F . . . first sensor, 282G . . . first sensor, 282H . . . first sensor, 285 . . . first lead wire, 290 . . . second circuit board, 291 . . . second circuit board, 292 . . . second sensor, 292A . . . second sensor, 292B . . . second sensor, 295 . . . second lead wire, 302 . . . housing, 304 . . . hammer case, 304A . . . upper tubular part, 304B . . . lower tubular part, 304C . . . ring-shaped part, 304D . . . hole, 304E . . . recessed part, 308 . . . spindle, 309 . . . impact mechanism, 310 . . . anvil, 310A . . . anvil shaft portion, 310B . . . anvil projection, 310B1 . . . first anvil projection, 310B2 . . . second anvil projection, 313 . . . battery mounting part, 314 . . . trigger lever, 315 . . . forward/reverse switching lever, 317 . . . light unit, 318 . . . controller, 321 . . . motor housing part, 322 . . . grip part, 323 . . . battery holding part, 325 . . . battery pack, 346 . . . anvil bearing, 347 . . . hammer, 347A . . . hammer groove, 347B . . . hammer projection, 347C . . . recessed part, 347D . . . body portion, 348 . . . ball, 349 . . . coil spring, 351 . . . cushion member, 352 . . . sponge, 353 . . . retaining ring, 363 . . . lead wire, 380 . . . first sensor board, 381 . . . first circuit board, 381T . . . convex part, 382 . . . first sensor, 382A . . . first sensor, 382B . . . first sensor, 382C . . . first sensor, 382D . . . first sensor, 382E . . . first sensor, 382F . . . first sensor, 382G . . . first sensor, 382H . . . first sensor, 385 . . . first lead wire, 390 . . . second circuit board, 391 . . . second circuit board, 392 . . . second sensor, 392A . . . second sensor, 392B . . . second sensor, 395 . . . second lead wire, 402 . . . housing, 404 . . . hammer case, 404A . . . rear side tubular part, 404B . . . front side tubular part, 404C . . . ring-shaped part, 404D . . . hole, 408 . . . spindle, 409 . . . impact mechanism, 410 . . . anvil, 410A . . . anvil shaft, 410B . . . anvil protrusion, 410B1 . . . first anvil protrusion, 410B2 . . . second anvil protrusion, 413 . . . battery mounting part, 414 . . . trigger lever 415 . . . forward/reverse switching lever, 417 . . . light unit, 418 . . . controller, 421 . . . motor housing part, 422 . . . rear grip part, 423 . . . battery holding part, 424 . . . upper grip part, 425 . . . battery pack, 447 . . . hammer, 447A . . . hammer groove, 447B . . . hammer projection, 447C . . . recessed part, 447D . . . body portion, 448 . . . ball, 449 . . . coil spring, 451 . . . cushion member, 452 . . . sponge, 453 . . . retaining ring, 463 . . . lead wire, 480 . . . first sensor board, 481 . . . first circuit board, 481T . . . convex part, 482 . . . first sensor, 482A . . . first sensor, 482B . . . first sensor, 482C . . . first sensor, 482D . . . first sensor, 482E . . . first sensor, 482F . . . first sensor, 482G . . . first sensor, 482H . . . first sensor, 485 . . . first lead wire, 490 . . . second circuit board, 491 . . . second circuit board, 492 . . . second sensor, 492A . . . second sensor, 492B . . . second sensor, 495 . . . second lead wire, 504 . . . hammer case, 506 . . . motor, 507 . . . reduction mechanism, 508 . . . spindle, 509 . . . impact mechanism, 510 . . . anvil, 514 . . . trigger switch, 517 . . . light unit, 518 . . . controller, 518B . . . circuit board, 518D . . . microcomputer, 518J . . . switching element, 518K . . . capacitor, 521 . . . motor housing part, 522 . . . grip part, 523 . . . battery holding part, 537 . . . sensor board, 547 . . . hammer, 580 . . . first sensor board, 585 . . . lead wire, 590 . . . second sensor board, 595 . . . lead wire, 604 . . . hammer case, 606 . . . motor, 607 . . . reduction mechanism, 608 . . . spindle, 609 . . . impact mechanism, 610 . . . anvil, 614 . . . trigger switch, 617 . . . light unit, 618 . . . controller, 618D . . . microcomputer, 618J . . . switching element, 618K . . . capacitor, 621 . . . motor housing part, 622 . . . grip part, 623 . . . battery holding part, 647 . . . hammer, 680 . . . first sensor board, 685 . . . lead wire, 690 . . . second sensor board, 695 . . . lead wire, 704 . . . hammer case, 706 . . . motor, 761 . . . lead wire, 707 . . . reduction mechanism, 708 . . . spindle, 709 . . . impact mechanism, 710 . . . anvil, 714 . . . trigger switch, 717 . . . light unit, 718 . . . controller, 721 . . . motor housing part, 722 . . . rear grip part, 723 . . . battery holding part, 747 . . . hammer, 780 . . . first sensor board, 785 . . . lead wire, 790 . . . second sensor board, 795 . . . lead wire, 804 . . . hammer case, 806 . . . motor 807 . . . reduction mechanism, 808 . . . spindle, 809 . . . impact mechanism, 810 . . . anvil, 814 . . . trigger switch, 817 . . . light unit, 818 . . . controller, 821 . . . motor housing part, 822 . . . grip part, 823 . . . battery holding part, 837 . . . sensor board, 847 . . . hammer, 861 . . . lead wire, 862 . . . lead wire, 863 . . . lead wire, 880 . . . first sensor board, 885 . . . lead wire, 890 . . . second sensor board, 895 . . . lead wire, 904 . . . hammer case, 906 . . . motor, 907 . . . reduction mechanism, 908 . . . spindle, 909 . . . impact mechanism, 910 . . . anvil, 914 . . . trigger switch, 917 . . . light unit, 918 . . . controller, 921 . . . motor housing part, 922 . . . rear grip part, 923 . . . battery holding part, 924 . . . upper grip part, 947 . . . hammer, 963 . . . lead wire, 980 . . . first sensor board, 985 . . . lead wire, 990 . . . second sensor board, 995 . . . lead wire, 1002 . . . housing, 1004 . . . hammer case, 1006 . . . motor, 1007 . . . reduction mechanism, 1008 . . . spindle, 1009 . . . impact mechanism, 1010 . . . anvil, 1013 1013 . . . battery mounting part, 1014 . . . trigger lever, 1017 . . . light unit, 1018 . . . controller, 1025 . . . battery pack, 1047 . . . hammer, 1055 . . . torque changing panel, 1063 . . . lead wire, 1080 . . . first sensor board, 1085 . . . first lead wire, 1090 . . . second sensor board, 1095 . . . second lead wire, 1180 . . . first sensor board, 1181 . . . first circuit board, 1182 . . . first sensor, 1185 . . . first lead wire, AX . . . rotational axis, CX . . . rotational axis

1. An impact tool, comprising:
a housing,
a motor housed in the housing,
a hammer configured to be rotated by the motor,
an anvil configured to be impacted in a direction of rotation thereof by the hammer,
a hammer case that houses the hammer,
a first sensor configured to detect rotation of the anvil,
a second sensor configured to detect movement of the hammer,
a controller configured to control tightening torque based on detection data output by the first and second sensors,
wherein the anvil has a bit hole into which the tool accessory is insertable.

2. The impact tool according to claim 1, wherein the housing includes:
a motor housing part that houses the motor,
a grip part that extends downward from the motor housing part, and
a battery holder that is connected to a lower end of the grip part.

3. The impact tool according to claim 1, wherein:
the first sensor is mounted on a first circuit board,
the second sensor is mounted on a second circuit board,
a first lead wire electrically connects the first circuit board to the controller, and
a second lead wire electrically connects the second circuit board to the controller.

4. The impact tool according to claim 3, wherein:
each of the first and second circuit boards is disposed in the interior of the hammer case, and
the hammer case has a hole through which the first and second lead wires pass.

5. The impact tool according to claim 3, wherein:
the anvil includes an anvil shaft portion and anvil projections,
the first circuit board is disposed at least partially around the anvil shaft portion, and
the first sensor is disposed at a position that faces the anvil projections.

6. The impact tool according to claim 3, wherein:
the second circuit board has a plate shape that faces an outer surface of the hammer, and
the second sensor is disposed at a position that faces the outer surface of the hammer.

7. The impact tool according to claim 1, wherein the second sensor is configured to detect movement of the hammer relative to the anvil in a direction parallel to the rotational axis of the hammer.

8. The impact tool according to claim 1, wherein the first sensor comprises a plurality of first sensors arranged circumferentially around an anvil shaft portion of the anvil and facing anvil projections that extend radially from a rear end portion of the anvil shaft portion.

9. The impact tool according to claim 1, wherein the second sensor comprises a plurality of second sensors arranged linearly parallel to the rotational axis of the hammer.

10. The impact tool according to claim 1, wherein the first sensor and the second sensor are inductive sensors.

11. The impact tool according to claim 2, wherein:
the first sensor is mounted on a first circuit board,
the second sensor is mounted on a second circuit board,
a first lead wire electrically connects the first circuit board to the controller,
a second lead wire electrically connects the second circuit board to the controller,
each of the first and second circuit boards is disposed in the interior of the hammer case,
the hammer case has a hole through which the first and second lead wires pass
the anvil includes an anvil shaft portion and anvil projections,
the first circuit board is disposed at least partially around the anvil shaft portion,
the first sensor is disposed at a position that faces the anvil projections,
the second circuit board has a plate shape that faces an outer surface of the hammer, and
the second sensor is disposed at a position that faces the outer surface of the hammer.

12. The impact tool according to claim 11, wherein:
the first sensor comprises a plurality of first sensors arranged circumferentially around an anvil shaft portion of the anvil and facing anvil projections that extend radially from a rear end portion of the anvil shaft portion,
the second sensor comprises a plurality of second sensors arranged linearly parallel to the rotational axis of the hammer,
the first sensors and the second sensors are inductive sensors, and
the second sensors are configured to detect movement of the hammer relative to the anvil in a direction parallel to the rotational axis of the hammer.

13. An impact tool, comprising:
a housing,
a motor housed in the housing,
a hammer configured to be rotated by the motor,
an anvil configured to be impacted in a direction of rotation thereof by the hammer,
a hammer case that houses the hammer,
a first sensor configured to detect rotation of the anvil,
a second sensor configured to detect movement of the hammer, and
a controller configured to be control tightening torque based on detection data output by the first and second sensors,
wherein the housing includes:
a motor housing part that houses the motor,
a rear grip part that extends downward from the motor housing part,
a front grip part that is disposed forward of the rear grip part, and
a battery holding part that is connected to a lower end of the rear grip part and to a lower end of the front grip part.

14. An impact tool, comprising:
a grip part extending in a front-rear direction,
a housing connected to the grip part,
a motor housed in the housing,
a hammer configured to be rotated by the motor,
an anvil configured to be impacted in a rotational direction thereby by the hammer, the anvil extending in an up-down direction that is perpendicular to the front-rear direction,
a hammer case that houses the hammer,
a first sensor configured to detect rotation of the anvil,
a second sensor configured to detect movement of the hammer, and
a controller configured to be control tightening torque based on detection data of the first and second sensors.

15. An impact tool, comprising:
a housing,
a motor housed in the housing,
a hammer configured to be rotated by the motor,
an anvil configured to be impacted in a direction of rotation thereof by the hammer,
a hammer case that houses the hammer,
a first sensor configured to detect rotation of the anvil,
a second sensor configured to be detect movement of the hammer, and
a controller configured to control tightening torque based on detection data output by the first and second sensors,
wherein the housing includes:
a motor housing part that houses the motor,
a rear grip part that is disposed rearward of the motor housing part,
an upper grip part that connects an upper portion of the rear grip part to the motor housing part, and
a battery holding part that is connected to a lower end portion of the rear grip part.

16. The impact tool according to claim 15, wherein:
the first sensor is mounted on a first circuit board,
the second sensor is mounted on a second circuit board,
a first lead wire electrically connects the first circuit board to the controller, and
a second lead wire electrically connects the second circuit board to the controller.

17. The impact tool according to claim 16, wherein:
each of the first and second circuit boards is disposed in the interior of the hammer case, and
the hammer case has a hole through which the first and second lead wires pass.

18. The impact tool according to claim 16, wherein:
the anvil includes an anvil shaft portion and anvil projections,
the first circuit board is disposed at least partially around the anvil shaft portion, and
the first sensor is disposed at a position that faces the anvil projections.

19. The impact tool according to claim 16, wherein:
the second circuit board has a plate shape that faces an outer surface of the hammer, and
the second sensor is disposed at a position that faces the outer surface of the hammer.

20. The impact tool according to claim 15, wherein the second sensor is configured to detect movement of the hammer relative to the anvil in a direction parallel to the rotational axis of the hammer.
